(19) United States
(12) Patent Application Publication
(10) Pub. No.: US 2020/0102703 A1
(43) Pub. Date: Apr. 2, 2020

(54) RECORDING MEDIUM MANUFACTURING APPARATUS

(71) Applicant: SEIKO EPSON CORPORATION, Tokyo (JP)

(72) Inventors: Kaneo YODA, Okaya, Nagano (JP); Yasumasa NAKAJIMA, Shiojiri, Nagano (JP); Seiichi TANIGUCHI, Higashichikuma-gun, Asahi-mura, Nagano (JP); Shunichi SEKI, Suwa, Nagano (JP); Akira ARAI, Suwa-gun, Shimosuwa-machi, Nagano (JP); Kazuhiro ICHIKAWA, Okaya, Nagano (JP); Hiroshi TANAKA, Matsumoto, Nagano (JP); Hiroki KURATA, Matsumoto, Nagano (JP)

(21) Appl. No.: 16/469,208

(22) PCT Filed: Dec. 14, 2017
(86) PCT No.: PCT/JP2017/044945

§ 371 Date: Jun. 13, 2019

(30) Foreign Application Priority Data
Dec. 15, 2016 (JP) 2016-243023
Dec. 15, 2016 (JP) 2016-243024
Nov. 27, 2017 (JP) 2017-226532

(51) Int. Cl. D21F 2/00; D21F 1/00; D21H 17/20

(52) U.S. Cl. CPC D21F 2/00; B41M 5/502; D21H 17/20; D21F 1/0027

(57) ABSTRACT

A recording medium manufacturing apparatus includes at least one material supplying section which includes a storage unit which stores a fiber-containing material containing cellulose fibers and a resin, at least one carrying body which carries the fiber-containing material which is supplied from the material supplying section, a transfer-target body onto which the fiber-containing material which is carried by the carrying body is electrostatically transferred, and an after-treatment unit which performs an after-treatment on the fiber-containing material which is electrostatically transferred onto the transfer-target body.

### CROSS-REFERENCE TO RELATED APPLICATIONS

This application is a U.S. National stage application of International Patent Application No. PCT/JP2017/044945, filed on Dec. 14, 2017, which claims priority under 35 U.S.C. § 119(a) to Japanese Patent Application Nos. 2016-243023 and 2016-243024, filed in Japan on Dec. 15, 2016, and Japanese Patent Application No. 2017-226532, filed in Japan on Nov. 27, 2017. The entire disclosures of Japanese Patent Application Nos. 2016-243023, 2016-243024 and 2017-226532 are hereby incorporated herein by reference.

### TECHNICAL FIELD

The present invention relates to a recording medium manufacturing apparatus.

### BACKGROUND ART

In recent years, there is an increased consciousness of the environment and there is a demand for not only a reduction in the usage amount of paper at the workplace but also for recycling of paper at the workplace, in addition to performing “reuse compatible” printing, which is reusable, on paper.

For example, Japanese Unexamined Patent Application Publication No. 2005-48333 discloses an apparatus capable of executing a method in which, after fibers are caused to adhere to a surface of a surface of a peeling substrate to which an aqueous liquid is adhered to form the fibers in a layer shape, the layer-shaped fibers are peeled from the peeling substrate to manufacture paper. In the apparatus, a configuration is adopted in which fibers which float up once from a fiber supplying device are caused to adhere to the peeling substrate by an electrostatic force.

However, in the apparatus described in Japanese Unexamined Patent Application Publication No. 2005-48333, since when the fibers adhere to the peeling substrate, the fibers float up once from the fiber supplying device, the fibers do not stably adhere to the peeling substrate, and as a result, for example, there is a case in which variation arises in the thickness of the paper which is obtained.

### SUMMARY

An object according to several aspects of the invention, for example, is to provide a recording medium manufacturing apparatus capable of stably manufacturing a recording medium having a uniform thickness using as simple a configuration as possible.

The invention was created in order to solve at least a portion of the problems and may be realized as described below.

A recording medium manufacturing apparatus of the invention includes a material supplying section which includes a storage unit which stores a fiber-containing material containing cellulose fibers and a resin,

a carrying body which carries the fiber-containing material which is supplied from the material supplying section,

a transfer-target body onto which the fiber-containing material which is carried by the carrying body is electrostatically transferred, and

an after-treatment unit which performs an after-treatment on the fiber-containing material which is electrostatically transferred onto the transfer-target body.

Accordingly, it is possible to prevent variation arising in the adherence amount of the fiber-containing material which is adhered to the transfer-target body, that is, it is possible to cause an appropriate amount of the fiber-containing material to adhere to the transfer-target body. As a result, it is possible to stably manufacture a recording medium which is obtained from the fiber-containing material as a medium having a uniform thickness.

In the recording medium manufacturing apparatus of the invention, it is preferable that the transfer-target body be a belt which transports the fiber-containing material.

Accordingly, it is possible to dispose the after-treatment unit which performs the after-treatment on the fiber-containing material on the belt along the transport direction of the fiber-containing material, and thus, it is possible to swiftly perform the manufacturing of the recording medium.

In the recording medium manufacturing apparatus of the invention, it is preferable that the belt be configured by a resin having a volume resistivity of 10⁷ to 10¹¹Ω·cm.

Accordingly, it is possible to electrostatically hold the fiber-containing material, which is electrostatically transferred, on the belt.

In the recording medium manufacturing apparatus of the invention, it is preferable that the carrying body and the transfer-target body pressurize the fiber-containing material between the carrying body and the transfer-target body.

Accordingly, the fiber-containing material which is transferred onto a transfer-target portion form a layer having a uniform thickness. As a result, the recording medium which is obtained from the layer is also manufactured having a uniform thickness.

In the recording medium manufacturing apparatus of the invention, it is preferable that the carrying body carry the fiber-containing material which is carried by the carrying body at a first speed V1,

the transfer-target body transport the fiber-containing material which is electrostatically transferred onto the transfer-target body at a second speed V2, and

when the fiber-containing material is electrostatically transferred from the carrying body to the transfer-target body, a transport direction of the fiber-containing material by the carrying body and a transport direction of the fiber-containing material by the transfer-target body be the same direction and a relationship of V1>V2 be satisfied.

Accordingly, when the fiber-containing material is transferred from the carrying body to the transfer-target body, the fiber-containing material is gathered and stops at the transfer nip between the carrying body and the transfer-target body. When the stopping of the fiber-containing material at the transfer nip reaches a threshold, the fiber-containing material is transported by the transfer-target body to form a layer shape.

In the recording medium manufacturing apparatus of the invention, it is preferable that the carrying body carry the fiber-containing material which is carried by the carrying body at a first speed V1,

the transfer-target body transport the fiber-containing material which is electrostatically transferred onto the transfer-target body at a second speed V2, and

when the fiber-containing material is electrostatically transferred from the carrying body to the transfer-target body, a transport direction of the fiber-containing material by the carrying body and a transport direction of the fiber-containing material by the transfer-target body be opposite directions from each other.

Accordingly, it is possible to cause a comparatively large amount of the fiber-containing material to gather on the transfer-target body, and thus, it is possible to manufacture the recording medium which is configured by the fiber-containing material to be as thick as possible.

In the recording medium manufacturing apparatus of the invention, it is preferable that a relationship of |V1|>|V2| be satisfied.

Accordingly, it is possible to stably and swiftly perform the manufacturing of the recording medium to be as thick as possible.

In the recording medium manufacturing apparatus of the invention, it is preferable that when a weight per unit area of the fiber-containing material which is carried by the carrying body is set to W1 and a weight per unit area of the fiber-containing material which is electrostatically transferred onto the transfer-target body is set to W2, a relationship of W2/W1>1.0 be satisfied.

Accordingly, it is possible to manufacture the recording medium which is configured by the fiber-containing material to be as thick as possible.

In the recording medium manufacturing apparatus of the invention, it is preferable that the material supplying section be capable of assuming a first position at which it is possible to supply the fiber-containing material to the carrying body and a second position at which the material supplying section is withdrawn from the first position.

Accordingly, when the material supplying section is at the second position, various maintenance on the material supplying section such as upkeep, inspection, cleaning, replenishment of material (the fiber-containing material), repair, servicing, and replacement (including replacing a portion of the parts), and the like becomes possible.

In the recording medium manufacturing apparatus of the invention, it is preferable that at the first position, the material supplying section assume a loaded state of being loaded in the recording medium manufacturing apparatus, and at the second position, the material supplying section assume a detachable state in which the material supplying section is detachable from the recording medium manufacturing apparatus.

Accordingly, since the material supplying section is in the detachable state, it is possible to easily perform the various maintenance in comparison to a state in which the material supplying section remains positioned at the second position, for example.

In the recording medium manufacturing apparatus of the invention, it is preferable that the material supplying section be replaceable in the detachable state.

Accordingly, it is possible to easily and swiftly perform the replacement of the material supplying section during breakdowns and the replacement of the material supplying section when the fiber-containing material is emptied.

In the recording medium manufacturing apparatus of the invention, it is preferable that a plurality each of the material supplying section and the carrying body be disposed.

Accordingly, it is possible to manufacture the recording medium which is configured by a laminate body.

In the recording medium manufacturing apparatus of the invention, it is preferable that the after-treatment unit perform, as the after-treatment, surface property treatment in which surface properties of the fiber-containing material are regulated.

Accordingly, in a case in which the recording medium is to be used in an ink jet printer, for example, it is possible to render the recording medium which is manufactured such that the reception of the ink is performed stably.

In the recording medium manufacturing apparatus of the invention, it is preferable that the surface property treatment include a treatment in which a surface of the fiber-containing material is planarized.

Accordingly, it is possible to render the surface of the fiber-containing material a smooth state.

In the recording medium manufacturing apparatus of the invention, it is preferable that the surface property treatment include a treatment in which a surface of the fiber-containing material is semi-solidified.

Accordingly, a thin film is formed on the surface of the fiber-containing material to contribute to the shape maintenance and the like of the layer.

In the recording medium manufacturing apparatus of the invention, it is preferable that the surface property treatment include a treatment in which the fiber-containing material is pressurized.

Accordingly, the fiber-containing material bonds to itself.

In the recording medium manufacturing apparatus of the invention, it is preferable that the after-treatment unit perform, as the after-treatment, a solidifying process in which the fiber-containing material is solidified.

Accordingly, the recording medium which is configured by the fiber-containing material is solidified appropriately, and thus, for example, in a case in which the recording medium is used in an ink jet printer, has a strength of a degree capable of sufficiently withstanding the printing.

It is preferable that the recording medium manufacturing apparatus of the invention further include a peeling promotion unit which promotes peeling of the fiber-containing material from the transfer-target body.

Accordingly, in a case in which the fiber-containing material forms a belt shape on the transfer-target body, for example, the peeling of the fiber-containing material from the transfer-target body becomes easy and it is also possible to wind the fiber-containing material after the peeling.

It is also possible to realize the invention as the following aspects.

A recording medium manufacturing apparatus of the invention includes at least one a material supplying unit which includes a storage unit which stores a fiber-containing material containing cellulose fibers and a resin, and a carrying body which carries the fiber-containing material, a transfer unit which electrostatically transfers the fiber-containing material which is carried by the carrying body onto a transfer-target body, and an after-treatment unit which performs an after-treatment on the fiber-containing material which is electrostatically transferred onto the transfer-target body.

Accordingly, it is possible to omit the photosensitive body, and thus, it is possible to configure the recording medium manufacturing apparatus in the simplest possible manner. It is possible to prevent variation arising in the adherence amount of the fiber-containing material which is adhered to the transfer-target body, that is, it is possible to cause an appropriate amount of the fiber-containing material to adhere to the transfer-target body. As a result, it is possible to stably form the layer which is configured by the fiber-containing material as a layer having a uniform thickness. It is possible to stably manufacture, as a medium having a uniform thickness, the recording medium which is manufactured.

In the recording medium manufacturing apparatus of the invention, it is preferable that the material supplying unit be capable of assuming a first position at which it is possible to electrostatically transfer the fiber-containing material onto the transfer-target body and a second position at which the material supplying unit is withdrawn from the first position.

Accordingly, when the material supplying unit is at the second position, various maintenance on the material supplying unit such as upkeep, inspection, cleaning, replenishment of material (the fiber-containing material), repair, servicing, and replacement (including replacing a portion of the parts), and the like becomes possible.

In the recording medium manufacturing apparatus of the invention, it is preferable that at the first position, the material supplying unit assume a loaded state of being loaded in the recording medium manufacturing apparatus, and at the second position, the material supplying unit assume a detached state in which the material supplying section is detached from the recording medium manufacturing apparatus.

Accordingly, since the material supplying unit is in the detached state, it is possible to easily perform the various maintenance in comparison to a state in which the material supplying unit remains positioned at the second position, for example.

In the recording medium manufacturing apparatus of the invention, it is preferable that the material supplying unit be replaceable in the detached state.

Accordingly, it is possible to easily and swiftly perform the replacement of the material supplying unit during breakdowns and the replacement of the material supplying unit when the fiber-containing material is emptied.

In the recording medium manufacturing apparatus of the invention, it is preferable that the carrying body be configured by a roller, and a plurality of types of the material supplying unit having different roller widths be prepared, and it be possible to select from the plurality of types in the detached state to replace the material supplying unit.

Accordingly, it is possible to form the layer (the layer which is configured by the fiber-containing material) having a different width according to the material supplying unit which is selected from the plurality of material supplying units.

It is preferable that the recording medium manufacturing apparatus of the invention further include a transport unit which transports the fiber-containing material which is electrostatically transferred to the transfer-target body, in which a direction in which the material supplying unit is displaced between the first position and the second position is a direction which intersects a transport direction of the fiber-containing material by the transport unit.

Accordingly, although dependent on the peripheral configuration of the material supplying unit in the recording medium manufacturing apparatus, due to the displacement direction in which the material supplying unit is displaced being a direction which intersects the transport direction of the fiber-containing material, since there is a case in which the displacement direction is suitable for a direction in which to displace the material supplying unit during maintenance, for example, while preventing interference with the periphery of the material supplying unit, the configuration is preferable.

In the recording medium manufacturing apparatus of the invention, it is preferable that the fiber-containing material which is electrostatically transferred onto the transfer-target body have a layer shape, and the after-treatment unit perform, as the after-treatment, surface property treatment in which surface properties of the fiber-containing material which forms the layer shape are regulated.

Accordingly, in a case in which the recording medium is to be used in an ink jet printer, for example, it is possible to render the recording medium which is manufactured such that the reception of the ink is performed stably.

In the recording medium manufacturing apparatus of the invention, it is preferable that the surface property treatment include a treatment in which a surface of the fiber-containing material which forms the layer shape is planarized.

Accordingly, it is possible to render the surface of the fiber-containing material which forms the layer shape a smooth state.

In the recording medium manufacturing apparatus of the invention, it is preferable that the surface property treatment include a treatment in which a surface of the fiber-containing material which forms the layer shape is semi-solidified.

Accordingly, a thin film is formed on the surface of the fiber-containing material which forms the layer shape to contribute to the shape maintenance and the like of the layer.

In the recording medium manufacturing apparatus of the invention, it is preferable that the surface property treatment include a treatment in which the fiber-containing material which forms the layer shape is pressurized.

Accordingly, the fiber-containing material bonds to itself.

In the recording medium manufacturing apparatus of the invention, it is preferable that the fiber-containing material which is electrostatically transferred onto the transfer-target body have a layer shape, and the after-treatment unit perform, as the after-treatment, a solidifying process in which the fiber-containing material which forms the layer shape is solidified.

Accordingly, the fiber-containing material which forms the layer shape is solidified appropriately, and thus, for example, in a case in which the fiber-containing material is used in an ink jet printer, has a strength of a degree capable of sufficiently withstanding the printing.

It is preferable that the recording medium manufacturing apparatus of the invention further include a peeling promotion unit which promotes peeling of the fiber-containing material from the transfer-target body.

Accordingly, the peeling between the transfer-target body and the fiber-containing material becomes easy.

In the recording medium manufacturing apparatus of the invention, it is preferable that the transfer-target body be a substrate which configures a recording medium together with the fiber-containing material.

Accordingly, it is possible to swiftly manufacture the recording medium which is configured by the substrate and the layer which is formed from the fiber-containing material.

In the recording medium manufacturing apparatus of the invention, it is preferable that the transfer-target body be a belt which transports the fiber-containing material and that the recording medium manufacturing apparatus include the belt.

Accordingly, as long as the fiber-containing material is formed in a layer shape and the layer-shaped fiber-containing material is peeled from the belt, the recording medium may be obtained. In the obtained recording medium, the substrate, for example, which supports the layer-shaped fiber-containing material is omitted.

In the recording medium manufacturing apparatus of the invention, it is preferable that a plurality of the material supplying units be disposed.

Accordingly, it is possible to manufacture the recording medium in which a plurality of the layers which are configured by the fiber-containing material are laminated.

### BRIEF DESCRIPTION OF DRAWINGS

FIG. 1 is a block diagram illustrating main portions of a recording medium manufacturing apparatus (a first embodiment) of the invention.

FIG. 2 is a vertical sectional side view illustrating, in order, a process of manufacturing a recording medium using the recording medium manufacturing apparatus (the first embodiment) of the invention.

FIG. 3 is a vertical sectional side view illustrating, in order, the process of manufacturing the recording medium using the recording medium manufacturing apparatus (the first embodiment) of the invention.

FIG. 4 is a vertical sectional side view illustrating, in order, a process of displacing a material supplying section with respect to a recording medium manufacturing apparatus (a second embodiment) of the invention.

FIG. 5 is a vertical sectional side view illustrating, in order, the process of displacing the material supplying section with respect to the recording medium manufacturing apparatus (the second embodiment) of the invention.

FIG. 6 is a vertical sectional side view illustrating, in order, the process of displacing the material supplying section with respect to the recording medium manufacturing apparatus (the second embodiment) of the invention.

FIG. 7 is a vertical sectional side view illustrating, in order, a process of manufacturing a recording medium using a recording medium manufacturing apparatus (a third embodiment) of the invention.

FIG. 8 is a vertical sectional side view illustrating, in order, a process of manufacturing a recording medium using a recording medium manufacturing apparatus (a fourth embodiment) of the invention.

FIG. 9 is a vertical sectional side view illustrating, in order, a process of manufacturing a recording medium using a recording medium manufacturing apparatus (a fifth embodiment) of the invention.

FIG. 10 is a vertical sectional side view illustrating, in order, the process of manufacturing the recording medium using the recording medium manufacturing apparatus (the fifth embodiment) of the invention.

FIG. 11 is a vertical sectional view illustrating an example of the recording medium which is manufactured by the recording medium manufacturing apparatus (the fifth embodiment) of the invention.

FIG. 12 is a vertical sectional view illustrating an example of the recording medium which is manufactured by the recording medium manufacturing apparatus (the fifth embodiment) of the invention.

FIG. 13 is a vertical sectional view illustrating an example of the recording medium which is manufactured by the recording medium manufacturing apparatus (the fifth embodiment) of the invention.

FIG. 14 is a vertical sectional side view illustrating a material supplying section which is included in a recording medium manufacturing apparatus (a sixth embodiment) of the invention.

FIG. 15 is a block diagram illustrating main portions of a recording medium manufacturing apparatus (a seventh embodiment) of the invention.

FIG. 16 is a plan view illustrating an example of a recording medium which is manufactured by the recording medium manufacturing apparatus illustrated in FIG. 15.

FIG. 17 is a sectional diagram taken along a line A-A in FIG. 16.

FIG. 18 is a vertical sectional side view illustrating, in order, the process of manufacturing the recording medium using the recording medium manufacturing apparatus illustrated in FIG. 15.

FIG. 19 is a vertical sectional side view illustrating, in order, the process of manufacturing the recording medium using the recording medium manufacturing apparatus illustrated in FIG. 15.

FIG. 20 is a vertical sectional side view illustrating, in order, a process of manufacturing a recording medium using a recording medium manufacturing apparatus (an eighth embodiment) of the invention.

FIG. 21 is a vertical sectional side view illustrating, in order, the process of manufacturing the recording medium using the recording medium manufacturing apparatus (the eighth embodiment) of the invention.

FIG. 22 is a vertical sectional side view illustrating, in order, a process of displacing a material supplying unit with respect to a recording medium manufacturing apparatus (a ninth embodiment) of the invention.

FIG. 23 is a vertical sectional side view illustrating, in order, the process of displacing the material supplying unit with respect to the recording medium manufacturing apparatus (the ninth embodiment) of the invention.

FIG. 24 is a vertical sectional side view illustrating, in order, a process of manufacturing a recording medium using a recording medium manufacturing apparatus (a tenth embodiment) of the invention.

FIG. 25 is a vertical sectional side view illustrating, in order, the process of manufacturing the recording medium using the recording medium manufacturing apparatus (the tenth embodiment) of the invention.

FIG. 26 is a vertical sectional view illustrating an example of the recording medium which is manufactured by the recording medium manufacturing apparatus (the tenth embodiment) of the invention.

FIG. 27 is a vertical sectional view illustrating an example of the recording medium which is manufactured by the recording medium manufacturing apparatus (the tenth embodiment) of the invention.

FIG. 28 is a vertical sectional view illustrating an example of the recording medium which is manufactured by the recording medium manufacturing apparatus (the tenth embodiment) of the invention.

### DESCRIPTION OF EMBODIMENTS

Hereinafter, a detailed description will be given of a recording medium manufacturing apparatus of the invention based on favorable embodiments which are illustrated in the attached drawings. Hereinafter, to facilitate the description, there are diagrams in which three mutually orthogonally intersecting coordinate axes, that is, an x-axis, a y-axis, and a z-axis are depicted. In these diagrams, an xy plane including the x-axis and the y-axis forms a horizontal direction and the z-axis forms a vertical direction. A direction parallel to the x-axis will also be referred to as “an x-axis direction (a first direction)”, a direction parallel to the y-axis will also be referred to as “a y-axis direction (a second direction)”, and a direction parallel to the z-axis will also be referred to as “a z-axis direction (a third direction)”. The directions in which the arrows of each direction face will be referred to as “positive” and the opposite directions will be referred to as “negative”. In the diagrams in which the coordinate axes are depicted, the top side may be referred to as “the top” or “above” and the bottom side may be referred to as “the bottom” or “below”. In the diagrams in which the coordinate axes are depicted, the left side may be referred to as “the upstream side” and the right side may be referred to as “the downstream side”.

### First Embodiment

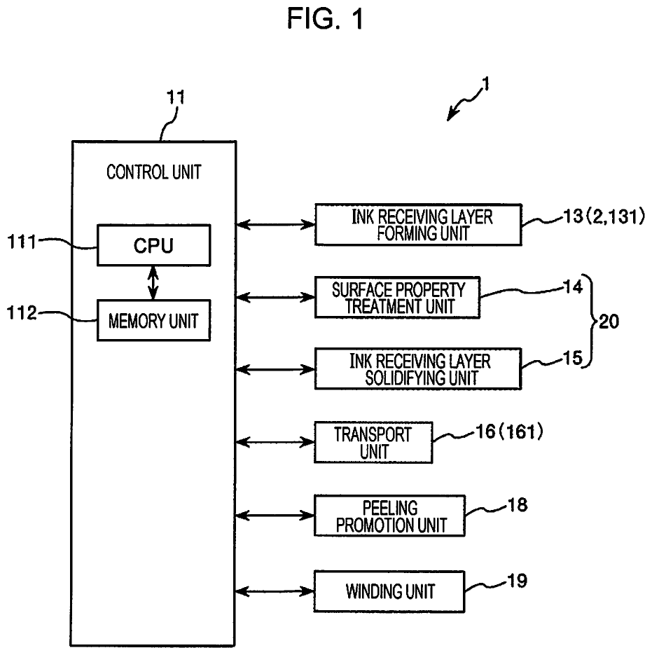

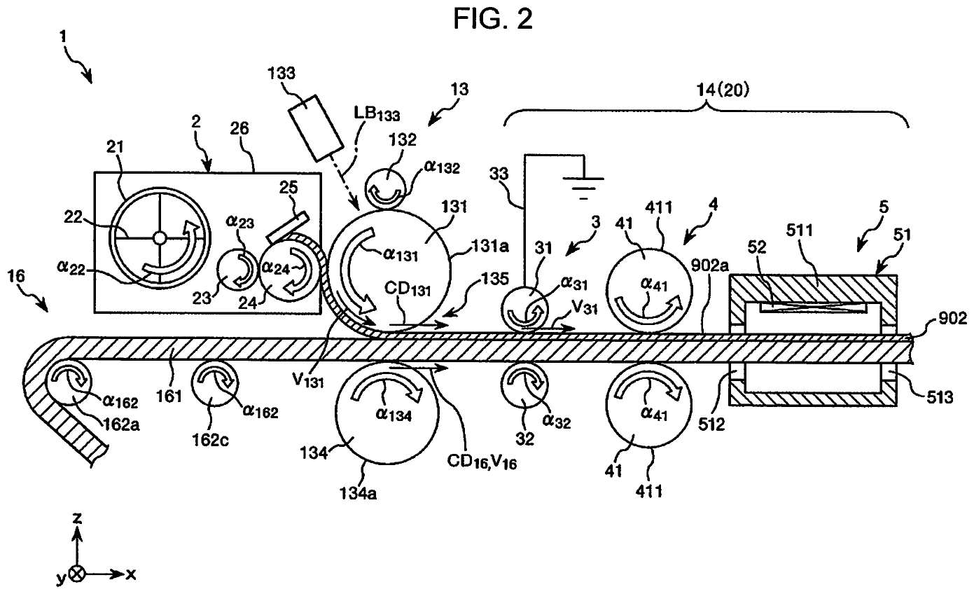

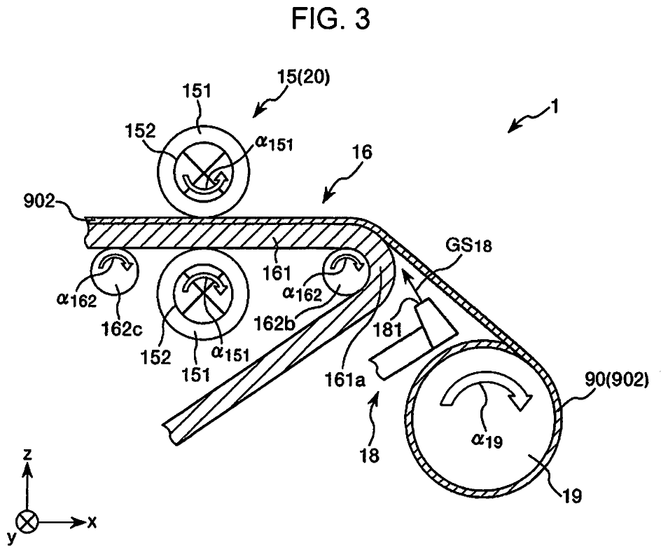

FIG. 1 is a block diagram illustrating main portions of a recording medium manufacturing apparatus (a first embodiment) of the invention. FIGS. 2 and 3 are each a vertical sectional side view illustrating, in order, the process of manufacturing the recording medium using the recording medium manufacturing apparatus (the first embodiment) of the invention. Hereinafter, in FIGS. 2, 3, and 7 to 10, for the convenience of illustration, an ink receiving layer 902 will be displayed as a single ink receiving layer 902 whether the ink receiving layer 902 is a single layer or a laminated body of a plurality of layers.

A recording medium manufacturing apparatus 1 of the invention includes at least one material supplying section 2, at least one carrying body (a second carrying body 131), a transfer-target body (a transport belt 161), and an after-treatment unit 20. The material supplying section 2 includes a storage unit 21 which stores a fiber-containing material including cellulose fibers and a resin, the carrying body carries the fiber-containing material which is supplied from the material supplying section 2, the fiber-containing material which is carried by the carrying body (the second carrying body 131) is electrostatically transferred to the transfer-target body, and the after-treatment unit 20 performs after-treatment on the fiber-containing material which is electrostatically transferred to the transfer-target body (the transport belt 161).

In the recording medium manufacturing apparatus 1, it is possible to electrostatically transfer the fiber-containing material from the carrying body (the second carrying body 131) to the transfer-target body (the transport belt 161). Accordingly, as described later, it is possible to prevent variation arising in the adherence amount of the fiber-containing material which is adhered to the transfer-target body (the transport belt 161), that is, by electrostatically transferring the fiber-containing material, it is possible to cause an appropriate amount of the fiber-containing material to adhere to the transfer-target body (the transport belt 161). As a result, it is possible to stably manufacture a recording medium 90 which is obtained from the fiber-containing material as a medium having a uniform thickness.

Although the recording medium 90 which is manufactured by the recording medium manufacturing apparatus 1 may have a single layer or be a laminate of a plurality of layers, in the present embodiment, for example, a description will be given of a case in which the recording medium 90 has a single layer which is configured by one ink receiving layer 902.

First, a description will be given of the recording medium 90 before describing the configuration of each part of the recording medium manufacturing apparatus 1.

It is possible to subject the recording medium 90 of an unused state which is configured by the ink receiving layer 902 to printing to use the recording medium 90. Through the printing, various information is recorded on the recording medium 90. In the recording medium 90, it is possible to refer to the ink receiving layer 902 as “a recording layer” on which various information is recorded. Examples of the various information include characters, symbols, figures, patterns, colors, and combinations of these. It is possible to also record a marking portion including information regarding the ink receiving layer 902 on the recording medium 90. While the marking portion may be a bar-code (a one-dimensional code), it is preferable that the marking portion be a QR code (registered trademark) (two-dimensional code).

When the recording medium 90 is manufactured by the recording medium manufacturing apparatus 1, the recording medium 90 is once wound in a roll shape (refer to FIG. 3). When using the recording medium 90, the rolled state is expanded, the recording medium 90 is cut and used, as appropriate.

The ink receiving layer 902 (the recording medium 90) is configured by a complex (a fiber-containing material) including cellulose fibers and a hydrophobic material which covers at least a portion of the cellulose fibers. As described later, the ink receiving layer 902 is formed by electrostatic application (electrostatic transfer) by an electrophotographic type of system, that is, by application using an electrostatic force, the complex is caused to adhere to the transport belt 161 of a transport unit 16, and the complex is heated under pressure. The cellulose fibers are fibers which are configured by cellulose. The cellulose fibers may be natural fibers, may be recycled fibers, and may be semisynthetic fibers. In other words, for example, the cellulose fibers may originate from virgin pulp, may originate from a cellulose product such as paper (including old paper, recycled paper, and the like), and may be semisynthetic fibers which are obtained by subjecting a material containing cellulose to chemical treatment. The cellulose fibers may be in a powder form in a state before a hydrophobic material covers the cellulose fibers.

In the invention, the cellulose fibers may have the compound cellulose (the narrow definition of cellulose) as the main component and have a fibrous form, and may include, in addition to cellulose (the narrow definition of cellulose), hemicellulose and lignin.

Regarding the size of the cellulose fibers included in the ink receiving layer 902, it is preferable that, for example, the length (the major axis) be greater than or equal to 1 μm and less than or equal to 100 μm and the width (the minor axis) be greater than or equal to 1 μm and less than or equal to 30 μm, and it is more preferable that the length (the major axis) be greater than or equal to 5 μm and less than or equal to 30 μm and the width (the minor axis) be greater than or equal to 5 μm and less than or equal to 20 μm. Although, in a case in which the length of the cellulose fibers is less than the minimum value, the manufacturing cost of the cellulose fibers increases, it is possible to suppress the manufacturing cost as long as the length is within the range. As long as the size of the cellulose fibers is within the numerical value range, it is possible to adjust the length of the cellulose fibers using a dry method. As long as the size of the cellulose fibers is less than or equal to the maximum value, it is possible to suppress the entanglement of the cellulose fibers with each other. Accordingly, it is possible to improve the uniformity of the charge distribution in a powder formed from the complex which forms the ink receiving layer 902, and as such, it is possible to uniformly electrostatically apply the complex to the transport belt 161.

The size (the length and the width) of the cellulose fibers is measured using a Morphologi G3, which is a particle image analyzer made by Malvern Instruments, for example. This apparatus is an apparatus which uniformly disperses a sample using an automatic dry dispersion unit and analyzes a static image of the sample to measure the particle size and the particle shape.

A hydrophobic material is included in the fiber-containing material which configures the ink receiving layer 902 and the hydrophobic material covers at least a portion of the cellulose fibers. It is preferable that the average aspect ratio of the cellulose fibers which are included in the ink receiving layer 902 be less than 3, and it is more preferable that the average aspect ratio be less than or equal to 2. As long as the average aspect ratio of the cellulose fibers is less than 3, it is possible to suppress the entanglement of the cellulose fibers with each other. Accordingly, it is possible to improve the uniformity of the charge distribution in a powder formed from the complex which forms the ink receiving layer 902, and as such, it is possible to uniformly electrostatically apply the complex to the transport belt 161. It is possible to render the ink receiving layer 902 porous which is suitable for infiltration by the ink during printing by setting the average aspect ratio of the cellulose fibers to less than or equal to 2. In this manner, it is possible to set the absorbency of the ink in the ink receiving layer 902 particularly high. The average aspect ratio of the cellulose fibers is, for example, a value obtained by dividing the average length of the cellulose fibers which are measured by the Morphologi G3 particle image analyzer by the average width of the cellulose fibers.

It is preferable that the average length of the cellulose fibers be greater than or equal to 1 μm and less than or equal to 100 μm. Accordingly, in the recording medium 90, it is possible to reduce the length of the cellulose fibers using a dry method and it is possible to suppress the entanglement of the cellulose fibers with each other. Accordingly, it is possible to improve the uniformity of the charge distribution in a powder formed from the complex which forms the ink receiving layer 902, and as such, it is possible to uniformly electrostatically apply the complex to the transport belt 161.

The hydrophobic material is fused with the cellulose fibers through heat treatment to form the complex. The hydrophobic material may cover a portion of the surface of the cellulose fibers and may cover the entirety of the surface of the cellulose fibers. The hydrophobic material may have higher hydrophobicity than cellulose overall, and for example, may include a component (a highly hydrophilic component) having a lower hydrophobicity than cellulose.

The hydrophobic material causes the cellulose fibers to bind to each other to form the porous ink receiving layer 902. By having hydrophobicity, it is possible to adjust the balance of hydrophobicity and hydrophilicity of the ink receiving layer 902, and it is possible to suppress excessive wet-spreading, repellence, and the like of the ink when applying the ink to the ink receiving layer 902 and to obtain excellent ink absorbency in the ink receiving layer 902. By covering the cellulose fibers with the hydrophobic material, it is possible to obtain excellent stability of the charge characteristics of the complex.

It is possible to favorably form the ink receiving layer 902 using the electrostatic application. For example, in the cellulose fibers which are not covered by the hydrophobic material, the charge properties change easily depending on the environment (specifically, the humidity), and there is a case in which it is difficult to form the ink receiving layer 902 using electrostatic application. In the cellulose fibers which is not covered by the hydrophobic material, the affinity with ink is high and there is a case in which ink bleeds. By causing the hydrophobic material to cover the cellulose, it is possible to stabilize the charge properties of the cellulose fibers and it is possible to suppress the bleeding of the ink.

The hydrophobic material includes at least a resin. The resin causes the cellulose fibers to bind to each other to form the porous ink receiving layer 902. The resin may be in a powder form in a state before the resin covers the cellulose fibers. It is preferable that the resin content in the ink receiving layer 902 be greater than or equal to 10 mass % and less than 40 mass %, and it is more preferable that the resin content be greater than or equal to 15 mass % and less than or equal to 30 mass %.

The hydrophobic material has a function of causing the cellulose fibers to bind to each other and has a function of stabilizing the charge characteristics of the complex by covering the cellulose fibers. The hydrophobic material is generally configured by a resin such as those described later. While the resin may be positively charged and may be negatively charged, it is preferable that the resin be negatively charged. In general, the negatively charged resin has particularly excellent charge characteristic stability. In comparison to the positively charged resin, there is a wide selection of types of the negatively charged resin, it is possible to easily perform adjustment of the resin characteristics (for example, the melting point, the glass transition temperature, the bond strength with cellulose fibers, the charge, the degree of hydrophobicity, and the like), and the negatively charged resin is beneficial from the perspective of suppressing the manufacturing cost of the recording medium 90 and the like.

While it is possible to use a thermoplastic resin, a curable resin, or the like for the resin which configures the hydrophobic material, it is preferable to use a thermoplastic resin. In particular, when the hydrophobic material includes the thermoplastic resin, generally, more stable charge characteristics (particularly, the charge characteristics) may be obtained. When the hydrophobic material includes the curable resin, it is possible to render, in particular, the heat resistance, the durability, and the like of the ink receiving layer 902 (the recording medium 90) excellent. Accordingly, in addition to the hydrophobic material including the thermoplastic resin in isolation, the hydrophobic material may include both the thermoplastic resin and the curable resin.

Examples of the thermoplastic resin include polyolefins such as AS resin, ABS resin, polyethylene, polypropylene, ethylene-vinyl acetate copolymer (EVA), acrylic resins such as modified polyolefin and polymethyl methacrylate, polyesters such as polyvinyl chloride, polystyrene, polyethylene terephthalate, and polybutylene terephthalate, polyamides (nylons) such as nylon 6, nylon 46, nylon 66, nylon 610, nylon 612, nylon 11, nylon 12, nylon 6-12, and nylon 6-66, liquid crystal polymers such as polyphenylene ether, polyacetal, polyether, polyphenylene oxide, polyether ether ketone, polycarbonate, polyphenylene sulfide, thermoplastic polyimide, polyetherimide, and aromatic polyester, various thermoplastic elastomers such as styrene-based elastomers, polyolefin-based elastomers, polyvinyl chloride-based elastomers, polyurethane-based elastomers, polyester-based elastomers, polyamide-based elastomers, polybutadiene-based elastomers, trans polyisoprene-based elastomers, fluoro rubber-based elastomers, and chlorinated polyethylene-based elastomers, and it is possible to use one kind or two or more kinds selected from these in combination. It is preferable to use polyester or a thermoplastic resin containing polyester as the thermoplastic resin.

It is preferable that the glass transition temperature (Tg) of the thermoplastic resin be greater than or equal to 50° C. and less than or equal to 200° C., and it is more preferable that the glass transition temperature is greater than or equal to 55° C. and less than or equal to 160° C. As long as the glass transition temperature of the thermoplastic resin is greater than or equal to the minimum value (50° C.), it is possible to suppress the ink receiving layer 902 receiving damage through the degree of heating generated by friction, and it is possible to suppress a reduction in the strength of the ink receiving layer 902. As long as the glass transition temperature of the thermoplastic resin is less than or equal to the maximum value (200° C.), for example, it is not necessary to heat the recording medium 90 to a temperature which is higher than the maximum value when heating and pressurizing the complex which serves as the ink receiving layer 902 to fix the complex, and it is possible to suppress the cellulose fibers receiving damage through the heating.

Examples of the curable resin include heat-curable resin and light-curable resin, and more specifically, include phenol resin, epoxy resin, melamine resin, urea resin, unsaturated polyester resin, alkyd resin, urethane resin (polyurethane), and acrylic resin, and it is possible to use one kind or two or more kinds selected from these in combination.

When the resin (the thermoplastic resin) content in the ink receiving layer 902 (the fiber-containing layer) is Wa, it is preferable that Wa be greater than or equal to 10 mass % and less than 40 mass %, and it is more preferable that Wa be greater than or equal to 15 mass % and less than or equal to 30 mass %. As long as the content Wa is greater than or equal to the minimum value (10 mass %), it is possible to secure the binding force of the cellulose fibers and it is possible to suppress the cellulose fibers being lost from the ink receiving layer 902. As long as the content Wa is less than the maximum value (40 mass %), it is possible to suppress the hydrophobicity of the ink receiving layer 902 being too high and deflecting the ink and it is possible to improve the print quality. Even if the complex is in a state before the complex adheres onto the transport belt 161 and even if the complex is in a state of being adhered onto the transport belt 161 to form the ink receiving layer 902, it is preferable that the content Wa be within the numerical value range.

The hydrophobic material may include a charge controlling agent (a charge controller). Accordingly, the complex which serves as the ink receiving layer 902 may have a stable charge and may have a greater charge. It is possible to confirm whether or not the complex includes a charge controlling agent according to, in addition to a change in the charge amount of the complex, a reduction in the repose angle of the complex. The charge controlling agent may have a function as an agglomeration suppressing agent which suppresses the agglomeration of the complex. In the hydrophobic material, the charge controlling agent, ordinarily at least a portion of the charge controlling agent, is exposed to the surface of the resin. Accordingly, the effect of including the charge controlling agent is more effectively exhibited.

Examples of the charge controlling agent include silica (silicon dioxide), titanium oxide, aluminum oxide, zinc oxide, cerium oxide, magnesium oxide, zirconium oxide, strontium titanate, barium titanate, calcium carbonate, metal salts of benzoic acid, metal salts of salicylic acid, metal salts of alkylsalicylic acid, metal salts of catechol, metal-containing bisazo dyes, nigrosine dyes, tetraphenylborate derivatives, quaternary ammonium salts, alkylpyridinium salts, chlorinated polyesters, and nitrophinic acid, and it is possible to use one kind or two or more kinds selected from these in combination.

The charge controlling agent may be subjected to surface treatment with the aim of adjusting the charge characteristics, adjusting the hydrophobicity, or the like, for example. It is possible to use a silane compound for the surface treatment of the charge controlling agent, for example. Accordingly, it is possible to favorably perform hydrophobic treatment on the charge controlling agent. Examples of the silane compound used for the hydrophobic treatment of the charge controlling agent include alkylsilanes such as trimethylsilane, dimethylsilane, triethylsilane, triisopropylsilane, and triisobutylsilane, and silane coupling agents such as vinyltrimethoxysilane and vinyltriethoxysilane.

Although the form of the charge controlling agent is not particularly limited, it is preferable that the charge controlling agent be in particulate form (micro-particulate form). It is preferable that the volume-standard average particle diameter (the volume average particle diameter) of the charge controlling agent be greater than or equal to 1 nm and less than or equal to 100 nm, and it is more preferable that the volume-standard average particle diameter be greater than or equal to 5 nm and less than or equal to 50 nm. As long as the particle diameter of the charge controlling agent is within the numerical value range (greater than or equal to 1 nm and less than or equal to 100 nm), it is possible to obtain a more favorable charging effect. Furthermore, as long as the particle diameter of the charge controlling agent is within the numerical value range, it is possible to more favorably coat the surface of the resin. It is possible to obtain the volume average particle diameter of the charge controlling agent using a laser diffraction/scattering method, a dynamic light scattering method, or the like, for example.

It is preferable that the content of the charge controlling agent with respect to 100 parts by mass of a mixture of the cellulose fibers and the resin be greater than or equal to 0.5 parts by mass and less than or equal to 10 parts by mass, and it is more preferable that the content of the charge controlling agent be greater than or equal to 1 part by mass and less than or equal to 5 parts by mass. As long as the range of the content of the charge controlling agent is within the numerical value range (greater than or equal to 0.5 parts by mass and less than or equal to 10 parts by mass), the complex which serves as the ink receiving layer 902 is capable of exhibiting more favorable and stable charge properties.

The hydrophobic material may include a white pigment. Accordingly, it is possible to favorably adjust the whiteness of the ink receiving layer 902. For example, even in a case in which the cellulose fibers having a low whiteness are used, depending on the white pigment, it is possible to form the ink receiving layer 902 having high whiteness and it is possible to improve the appearance (the quality) of the printing.

Examples of the material of the white pigment include inorganic pigments such as calcium carbonate, titanium dioxide, barium sulfate, lithopone, aluminum oxide, silicon oxide, antimony trioxide, titanium phosphate, zinc oxide, lead white, and zirconium oxide, and organic fine powders such as polystyrene, and styrene-divinylbenzene copolymer, and it is possible to use one kind or two or more kinds selected from these in combination. It is preferable that titanium dioxide or calcium carbonate be used as the white pigment.

It is preferable that the blending quantity of the white pigment to 90 parts by mass of the resin be greater than or equal to 1 part by mass and less than or equal to 30 parts by mass, and it is more preferable that the blending quantity be greater than or equal to 3 parts by mass and less than or equal to 20 parts by mass, for example. Accordingly, it is possible to favorably increase the whiteness of the ink receiving layer 902 while suppressing a rise in the manufacturing cost of the recording medium 90. The white pigment may be positioned on either the surface or the inner portion of the resin.

For example, in a case in which, after mixing 10 parts by mass of calcium carbonate which is the white pigment to 90 parts by mass of polyester inside a hopper, the mixture is placed in a twin-screw kneading extruder and is melted and kneaded to manufacture white resin pellets, the ink receiving layer 902 which is formed from the resin pellets attains a higher whiteness.

The hydrophobic material may include other components. For example, the hydrophobic material may include pigments and dyes other than the white pigment. In this case, it is possible to obtain colored paper easily at low cost using electrostatic application.

It is preferable that the absolute value of the average charge amount of the complex which forms the ink receiving layer 902 be greater than or equal to 3 μC/g. Setting the absolute value of the average charge amount of the complex to a high value ensures that it is possible to easily adhere the complex onto the transport belt 161 using electrostatic application to form the ink receiving layer 902. It is possible to measure the charge amount of the complex by friction charging the complex against itself. For example, it is possible to perform the measurement of the charge amount by stirring (mixing) a powder referred to as a standard carrier and the complex in the air and measuring the charge amount of the powder. For the standard carrier, for example, it is possible to use a standard carrier for positively charged polarity toner or negatively charged polarity toner that is a spherical carrier in which a ferrite core is subjected to surface treatment and that can be purchased from Japan Imaging Society (available as a standard carrier for positively charged polarity or negatively charged polarity toner, “P-01 or N-01”), a ferrite carrier available from Powdertech Co., Ltd., or the like. More specifically, it is possible to obtain the average charge amount of the complex in the following manner, for example. A mixed powder having 80 mass % carrier and 20 mass % complex is placed in an acrylic container, the container is placed on a ball mill stand, caused to rotate at 100 rpm for 60 seconds, and the mixing of the carrier and the complex (the powder) is performed. By performing measurement on the mixture of the complex and the carrier which are mixed using suction-type compact charge amount measurement device (for example, “Model 210Hs-2” made by Trek), it is possible to obtain the absolute value of the average charge amount.

For example, after mixing cellulose fibers having an average length (the major axis) of 18 μm and an average width (the minor axis) of 9 μm and a powder which is configured by a polyester resin (glass transition temperature: 56° C., molecular weight: 10000) and which has a particle diameter of 1 μm to 40 μm in the air at 2:8 (weight ratio), the polyester resin is melted using heat treatment and conjugated with the cellulose fibers. Next, silicon dioxide micro-particles which are subjected to hydrophobic surface treatment are added to the result of the conjugation to become 1.5% by weight ratio, the result is placed in a table blender and is subjected to a stirring process for 60 seconds at a tip speed of 30 m/s. It is possible to confirm the effect of the inorganic micro-particles which are subjected to the hydrophobic treatment through a reduction in the repose angle and a change in the charge amount. Ordinarily, although the cellulose fibers are a material which is comparatively easy to positively charge, the cellulose fibers are more easily negatively charged by conjugating the cellulose fibers with a polyester resin and coating the complex with inorganic micro-particles.

In this case, the average charge amount is −6 μC/g.

Next, a description will be given of the configuration of the various parts of the recording medium manufacturing apparatus 1. As illustrated in FIG. 1, the recording medium manufacturing apparatus 1 is provided with a control unit 11, an ink receiving layer forming unit 13, a surface property treatment unit 14, an ink receiving layer solidifying unit 15, the transport unit 16, a peeling promotion unit 18, and a winding unit 19.

The control unit 11 is a control device which controls the operations of the various parts of the recording medium manufacturing apparatus 1. The control unit 11 includes a CPU (central processing unit) 111 and a memory unit 112. A control program which controls the operations, various data, and the like are stored in the memory unit 112.

Although not illustrated, it is preferable that the control unit 11 include, for example, an input unit such as a keyboard or a touch panel, and an image display unit such as an LCD monitor. The operating conditions of the various parts (described later) may be input in advance to the control program and may be input case-by-case via the input unit. It is possible to confirm the input information via the image display unit. The control unit 11 may be provided with a connecting unit to which the input unit, the image display unit, and the like are respectively connected.

As illustrated in FIGS. 2 and 3, the transport unit 16 includes the transport belt 161 which transports the fiber-containing material, a transport roller 162a, a transport roller 162b, and a plurality of transport rollers 162c.

The transport belt 161 is configured by an endless belt in the present embodiment and is capable of transporting the fiber-containing material toward the x-axis direction positive side with the fiber-containing material placed thereon. It is preferable that the transport belt 161 have sufficient strength of a degree at which the transport belt 161 is capable of withstanding the transporting of the fiber-containing material and that the transport belt 161 have sufficient flexibility of a degree at which the transport belt 161 functions as an endless belt. It is preferable that at least the surface of the obverse side of the transport belt 161 (the belt) be configured by a resin having medium to high resistance (volume resistivity of 10⁷ to 10¹¹ Ω·cm). The configuration material is not particularly limited, and for example, it is possible to use a material in which carbon black is kneaded into a fluorine-based resin. Accordingly, in the ink receiving layer forming unit 13, a powder of the fiber-containing material is transferred to the transport belt 161 using a potential difference and is electrostatically held on the transport belt 161.

It is possible to peel the fiber-containing material from the transport belt 161 using a reduction in the electrostatic holding force in a wrap-around portion 161a of the transport belt 161, which is caused by rendering the transport roller 162b low resistance (a volume resistivity of less than or equal to 10⁶ Ω·cm) or conductive and grounding the transport roller 162b, and the curvature of the wrap-around portion 161a. In this manner, it is possible to prevent the powder of the fiber-containing material which configures the ink receiving layer 902 from remaining on the transport belt 161 by using the wrap-around portion 161a. It is possible to easily peel the ink receiving layer 902 (the recording medium 90) which is configured by the fiber-containing material from the transport belt 161.

The transport belt 161 is stretched around the transport roller 162a and the transport roller 162b. The transport roller 162a is a main drive roller which is connected to a motor via a speed reducer, for example. The transport roller 162b is a follower roller to which the rotational force of the transport roller 162a is transmitted via the transport belt 161 such that the transport roller 162b rotates. In the present embodiment, the transport roller 162a is disposed on the upstream side of a transport direction CD₁₆ of the fiber-containing material of the transport belt 161 (the transport unit 16) and the transport roller 162b is disposed on the downstream side. However, the configuration is not limited thereto, and for example, the transport roller 162b may be disposed on the upstream side and the transport roller 162a may be disposed on the downstream side. The plurality of transport rollers 162c are disposed at an interval between the transport roller 162a and the transport roller 162b. The transport rollers 162c are idle rollers. It is possible to transport the fiber-containing material which is placed on the transport belt 161 due to the transport roller 162a, the transport roller 162b, and the transport rollers 162c each rotating in an arrow α₁₆₂ direction.

The transport unit 16 is configured to be capable of modifying the speed (the transport speed) V₁₆ at which the fiber-containing material is transported in the transport direction CD₁₆. The modification method is not particularly limited, and examples of the modifying method include a method of adjusting the applied voltage to the motor which is connected to the transport roller 162a via the speed reducer and a method of modifying the aspect ratio in the speed reducer.

As illustrated in FIG. 2, the ink receiving layer forming unit 13 is disposed on the upstream side in the transport direction CD₁₆. The ink receiving layer forming unit 13 is a device which forms the ink receiving layer 902 on the transport belt 161 using the fiber-containing material (the complex which serves as the ink receiving layer 902). The ink receiving layer forming unit 13 is provided with the material supplying section 2 which includes a first carrying body 24 and the like, the second carrying body (photosensitive body) 131, a charging unit 132, an exposing unit 133, and a transfer unit 134 and is a device which forms the ink receiving layer 902 on the transport belt 161 using electrostatic application (electrostatically transferring).

The material supplying section 2 moves and adheres the fiber-containing material onto an outer circumferential surface 131a of the second carrying body 131. The material supplying section 2 includes the storage unit 21, a stirring device (an agitator) 22, a supply roller 23, the first carrying body 24, a blade 25, and a housing 26.

The storage unit 21 stores the powder-form fiber-containing material in the inner portion of the storage unit 21.

The stirring device 22 is capable of rotating in an arrow α₂₂ direction inside the storage unit 21. Accordingly, it is possible to stir and charge the fiber-containing material inside the storage unit 21. The fiber-containing material is supplied to the first carrying body 24 via the supply roller 23 which rotates in an arrow α₂₃ direction.

The first carrying body 24 is a roller which carries the fiber-containing material which is discharged from the storage unit 21. The first carrying body 24 has a potential difference between itself and the fiber-containing material which is supplied via the supply roller 23 and the fiber-containing material electrostatically adheres to the first carrying body 24 while the first carrying body 24 rotates in an arrow α₂₄ direction.

The blade 25 adjusts the thickness (the adherence amount) of the fiber-containing material which adheres onto the first carrying body 24 to form a thin film and friction charges the fiber-containing material.

The fiber-containing material on the first carrying body 24 moves and adheres to the outer circumferential surface 131a of the second carrying body 131 due to the potential difference between the first carrying body 24 and the second carrying body 131. The potential between the first carrying body 24 and the second carrying body 131 is set as appropriate. The setting of the potential is controlled by the control unit 11.

The housing 26 has a box shape, for example, and is a storage portion which stores the storage unit 21 in which the stirring device 22 is embedded, the supply roller 23, the first carrying body 24, and the blade 25 together inside the housing 26.

The second carrying body 131 (the carrying body) is roller shaped and carries the fiber-containing material which is supplied from the material supplying section 2, that is, moved from the first carrying body 24 onto the outer circumferential surface 131a to transfer the fiber-containing material to the transport belt 161. The second carrying body 131 is connected to a motor and is capable of rotating in an arrow α₁₃₁ direction (counterclockwise). Accordingly, the second carrying body 131 is capable of stably transferring the fiber-containing material to the transport belt 161 while rotating in the arrow α₁₃₁ direction together with the driving of the transport belt 161. The second carrying body 131 is configured to be capable of modifying the rotation speed. The modification method is not particularly limited, and for example, the modification method is possible by modifying the voltage which is applied to the motor which is connected to the second carrying body 131. It is preferable that the outer circumferential surface 131a of the second carrying body 131 be formed by an organic photosensitive body, for example. The rotation of the second carrying body 131 is controlled by the control unit 11. It is preferable that the second carrying body 131 be grounded via an earth line (not illustrated).

The charging unit 132, the exposing unit 133, the material supplying section 2, and the transfer unit 134 are arranged, in order, on the outer circumferential side of the second carrying body 131 along the arrow α₁₃₁ direction of the second carrying body 131.

The charging unit 132 is a roller which uniformly charges the outer circumferential surface 131a of the second carrying body 131 while rotating in an arrow α₁₃₂ direction (clockwise) accompanying the rotation of the second carrying body 131. In the present embodiment, the charging unit 132 is capable of charging the outer circumferential surface 131a of the second carrying body 131 to a negative potential, for example. It is possible to configure the charging unit 132 using a corona charger which irradiates ozone, a charging brush, a charging film, or the like, for example. The operation of the charging unit 132 is controlled by the control unit 11.

The exposing unit 133 exposes the outer circumferential surface 131a of the second carrying body 131 and adjusts the potential of the outer circumferential surface 131a of the second carrying body 131. In the present embodiment, the exposing unit 133 irradiates the outer circumferential surface 131a of the second carrying body 131 with a laser beam LB₁₃₃ and adjusts the potential such that the fiber-containing material moves and adheres to the outer circumferential surface 131a of the second carrying body 131. The adjustment of the potential is possible by discharging a portion of the outer circumferential surface 131a of the second carrying body 131 which is uniformly charged, for example. The operation of the exposing unit 133 is controlled by the control unit 11.

The transfer unit 134 is disposed on the bottom side of the second carrying body 131 via the transport belt 161 and is capable of pinching the transport belt 161 between the transfer unit 134 and the second carrying body 131. Accordingly, it is possible to transfer the fiber-containing material which adheres to the outer circumferential surface 131a of the second carrying body 131 to the transport belt 161. The transfer unit 134 is an idle roller which rotates in an arrow α₁₃₄ direction (clockwise) and forms a transfer nip 135 which is a gap (space) between the transfer unit 134 and the second carrying body 131. An outer circumferential surface 134a of the transfer unit 134 has a predetermined potential. Accordingly, a potential difference is generated between the second carrying body 131 and the transfer unit 134 at the transfer nip 135, and thus, the fiber-containing material on the second carrying body 131 electrostatically moves to the transfer unit 134 side to be transferred to the transport belt 161. The fiber-containing material which is transferred moves to the downstream side together with the driving of the transport belt 161 and forms a belt shape. The belt-shaped fiber-containing material forms the ink receiving layer 902. The transfer unit 134 has a function as a transport roller which transports the transport belt 161 together with the transport rollers 162c of the transport unit 16 and the like.

In this manner, the transfer unit 134 transfers the fiber-containing material using the electrostatic force which is generated by the potential difference between the transfer unit 134 and the second carrying body 131. In this manner, it is possible to easily and appropriately cause the fiber-containing material to adhere to the transport belt 161 using a simple method which uses the electrostatic force (electrostatic transfer). Using the electrostatic transfer contributes to a reduction in the size and a reduction in the noise of the recording medium manufacturing apparatus 1.

As described earlier, the transport belt 161 is a transfer-target body onto which the fiber-containing material which is carried by the second carrying body 131 is electrostatically transferred. The transfer-target body, that is, the transport belt 161 is a belt which transports the fiber-containing material. Accordingly, it is possible to dispose the surface property treatment unit 14 and the ink receiving layer solidifying unit 15, which carry out various processes on the fiber-containing material on the transport belt 161, in order along the transport direction CD₁₆, and thus, it is possible to swiftly perform the manufacturing of the recording medium 90.

As described earlier, the transfer unit 134 is capable of pinching the transport belt 161 between the transfer unit 134 and the second carrying body 131. Accordingly, the fiber-containing material is pressurized between the second carrying body 131 (the carrying body) and the transport belt 161 (the transfer-target body). The fiber-containing material on the transport belt 161 is formed as the ink receiving layer 902 having a uniform thickness due to the pressurizing. As a result, the recording medium 90 which is obtained from the ink receiving layer 902 is also manufactured having a uniform thickness.

As illustrated in FIG. 2, at the transfer nip 135 (on the transfer unit 134), a transport direction CD₁₃₁ of the fiber-containing material by the second carrying body 131 (the carrying body) and the transport direction CD₁₆ of the fiber-containing material by the transport unit 16 are the same directions. At the transfer nip 135, the second carrying body 131 (the carrying body) transports the fiber-containing material which is carried by the second carrying body 131 (the carrying body) at a speed (circumferential speed) V₁₃₁ (a first speed V1), and the transport belt 161 (the transfer-target body) transports the fiber-containing material which is transferred onto the transport belt 161 (the transfer-target body) at a speed V₁₆ (a second speed V2). When the fiber-containing material is electrostatically transferred from the second carrying body 131 (the carrying body) to the transport belt 161 (the transfer-target body), it is preferable that the transport direction CD₁₃₁ of the fiber-containing material by the second carrying body 131 (the carrying body) and the transport direction CD₁₆ of the fiber-containing material by the transport belt 161 (the transfer-target body) be the same direction and that the relationship of speed V₁₃₁>speed V₁₆ (that is, first speed V1>second speed V2) be satisfied. According to the magnitude relationship, when the fiber-containing material is transferred from the second carrying body 131 to the transport belt 161, the fiber-containing material is gathered toward the x-axis direction negative side once (temporarily) and stops at the transfer nip 135. When the stopping of the fiber-containing material at the transfer nip 135 reaches a threshold, the fiber-containing material is transported to the downstream side and forms a layer shape. This phenomenon may manifest with a simple configuration in which a magnitude difference is established between the speed V₁₃₁ and the speed V₁₆, and it is possible to form the ink receiving layer 902 as thickly as possible using this phenomenon. The thickness of the ink receiving layer 902 which is formed using this phenomenon may be greater than or equal to 10 μm, for example, and it is preferable that the thickness may be greater than or equal to 10 μm and less than or equal to 100 μm. It is possible to satisfy the magnitude relationship between the speed V₁₃₁ and the speed V₁₆ by adjusting the rotation speed (the angular speed) of the second carrying body 131 or the transport speed of the transport unit 16 (the angular speed of the transport roller 162a which is the main drive roller). Each speed adjustment is controlled by the control unit 11.

It is preferable that the magnitude relationship between the speed V₁₃₁ and the speed V₁₆ satisfy at least one of the following two conditions (two expressions). The first condition is to satisfy the relationship |speed V₁₃₁|/|speed V₁₆|>1.2 (that is, |first speed V1|/|second speed V2|>1.2). The second condition is to satisfy the relationship |speed V₁₃₁|/|speed V₁₆|<15 (that is, |first speed V1|/|second speed V2|<15). It is possible to stably and swiftly perform the forming of as the ink receiving layer 902 to be as thick as possible by satisfying these conditions.

In this manner, in the recording medium manufacturing apparatus 1, it is possible to electrostatically transfer the fiber-containing material from the second carrying body 131 to the transport belt 161 (the transfer-target body). Accordingly, it is possible to prevent variation in the adherence amount of the fiber-containing material which adheres to the transport belt 161 occurring, that is, it is possible to cause an appropriate amount of the fiber-containing material to adhere to the transport belt 161. As a result, it is possible to stably manufacture the recording medium 90 which is obtained from the fiber-containing material as a medium having a uniform thickness.

The after-treatment unit 20 is disposed on the downstream side, that is, the x-axis direction positive side of the ink receiving layer forming unit 13. The after-treatment unit 20 performs an after-treatment on the fiber-containing material which is electrostatically transferred to the transport belt 161 and includes the surface property treatment unit 14 and the ink receiving layer solidifying unit 15.

Incidentally, the ink receiving layer 902 directly after being formed by the ink receiving layer forming unit 13 assumes a state in which, for example, various irregularities such as line irregularities, undulation, and the like (hereinafter, “line irregularities” are represented) occur. Although depending on the degree of the state, there is a case in which the state impedes, to some extent, the reception of the ink by the recording medium 90 which is configured by the ink receiving layer 902, for example. Therefore, it is necessary to perform a treatment which regulates the surface properties of the ink receiving layer 902 in which irregularities occur and the surface property treatment is performed by the surface property treatment unit 14. In the present embodiment, the surface property treatment includes a leveling process which levels and planarizes a surface 902a of the ink receiving layer 902, a pressure treatment which pressurizes the ink receiving layer 902, and a semi-solidification process which semi-solidifies the surface 902a of the ink receiving layer 902. Examples of the origin of the occurrence of the irregularities in the ink receiving layer 902 include those originating in assembly error between the components which configure the ink receiving layer forming unit 13 (a drive gear pitch error during the forming of the layer or during the transferring, for example), those originating in discharging during the transferring, and those originating in the ink receiving layer 902 breaking due to transporting vibrations after the transferring.

As illustrated in FIG. 2, the surface property treatment unit 14 includes a leveling process unit 3, a pressure treatment unit 4, and a semi-solidification process unit 5. The leveling process unit 3, the pressure treatment unit 4, and the semi-solidification process unit 5 are disposed in this order along the transport direction CD₁₆.

The surface property treatment includes a treatment (a leveling process) which levels and planarizes, that is, smoothens the surface 902a of the ink receiving layer 902 (the fiber-containing material which forms a layer shape) as described earlier. It is possible to render the surface 902a of the ink receiving layer 902 a smooth state using the leveling process.

The leveling process is performed by the leveling process unit 3 in the surface property treatment unit 14. As illustrated in FIG. 2, the leveling process unit 3 includes a leveling roller 31 and a support roller 32.

The leveling roller 31 is capable of rotating in an arrow α₃₁ direction (counterclockwise) around the y-axis due to a motor (not illustrated) which is the drive source of the leveling roller 31. The leveling roller 31 is capable of contacting the surface 902a of the ink receiving layer 902. In the leveling roller 31, when the speed in the tangential direction at the point of contact with the surface 902a is set to V31, the rotation is adjusted to satisfy the relationship of speed V₃₁<speed V₁₆. Accordingly, minute unevenness and the like which forms the line irregularities is crushed as the surface 902a of the ink receiving layer 902 moves to the x-axis direction positive side and the fiber-containing material is pushed back to the upstream side in the transport direction CD₁₆. Accordingly, the undulation, unevenness, and the like are leveled and reduced and the surface 902a of the ink receiving layer 902 is smoothened (planarized). The material which is pushed back from the ink receiving layer 902 may be separately collected and disposed and may be reused. The rotation of the leveling roller 31 is controlled by the control unit 11.

It is preferable that the outer circumferential surface of the leveling roller 31 be configured by a metal material such as stainless steel, for example. Although not particularly limited, it is preferable that the surface roughness (center line average roughness Ra) of the outer circumferential surface of the leveling roller 31 be greater than or equal to 0.1 μm and less than or equal to 100 μm, for example.

The ink receiving layer 902 is charged by the static electricity which is generated by the friction with the leveling roller 31. Therefore, the leveling roller 31 is grounded via the earth line 33. Accordingly, it is possible to discharge the leveling roller 31, and thus, it is possible to prevent the adherence of the powder of the fiber-containing material which configures the ink receiving layer 902 on the leveling roller 31. In the surface property treatment unit 14, it is possible to perform discharging on the ink receiving layer 902 during the transporting of the ink receiving layer 902 (the fiber-containing material).

The support roller 32 is disposed on the bottom side of the leveling roller 31 via the transport belt 161. The support roller 32 is an idle roller which rotates in an arrow α₃₂ direction (clockwise) around the y-axis. Accordingly, the support roller 32 is capable of supporting the transport belt 161 on which the ink receiving layer 902 is formed from beneath, and thus, it is possible to sufficiently perform the leveling process (the planarization process) on the surface 902a of the ink receiving layer 902. The support roller 32 has a function as a transport roller which transports the transport belt 161 together with the transport rollers 162c of the transport unit 16 and the like.

The surface property treatment includes a treatment (a pressure treatment) which pressurizes the ink receiving layer 902 (the fiber-containing material which forms the layer shape) as described earlier. According to the pressure treatment, the fiber-containing material bonds to itself inside the ink receiving layer 902.

In the surface property treatment unit 14, the pressure treatment is performed by the pressure treatment unit 4. As illustrated in FIG. 2, the pressure treatment unit 4 is a calendering machine which includes two pressurizing rollers 41, outer circumferential portions 411 of which are configured by a metal material such as stainless steel. The two pressurizing rollers 41 are idle rollers which are disposed above and below the transport belt 161 to interpose the transport belt 161 and rotate in an arrow α₄₁ direction. When the ink receiving layer 902 passes between the two pressurizing rollers 41, it is possible to pressurize the ink receiving layer 902 in a direction in which the layer thickness is reduced. Accordingly, the pressure treatment is carried out, and thus, the fiber-containing material bonds to itself inside the ink receiving layer 902. Inside the ink receiving layer 902 which is pressurized, the density of the fiber-containing material increases and the density is also rendered uniform. It is preferable that the force of the two pressurizing rollers 41 pressurizing the ink receiving layer 902 be strong pressurization greater than or equal to 5 kg and less than or equal to 200 kg, for example, and it is more preferable that the force be strong pressurization greater than or equal to 20 kg and less than or equal to 80 kg. Although the pressurization of the ink receiving layer 902 is performed one time in the present embodiment, the configuration is not limited thereto and the pressurization may be performed stepwise over a plurality of times, for example. Of the two pressurizing rollers 41, the pressurizing roller 41 of the bottom side has a function as a transport roller which transports the transport belt 161 together with the transport rollers 162c of the transport unit 16. The two pressurizing rollers 41 may be configured such that the inter-center distance is variable. Accordingly, it is possible to adjust the pressurizing force. The adjustment is also controlled by the control unit 11.

The surface property treatment includes a process (a semi-solidification process) which semi-solidifies the surface 902a of the ink receiving layer 902 (the fiber-containing material which forms the layer shape) as described earlier. According to the semi-solidification process, a thin film is formed on the surface 902a of the ink receiving layer 902 and contributes to the shape maintenance of the ink receiving layer 902 and the like.

In the surface property treatment unit 14, the semi-solidification process is performed by the semi-solidification process unit 5. As illustrated in FIG. 2, the semi-solidification process unit 5 includes a chamber 51 and a heater 52.

The chamber 51 includes a heat-insulating wall 511 which is configured by a heat-insulating material. The chamber 51 includes an entrance 512 and an exit 513. Accordingly, the transport belt 161 is capable of passing through the inside of the chamber 51 together with the ink receiving layer 902.

The heater 52 is disposed on the top side inside the chamber 51. It is preferable that the heater 52 be configured by a heat emitting body which emits heat through electrical conduction, and for example, it is possible to use a halogen heater (a halogen lamp). Accordingly, the ink receiving layer 902 is heated without contact from the top side as the ink receiving layer 902 passes through the inside of the chamber 51. According to the heating, the thermoplastic resin is once melted at the surface 902a side of the ink receiving layer 902. When the ink receiving layer 902 leaves the inside of the chamber 51, the melted thermoplastic resin is cooled naturally, for example, is bound, and is cured. Through the curing, a thin film is formed on the surface 902a with respect to the layer thickness of the ink receiving layer 902. According to this layer formation, for example, it is possible to prevent the fiber-containing material from splattering from the ink receiving layer 902 due to the static electricity which is generated by the contact with the ink receiving layer solidifying unit 15 which is disposed next after the surface property treatment unit 14, and to prevent the shape of the ink receiving layer 902 from breaking under the vibrations caused by the transporting.

The heating temperature of the semi-solidification process unit 5 is greater than or equal to the glass transition temperature of the thermoplastic resin, for example, and is greater than or equal to the melting point of preferably the thermoplastic resin. The heating temperature is controlled by the control unit 11. The heating time of the semi-solidification process unit 5 is obtained using the relationship between the distance the ink receiving layer 902 moves inside the chamber 51 and the speed V₁₆, for example.

As described earlier, the fiber-containing material which is electrostatically transferred onto the transport belt 161 (the transfer-target body) forms a layer shape. The surface property treatment unit 14 of the after-treatment unit 20 is capable of performing, as after-treatments, various surface property treatments which regulate the surface properties of the fiber-containing material which forms the layer shape, that is, the ink receiving layer 902. Accordingly, the recording medium 90 which is configured by the ink receiving layer 902 is capable of stably receiving the ink.

The ink receiving layer solidifying unit 15 is disposed on the downstream side, that is, the x-axis direction positive side of the surface property treatment unit 14. As illustrated in FIG. 3, the ink receiving layer solidifying unit 15 includes two solidifying rollers 151. The two solidifying rollers 151 are disposed above and below the transport belt 161 to interpose the transport belt 161 and rotate in an arrow α₁₅₁ direction. A heater 152 is embedded in each of the solidifying rollers 151. It is preferable that the heater 152 be configured by a heat emitting body which emits heat through electrical conduction, and for example, it is possible to use a halogen heater (a halogen lamp). When the ink receiving layer 902 passes between the two solidifying rollers 151, it is possible to pressurize the ink receiving layer 902 in a direction in which the layer thickness is reduced while heating the ink receiving layer 902. Accordingly, it is possible to sufficiently melt the entirety of the thermoplastic resin inside the ink receiving layer 902. After the ink receiving layer 902 passes between the two solidifying rollers 151, the melted thermoplastic resin is naturally cooled, binds and solidifies, for example. Accordingly, the ink receiving layer 902 which is appropriately solidified is formed. It is preferable that the force of the two solidifying rollers 151 pressurizing the ink receiving layer 902 be greater than or equal to 5 kg and less than or equal to 200 kg, and it is more preferable that the force be greater than or equal to 20 kg and less than or equal to 80 kg. It is preferable that the temperature at which to heat the ink receiving layer 902 be greater than or equal to 100° C. and less than or equal to 200° C., and it is more preferable that the temperature be greater than or equal to 120° C. and less than or equal to 180° C. The temperature at which to heat the ink receiving layer 902 is not limited to this numerical value range, and it is possible to modify according to the type of the thermoplastic resin. In this case, it is preferable that the thermoplastic resin be heated until the thermoplastic resin is softened or melts.

As described earlier, the fiber-containing material which is electrostatically transferred onto the transport belt 161 (the transfer-target body) forms a layer shape. The ink receiving layer solidifying unit 15 of the after-treatment unit 20 is capable of performing, as an after-treatment, a solidifying process which solidifies the fiber-containing material which forms the layer shape, that is, the ink receiving layer 902. Accordingly, the recording medium 90 which is configured by the ink receiving layer 902 is solidified appropriately, and thus, for example, in a case in which the recording medium 90 is used in an ink jet printer, has a strength of a degree capable of sufficiently withstanding the printing.

As illustrated in FIG. 3, the wrap-around portion 161a which wraps around at the transport roller 162b on the downstream side is formed in the transport belt 161. The winding unit 19 is disposed on the bottom right in FIG. 3 with respect to the wrap-around portion 161a. The winding unit 19 winds the recording medium 90 which is manufactured in a belt shape (the ink receiving layer 902 which is formed in a belt shape). The winding unit 19 is a roller which rotates in an arrow α₁₉ direction around the y-axis. It is possible to wind the recording medium 90 through the winding unit 19 rotating in a state in which the end portion of the downstream side of the recording medium 90 is fixed to the winding unit 19. The winding unit 19 is capable of modifying the winding speed at which the recording medium 90 is wound. The modification method is not particularly limited, and examples of the modifying method include a method of adjusting the applied voltage to the motor which is connected to the winding unit 19.

The recording medium 90 peels away from the transport belt 161 as the recording medium 90 is wound. It is preferable that the diameter of the transport roller 162b be a small diameter in order to increase the curvature of the wrap-around portion 161a of the transport belt 161 to facilitate the peeling of the recording medium 90. For example, it is preferable that the diameter be less than or equal to 20 mm, and it is more preferable that the diameter be greater than or equal to 10 mm and less than or equal to 20 mm. It is preferable to reduce the electrostatic holding force at the wrap-around portion 161a of the transport belt 161 by rendering the transport roller 162b a low resistance (a volume resistivity of less than or equal to 10⁶ Ω·cm) or conductive to ground the transport roller 162b. Accordingly, the peeling of the recording medium 90 from the transport belt 161 is performed smoothly.

As illustrated in FIG. 3, the recording medium manufacturing apparatus 1 includes the peeling promotion unit 18 which promotes the peeling of the recording medium 90 (the fiber-containing material) from the transport belt 161 (the transfer-target body). The peeling promotion unit 18 is a fan which includes an outlet 181 which blows out air GS₁₈. The outlet 181 is disposed between the transport roller 162b and the winding unit 19 and faces the transport roller 162b side. Accordingly, it is possible to cause the air GS₁₈ to flows in between the transport belt 161 and the recording medium 90 at the wrap-around portion 161a of the transport belt 161, and thus, the peeling between the transport belt 161 and the recording medium 90 becomes easy. The air GS₁₈ which flows in between the transport belt 161 and the recording medium 90 hits the recording medium 90. Accordingly, the recording medium 90 is cooled to further solidify and the peeling from the transport belt 161 is rendered easier, that is, is promoted.

In the recording medium 90 which is manufactured by the recording medium manufacturing apparatus 1, the printing is performed favorably using an ink jet system, for example. In the recording medium 90, the printing is also performed favorably using a laser printer or a copier which use toner. The recording medium 90 may also be used favorably for handwriting. In the case of handwriting, for example, it is possible to use an oil-based ink pen, an aqueous ink pen, a pencil, or the like.

It is possible to install the recording medium manufacturing apparatus 1 in all manner of places such as offices, factories, homes, stores such as supermarkets and convenience stores, and public institutions such as schools, hospitals, stations, and public halls.

### Second Embodiment

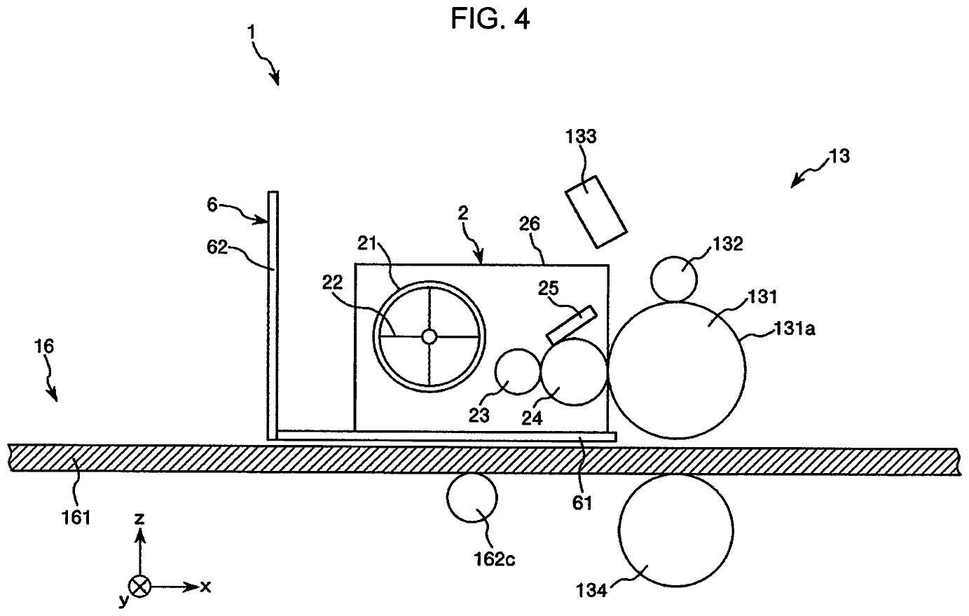

FIGS. 4 to 6 are vertical sectional side views illustrating, in order, the process of displacing the material supplying section with respect to the recording medium manufacturing apparatus (the second embodiment) of the invention.

Hereinafter, a description will be given of the second embodiment of the recording medium manufacturing apparatus of the invention with reference to the drawings and the description will be given centered on the points which differ from the previously-described embodiment, omitting the description of items which are the same.

In the present embodiment, the material supplying section 2 is capable of assuming a first position at which it is possible to supply the fiber-containing material to the second carrying body 131 (the carrying body) and a second position at which the material supplying section 2 is withdrawn from the first position. Accordingly, as described later, various maintenance of the material supplying section 2 becomes possible.

In the recording medium manufacturing apparatus 1, during continued usage over a long period, it is preferable to perform various maintenance on the material supplying section 2 such as upkeep, inspection, cleaning, replenishment of material (the fiber-containing material), repair, servicing, and replacement (including replacing a portion of the parts), for example. Therefore, the recording medium manufacturing apparatus 1 of the present embodiment is configured to be capable of performing various maintenance on the material supplying section 2.

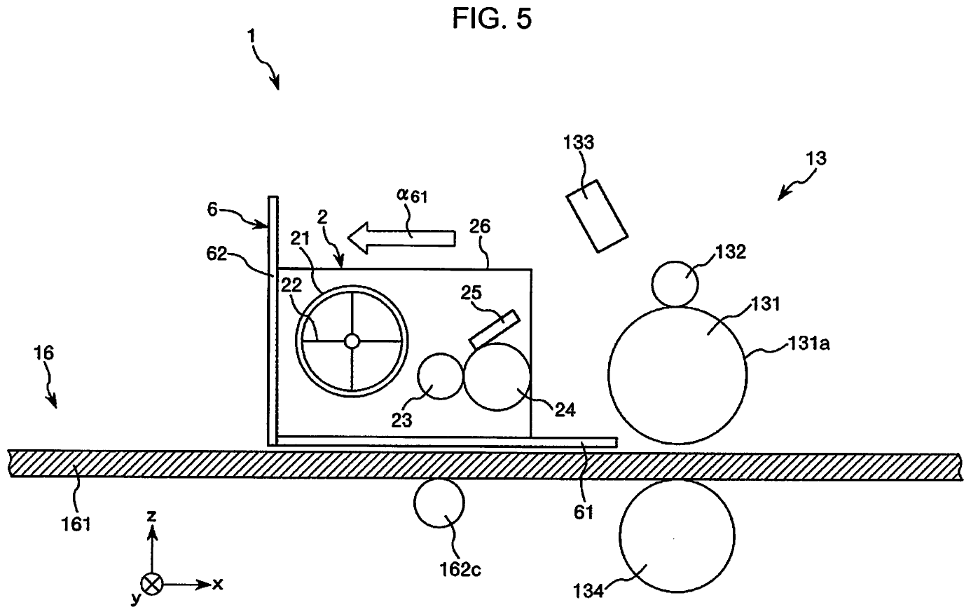

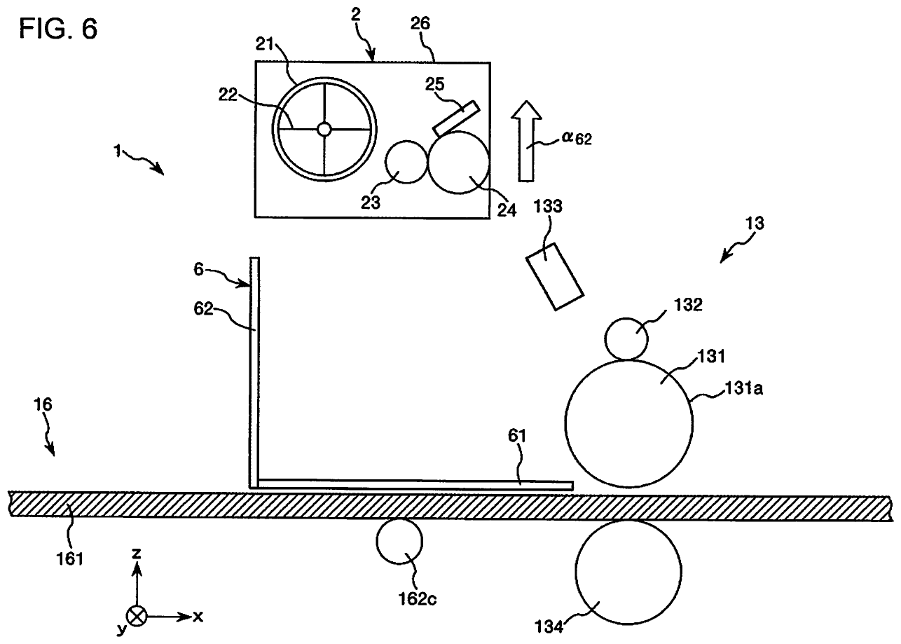

The material supplying section 2 is a cartridge capable of assuming the state illustrated in FIG. 4 and the states illustrated in FIGS. 5 and 6 in which the material supplying section 2 is moved from the state illustrated in FIG. 4. In the state illustrated in FIG. 4, the material supplying section 2 is positioned at the first position at which the formation of the ink receiving layer 902 is possible. Meanwhile, in the states illustrated in FIGS. 5 and 6, the material supplying section 2 is displaced at the second position which is withdrawn from the first position.

The ink receiving layer forming unit 13 is provided with a support portion 6 which is capable of being displaced between the first position and the second position of the material supplying section 2. The support portion 6 includes a first guide portion 61 capable of supporting the material supplying section 2 to be movable in the x-axis direction (the horizontal direction) and a second guide portion 62 which supports the material supplying section 2 to be capable of moving in the z-axis direction (the vertical direction).

As illustrated in FIG. 4, at the first position, the material supplying section 2 assumes a loaded state of being loaded in the recording medium manufacturing apparatus 1, and it is possible to move the fiber-containing material to the second carrying body 131 to form the ink receiving layer 902 on the transport belt 161.

In a case in which the maintenance is performed, the recording medium manufacturing apparatus 1 is set to a state in which the forming of the ink receiving layer 902 is stopped and the material supplying section 2 is displaced at the second position. For this operation, first, as illustrated in FIG. 5, the material supplying section 2 the material supplying section 2 is moved along the first guide portion 61 to the x-axis direction negative side, that is, in a backward-facing direction (an arrow α₆₁ direction) which is a direction parallel to the transport direction of the transport belt 161. Next, as illustrated in FIG. 6, when the material supplying section 2 is moved along the second guide portion 62 to the z-axis direction positive side, that is, in a vertical direction (an arrow α₆₂) of the transport belt 161 (alternatively, the first guide portion 61), it is finally possible to detach the material supplying section 2 from the recording medium manufacturing apparatus 1. In this manner, at the second position illustrated in FIGS. 5 and 6, the material supplying section 2 assumes a detachable state in which the material supplying section 2 is detachable from the recording medium manufacturing apparatus 1. It is possible to perform maintenance on the material supplying section 2 in the detachable state. Since the material supplying section 2 is in the detachable state, it is possible to easily perform the maintenance in comparison to a state in which the material supplying section 2 is supported by the second guide portion 62, for example.

As described earlier, examples of the types of maintenance include replacement, repairing, servicing, and inspection. In a case in which the material supplying section 2 breaks down due to degradation over time, for example, the replacement or the repair of the material supplying section 2 is performed. In a case in which the fiber-containing material which is stored in the storage unit 21 of the material supplying section 2 is used up, that is, is emptied, the replacement of the material supplying section 2 is performed. In a case in which problems such as breakdowns are to be preemptively prevented from occurring in the material supplying section 2, the servicing and the inspection of the material supplying section 2 are performed.

The material supplying section 2 may be replaced with a new material supplying section 2 in a detachable state. Accordingly, it is possible to easily and swiftly perform the replacement of the material supplying section 2 during breakdowns and the replacement of the material supplying section 2 when the fiber-containing material is emptied.

The material supplying section 2 is replaceable in the detachable state and is also possible to repair, service, and inspect in the detachable state. Accordingly, it is also possible to easily and swiftly perform the repair, the servicing, and the inspection.

After the maintenance, it is possible to return the material supplying section 2 to the first position by moving the material supplying section 2 in the opposite manner to that described above. Accordingly, the material supplying section 2 returns to the first position, is positioned, and it is possible to continually use the recording medium manufacturing apparatus 1.

It is preferable that the ink receiving layer forming unit 13 be provided with a locking portion (not illustrated) which fixes the material supplying section 2 which is at the first position. Accordingly, even if vibration caused by the operation of various components is generated in the recording medium manufacturing apparatus 1 during the manufacturing of the recording medium 90, for example, it is possible to prevent positional deviation of the material supplying section 2, and thus, it is possible to stably perform the forming of the ink receiving layer 902. When moving the material supplying section 2 to the second position, it is possible to release the fixed state by the locking portion.

Although the maintenance target is the material supplying section 2 in the present embodiment, the configuration is not limited thereto. For example, in a case in which the maintenance target is the second carrying body 131, it is preferable that the maintenance target be a cartridge in which the second carrying body 131 is capable of being displaced between the first position at which the forming of the ink receiving layer 902 is possible and the second position at which the second carrying body 131 is withdrawn from the first position. Accordingly, it is possible to easily perform the maintenance on the second carrying body 131.

### Third Embodiment

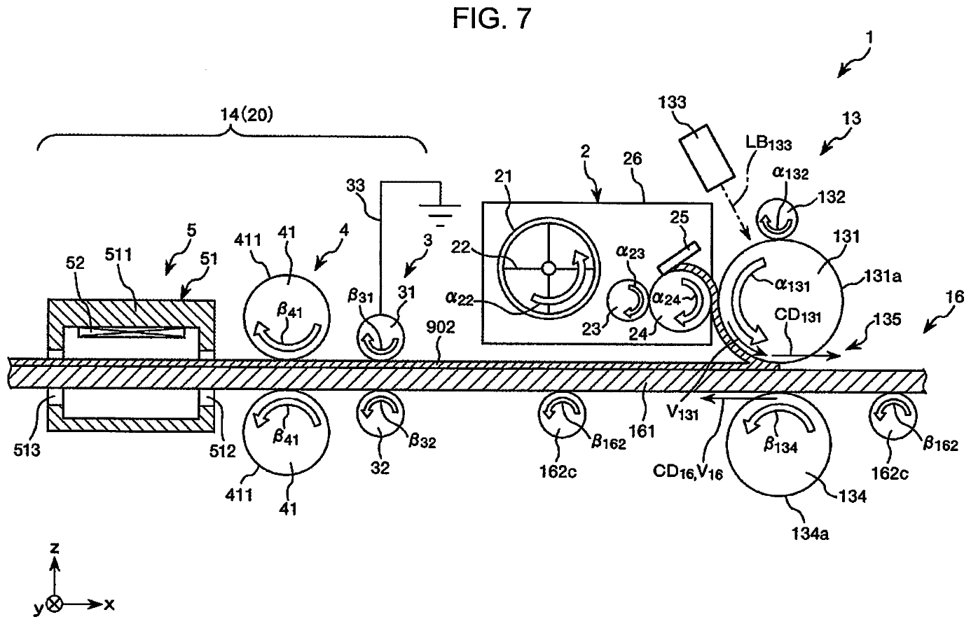

FIG. 7 is a vertical sectional side view illustrating, in order, a process of manufacturing a recording medium using a recording medium manufacturing apparatus (a third embodiment) of the invention.

Hereinafter, a description will be given of the third embodiment of the recording medium manufacturing apparatus of the invention with reference to the drawings and the description will be given centered on the points which differ from the previously-described embodiments, omitting the description of items which are the same.

As illustrated in FIG. 7, in the present embodiment, the second carrying body 131 (the carrying body) transports the fiber-containing material which is carried by the second carrying body 131 (the carrying body) at the speed V₁₃₁ (the first speed V1), and the transport belt 161 (the transfer-target body) transports the fiber-containing material which is transferred onto the transport belt 161 (the transfer-target body) at the speed V₁₆ (the second speed V2). When the fiber-containing material is electrostatically transferred from the second carrying body 131 (the carrying body) to the transport belt 161 (the transfer-target body), the transport direction CD₁₃₁ of the fiber-containing material by the second carrying body 131 (the carrying body) and the transport direction CD₁₆ of the fiber-containing material by the transport belt 161 (the transfer-target body) are the same direction. It is possible to cause a comparatively large amount of the fiber-containing material to stop on the transport belt 161 using a simple configuration in which the transport direction CD₁₃₁ of the fiber-containing material by the second carrying body 131 and the transport direction CD₁₆ of the fiber-containing material by the transport belt 161 are opposite directions. Accordingly, it is possible to form the ink receiving layer 902 which is configured by the fiber-containing material as thick as possible (for example, greater than or equal to 10 μm).

As illustrated in FIG. 7, in the present embodiment, the transport direction CD₁₆ faces the x-direction negative side and the ink receiving layer 902 is formed on the transport belt 161 by the ink receiving layer forming unit 13 during the transporting. After the forming of the ink receiving layer 902, the ink receiving layer 902 on the transport belt 161 is subjected to surface property treatment by the surface property treatment unit 14 and is solidified by the ink receiving layer solidifying unit 15.

Hereinafter, a description will be given of the various components.

As illustrated in FIG. 7, in the transport unit 16, each of the transport rollers 162c rotates in an arrow β₁₆₂ direction which is opposite to the arrow α₁₆₂ direction in the first embodiment. Accordingly, it is possible to transport the ink receiving layer 902 on the transport belt 161 toward the x-direction negative side.

In the ink receiving layer forming unit 13, the transfer unit 134 rotates in an arrow β₁₃₄ direction (counterclockwise) which is opposite to the arrow α₁₃₄ direction in the first embodiment. At the transfer nip 135 (on the transfer unit 134), the transport direction CD₁₃₁ of the fiber-containing material by the second carrying body 131 and the transport direction CD₁₆ of the fiber-containing material by the transport belt 161 are opposite directions. Accordingly, at the transfer nip 135, it is possible to move substantially all of the fiber-containing material onto the transport belt 161 with almost none remaining on the second carrying body 131. As a result, the ink receiving layer 902 is formed in as thick a layer as possible. The thickness of the ink receiving layer 902 may be greater than or equal to 10 μm, for example, and it is preferable that the thickness may be greater than or equal to 10 μm and less than or equal to 100 μm. It is possible to suppress or prevent the occurrence of line irregularities and the like in the ink receiving layer 902. It is also possible to prevent wastage of the fiber-containing material.

It is preferable to satisfy the relationship of speed V₁₃₁>speed V₁₆ (that is, |first speed V1|>|second speed V2|) at the transfer nip 135. It is preferable that the magnitude relationship between the speed V₁₃₁ and the speed V₁₆ satisfy at least one of the following two conditions (two expressions).

The first condition is to satisfy the relationship |speed V₁₃₁|/|speed V₁₆|>1.2 (that is, |first speed V1|/|second speed V2|>1.2).

The second condition is to satisfy the relationship |speed V₁₃₁|/|speed V₁₆|<15 (that is, |first speed V1|/|second speed V2|<15).

It is possible to stably and swiftly perform the forming of as the ink receiving layer 902 to be as thick as possible by satisfying these conditions.

As illustrated in FIG. 7, in the leveling process unit 3, the leveling roller 31 rotates in an arrow β₃₁ direction (clockwise) which is opposite from the arrow α₃₁ direction in the first embodiment. In the support roller 32 rotates in an arrow β₃₂ direction (counterclockwise) which is opposite to the arrow α₃₂ direction in the first embodiment. It is possible to perform the leveling process using the leveling process unit 3.

In the pressure treatment unit 4, each of the pressurizing rollers 41 rotates in an arrow β₄₁ direction which is opposite to the arrow α₄₁ direction in the first embodiment. It is possible to perform the pressure treatment using the pressure treatment unit 4.

### Fourth Embodiment

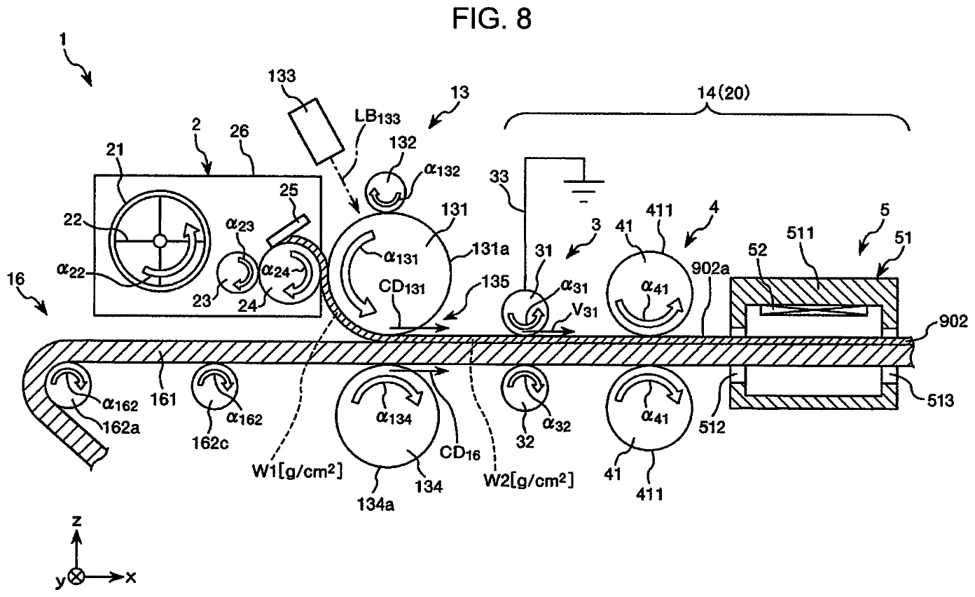

FIG. 8 is a vertical sectional side view illustrating, in order, a process of manufacturing a recording medium using a recording medium manufacturing apparatus (a fourth embodiment) of the invention.

Hereinafter, a description will be given of the fourth embodiment of the recording medium manufacturing apparatus of the invention with reference to the drawings and the description will be given centered on the points which differ from the previously-described embodiments, omitting the description of items which are the same.

In the present embodiment, when the weight per unit area of the fiber-containing material which is carried by the second carrying body 131 (the carrying body) is set to W1 and the weight per unit area of the fiber-containing material which is electrostatically transferred to the transport belt 161 (the transfer-target body) is set to W2, it is preferable that the relationship of weight W2/weight W1>1.0 be satisfied. Accordingly, it is possible to transfer a comparatively large amount of the fiber-containing material from the second carrying body 131 to the transport belt 161 using a simple configuration in which a magnitude difference is established between the weight W1 and the weight W2. Accordingly, it is possible to form the ink receiving layer 902 which is configured by the fiber-containing material as thick as possible (for example, greater than or equal to 10 μm).

As illustrated in FIG. 8, when the weight per unit area, that is, the linear mass density (unit: g/cm²) of the fiber-containing material which is carried by the second carrying body 131 is set to W1 and the weight per unit area, that is, the linear mass density (unit: g/cm²) of the fiber-containing material which is transferred to the transport belt 161 is set to W2, it is preferable that the relationship of weight W2/weight W1>1.0 be satisfied. Accordingly, it is possible to transfer a comparatively large amount of the fiber-containing material from the second carrying body 131 to the transport belt 161, and thus, it is possible to form the ink receiving layer 902 as thick as possible. It is possible to satisfy the magnitude relationship between the weight W1 and the weight W2 by adjusting the potential of the second carrying body 131 and the potential of the transfer unit 134, for example. The potential adjustment is controlled by the control unit 11.

It is preferable that the relationship of weight W2/weight W1<15 be satisfied. Accordingly, it is possible to stably and swiftly perform the forming of the ink receiving layer 902 to be as thick as possible.

In the present embodiment, it is possible to satisfy both the condition of the magnitude relationship between the weight W1 and the weight W2 and the condition of the magnitude relationship between the speed V₁₃₁ and the speed V₁₆ described earlier.

### Fifth Embodiment

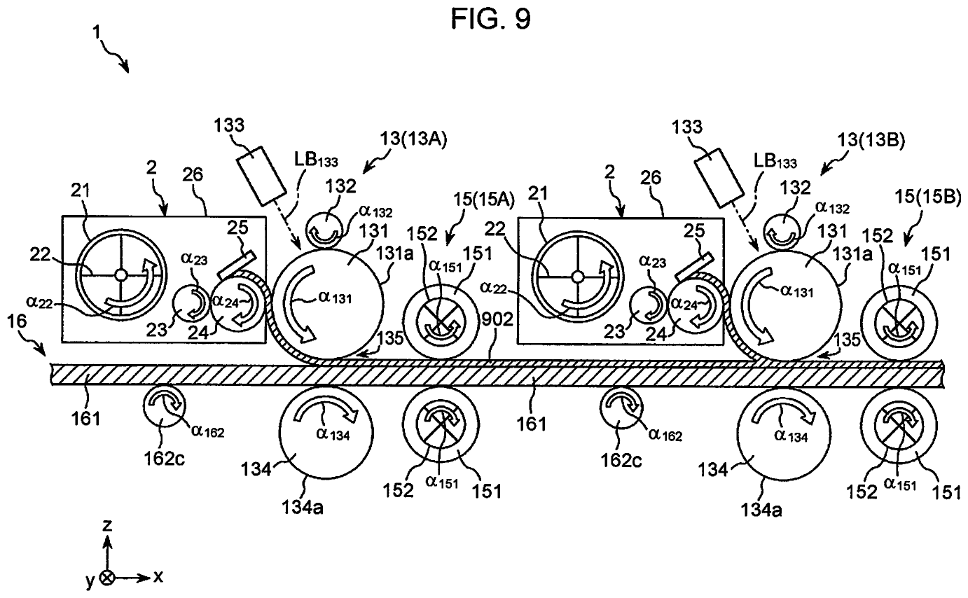

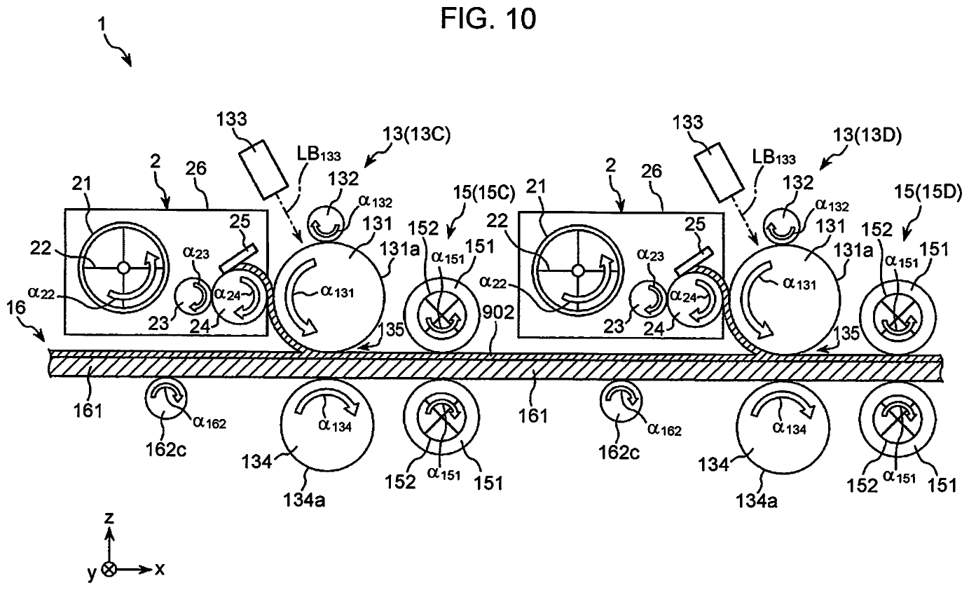

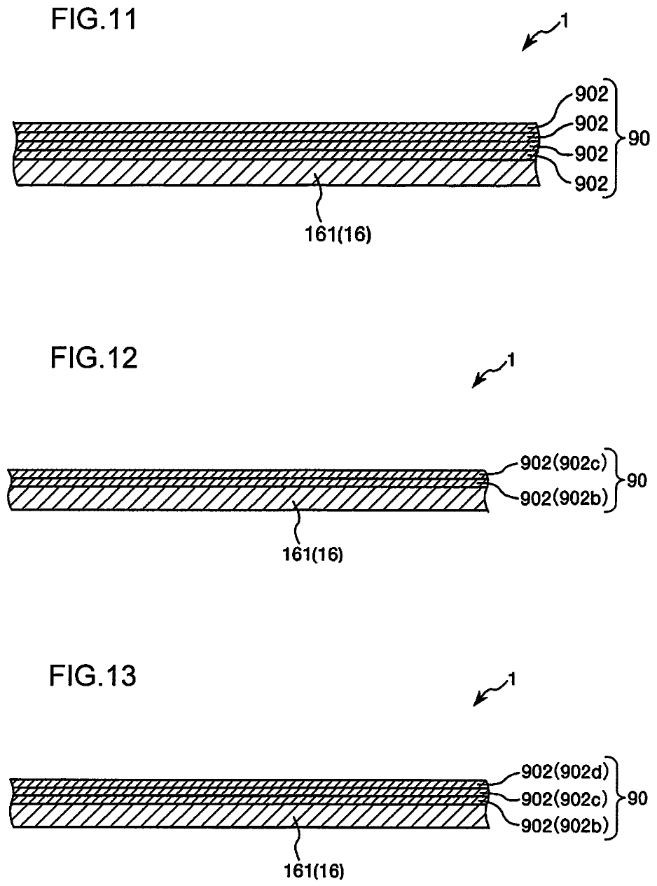

FIGS. 9 and 10 are each a vertical sectional side view illustrating, in order, the process of manufacturing the recording medium using the recording medium manufacturing apparatus (the fifth embodiment) of the invention. FIGS. 11 to 13 are each a vertical sectional view illustrating an example of the recording medium which is manufactured by the recording medium manufacturing apparatus (the fifth embodiment) of the invention.

Hereinafter, a description will be given of the fifth embodiment of the recording medium manufacturing apparatus of the invention with reference to the drawings and the description will be given centered on the points which differ from the previously-described embodiments, omitting the description of items which are the same.

In the recording medium manufacturing apparatus 1 of the present embodiment, a plurality (in the present embodiment, four) each of the ink receiving layer forming unit 13 and the ink receiving layer solidifying unit 15 are disposed toward the x-axis direction positive side. The four ink receiving layer forming units 13 may be referred to as, in order from the upstream side, “an ink receiving layer forming unit 13A” (refer to FIG. 9), “an ink receiving layer forming unit 13B” (refer to FIG. 9), “an ink receiving layer forming unit 13C” (refer to FIG. 10), and “an ink receiving layer forming unit 13D” (refer to FIG. 10). The four ink receiving layer solidifying units 15 may be referred to as, in order from the upstream side, “an ink receiving layer solidifying unit 15A” (refer to FIG. 9), “an ink receiving layer solidifying unit 15B” (refer to FIG. 9), “an ink receiving layer solidifying unit 15C” (refer to FIG. 10), and “an ink receiving layer solidifying unit 15D” (refer to FIG. 10). The ink receiving layer solidifying unit 15A is disposed between the ink receiving layer forming unit 13A and the ink receiving layer forming unit 13B, the ink receiving layer solidifying unit 15B is disposed between the ink receiving layer forming unit 13B and the ink receiving layer forming unit 13C, the ink receiving layer solidifying unit 15C is disposed between the ink receiving layer forming unit 13C and the ink receiving layer forming unit 13D, and the ink receiving layer solidifying unit 15D is disposed on the downstream side, that is, the x-axis direction positive side of the ink receiving layer forming unit 13D.

The recording medium manufacturing apparatus 1 is configured to include four of the ink receiving layer forming units 13, that is, four (a plurality) each of the material supplying section 2 and the second carrying body 131 (the carrying body) are disposed and the recording medium manufacturing apparatus 1 includes four of the ink receiving layer solidifying units 15. In the recording medium manufacturing apparatus 1 of this configuration, it is possible to manufacture the recording medium 90 which is configured by a laminate body such as the recording medium 90 illustrated in FIG. 11, for example. In the recording medium 90 illustrated in FIG. 11, four ink receiving layers 902 are laminated. The thickness of each of the ink receiving layers 902 is the same.

The ink receiving layer forming unit 13A forms the first ink receiving layer 902 on the transport belt 161. The ink receiving layer solidifying unit 15A solidifies the first ink receiving layer 902.

The ink receiving layer forming unit 13B forms the second ink receiving layer 902 on the solidified first ink receiving layer 902. The ink receiving layer solidifying unit 15B solidifies the second ink receiving layer 902.

The ink receiving layer forming unit 13C forms the third ink receiving layer 902 on the solidified second ink receiving layer 902. The ink receiving layer solidifying unit 15C solidifies the third ink receiving layer 902.

The ink receiving layer forming unit 13D forms the fourth ink receiving layer 902 on the solidified third ink receiving layer 902. The ink receiving layer solidifying unit 15D solidifies the fourth ink receiving layer 902.

According to this configuration, it is possible to stack the plurality of ink receiving layers 902 in order. There is a case in which each of the ink receiving layers 902 assumes a state in which the line irregularities or the like which are described earlier are generated. However, the line irregularities become random as the plurality of ink receiving layers 902 are laminated, and as a result, the fourth ink receiving layer 902 assumes a state in which the line irregularities are solved. Accordingly, the recording medium 90 which is manufactured becomes capable of stably receiving the ink.

Although the recording medium manufacturing apparatus 1 is configured such that the surface property treatment unit 14 is omitted in the depicted configuration, the recording medium manufacturing apparatus 1 may be configured to include the surface property treatment unit 14.

In the recording medium manufacturing apparatus 1, it is possible to adjust the operating conditions of the ink receiving layer forming units 13 and the ink receiving layer solidifying units 15, for example, such that the forming conditions under which the first ink receiving layer 902 is formed, the forming conditions under which the second ink receiving layer 902 is formed, the forming conditions under which the third ink receiving layer 902 is formed, and the forming conditions under which the fourth ink receiving layer 902 is formed are different from each other. Accordingly, it is possible to easily and swiftly manufacture various recording mediums 90 having different characteristics (properties). The adjustment of the operating conditions of the ink receiving layer forming units 13 and the ink receiving layer solidifying units 15 is controlled by the control unit 11.

For example, it is possible to adjust the potential of the transfer unit 134 of each of the ink receiving layer forming units 13 such that the electrostatic force during the formation of the first ink receiving layer 902 in the ink receiving layer forming unit 13A, the electrostatic force during the formation of the second ink receiving layer 902 in the ink receiving layer forming unit 13B, the electrostatic force during the formation of the third ink receiving layer 902 in the ink receiving layer forming unit 13C, and the electrostatic force during the formation of the fourth ink receiving layer 902 in the ink receiving layer forming unit 13D are different from each other. It is preferable that the magnitude relationship between the potentials be “(the potential during the formation of the first ink receiving layer 902)<(the potential during the formation of the second ink receiving layer 902)<(the potential during the formation of the third ink receiving layer 902)<(the potential during the formation of the fourth ink receiving layer 902)”. As the ink receiving layers 902 are laminated, the total thickness of the ink receiving layers 902 on the transport belt 161 increases. Therefore, according to the magnitude relationship between the potentials, it is possible to improve the transfer efficiency during the formation of each of the ink receiving layers 902.

In the recording medium manufacturing apparatus 1, the first ink receiving layer 902 is heated by the ink receiving layer solidifying unit 15A, the second ink receiving layer 902 is heated by the ink receiving layer solidifying unit 15B, the third ink receiving layer 902 is heated by the ink receiving layer solidifying unit 15C, and the fourth ink receiving layer 902 is heated by the ink receiving layer solidifying unit 15D.

It is possible to adjust the temperature of the heater 152 of each of the ink receiving layer solidifying units 15 such that the heating temperature at which the first ink receiving layer 902 is heated, the heating temperature at which the second ink receiving layer 902 is heated, the heating temperature at which the third ink receiving layer 902 is heated, and the heating temperature at which the fourth ink receiving layer 902 is heated are different from each other. It is preferable that the magnitude relationship between the heating temperatures be “(the heating temperature during the solidifying of the first ink receiving layer 902)<(the heating temperature during the solidifying of the second ink receiving layer 902)<(the heating temperature during the solidifying of the third ink receiving layer 902)<(the heating temperature during the solidifying of the fourth ink receiving layer 902)”. In the same manner as described above, as the ink receiving layers 902 are laminated, the total thickness of the ink receiving layers 902 on the transport belt 161 increases. Therefore, according to the magnitude relationship between the heating temperatures, it is possible to improve the melting of the resin more the closer the ink receiving layer 902 is to the top side to appropriately perform the subsequent solidification.

In the recording medium manufacturing apparatus 1, the first ink receiving layer 902 is pressurized by the ink receiving layer solidifying unit 15A, the second ink receiving layer 902 is pressurized by the ink receiving layer solidifying unit 15E, the third ink receiving layer 902 is pressurized by the ink receiving layer solidifying unit 15C, and the fourth ink receiving layer 902 is pressurized by the ink receiving layer solidifying unit 15D.

In this case, it is possible to adjust the pressurizing force of the ink receiving layer solidifying units 15 such that the pressurization force at which the first ink receiving layer 902 is pressurized, the pressurization force at which the second ink receiving layer 902 is pressurized, the pressurization force at which the third ink receiving layer 902 is pressurized, and the pressurization force at which the fourth ink receiving layer 902 is pressurized are different from each other. It is preferable that the magnitude relationship between the pressurizing forces be “(the pressurizing force during the solidifying of the first ink receiving layer 902)<(the pressurizing force during the solidifying of the second ink receiving layer 902)<(the pressurizing force during the solidifying of the third ink receiving layer 902)<(the pressurizing force during the solidifying of the fourth ink receiving layer 902)”. In the same manner as described above, as the ink receiving layers 902 are laminated, the total thickness of the ink receiving layers 902 on the transport belt 161 increases. Therefore, according to the magnitude relationship between the pressurizing forces, it is possible to improve the compression the closer the ink receiving layer 902 is to the top side. Accordingly, the closer the layer is to the top side, the thinner the layer becomes and it is possible to facilitate the transmission of heat from the heater 152, and thus, it is possible to further improve the melting of the resin.

It is possible to manufacture the recording medium 90 in which the thickness of the first ink receiving layer 902, the thickness of the second ink receiving layer 902, the thickness of the third ink receiving layer 902, and the thickness of the fourth ink receiving layer 902 are different from each other. It is preferable that the magnitude relationship between the thicknesses be “(the thickness of the first ink receiving layer 902)>(the thickness of the second ink receiving layer 902)>(the thickness of the third ink receiving layer 902)>(the thickness of the fourth ink receiving layer 902)”. Accordingly, the first ink receiving layer 902 having the greatest thickness is capable of functioning as an ink stop layer which prevents the ink from reaching the reverse surface of the recording medium 90, for example. Accordingly, in the recording medium 90, it is possible to prevent the bleeding of the ink in the reverse surface.

In this case, it is possible to adjust the operations of each of the ink receiving layer forming units 13 such that the transfer amount of the fiber-containing material during the formation of the first ink receiving layer 902 in the ink receiving layer forming unit 13A, the transfer amount of the fiber-containing material during the formation of the second ink receiving layer 902 in the ink receiving layer forming unit 13B, the transfer amount of the fiber-containing material during the formation of the third ink receiving layer 902 in the ink receiving layer forming unit 13C, and the transfer amount of the fiber-containing material during the formation of the fourth ink receiving layer 902 in the ink receiving layer forming unit 13D are different from each other.

In the recording medium manufacturing apparatus 1, the material supplying section 2 of each of the ink receiving layer forming units 13 may be a plurality of types (for example, six types) selected from the following, as appropriate, for example.

The first type of material supplying section 2 (hereinafter the ink receiving layer forming unit 13 including this material supplying section 2 will be referred to as “type A”) stores a fiber-containing material in which the ratio of the cellulose fibers to the resin in the fiber-containing material is 9:1 by weight ratio. The resin before covering the cellulose fibers is a polyester powder having an average particle diameter of 12 μm.

The second type of material supplying section 2 (hereinafter the ink receiving layer forming unit 13 including this material supplying section 2 will be referred to as “type B”) stores a fiber-containing material in which the ratio of the cellulose fibers to the resin in the fiber-containing material is 8:2 by weight ratio. The resin before covering the cellulose fibers is a polyester powder having an average particle diameter of 12 μm.

The third type of material supplying section 2 (hereinafter the ink receiving layer forming unit 13 including this material supplying section 2 will be referred to as “type C”) stores a fiber-containing material in which the ratio of the cellulose fibers to the resin in the fiber-containing material is 2:8 by weight ratio.

The fourth type of material supplying section 2 (hereinafter the ink receiving layer forming unit 13 including this material supplying section 2 will be referred to as “type D”) stores a material in which a pigment which serves as a colorant is dispersed in a polyester powder having an average particle diameter of 12 μm. Examples of the color of the pigment include yellow (Y), magenta (M), cyan (C), and black (K) and the color is selected from these, as appropriate.

The fifth type of material supplying section 2 (hereinafter the ink receiving layer forming unit 13 including this material supplying section 2 will be referred to as “type E”) stores a fiber-containing material in which the ratio of the cellulose fibers to the resin in the fiber-containing material is 9:1 by weight ratio, and further, in which the pigment which serves as the colorant is dispersed. The resin before covering the cellulose fibers is a polyester powder having an average particle diameter of 12 μm.

The sixth type of material supplying section 2 (hereinafter the ink receiving layer forming unit 13 including this material supplying section 2 will be referred to as “type F”) stores a fiber-containing material in which the ratio of the cellulose fibers to the resin in the fiber-containing material is 8:2 by weight ratio, and further, in which the pigment which serves as the colorant is dispersed. The resin before covering the cellulose fibers is a polyester powder having an average particle diameter of 12 μm.

For example, it is possible to set the ink receiving layer forming unit 13A to type C, the ink receiving layer forming unit 13B to type B, the ink receiving layer forming unit 13C to type A, and the ink receiving layer forming unit 13D to type D. It is possible to operate the recording medium manufacturing apparatus 1 in this state (hereinafter referred to as “the first state”). The operation patterns in the first state include the following patterns, for example.

Pattern 1: Ink receiving layers 902 are formed using type C and type B and the formation of the ink receiving layers 902 using type A and type D is stopped.

Pattern 2: Ink receiving layers 902 are formed using type C and type A and the formation of the ink receiving layers 902 using type B and type D is stopped.

Pattern 3: Ink receiving layers 902 are formed using type C, type B, and type D and the formation of the ink receiving layer 902 using type A is stopped.

Pattern 4: Ink receiving layers 902 are formed using type C, type A, and type D and the formation of the ink receiving layer 902 using type B is stopped.

It is possible to take the first state, for example, and set the ink receiving layer forming unit 13B to type F instead of type B and to set the ink receiving layer forming unit 13C to type E instead of type A. It is possible to operate the recording medium manufacturing apparatus 1 in this state (hereinafter referred to as “the second state”). The operation patterns in the second state include the following patterns, for example.

Pattern 5: Ink receiving layers 902 are formed using type C and type E and the formation of the ink receiving layers 902 using type A and type D is stopped.

Pattern 6: Ink receiving layers 902 are formed using type C and type F and the formation of the ink receiving layers 902 using type B and type D is stopped.

According to the operation of pattern 1, first, the first ink receiving layer 902 (hereinafter referred to as “an ink receiving layer 902b”) is formed using type C on the transport belt 161 (refer to FIG. 12). Next, the second ink receiving layer 902 (hereinafter referred to as “an ink receiving layer 902c”) is formed using type B on the ink receiving layer 902b (refer to FIG. 12). In the recording medium 90 which is manufactured in this manner, the ink is held mainly by the ink receiving layer 902c and further infiltration by the ink is prevented by the ink receiving layer 902b. Accordingly, in the recording medium 90, the ink bleeding in the reverse surface, that is, show-through is prevented. The recording medium 90 is mainly suitable for printing of images in which the ink dot disposition density is comparatively high such as in graphic images and photographic images.

According to the operation of pattern 2, first, the ink receiving layer 902b is formed using type C on the transport belt 161 (refer to FIG. 12). Next, the ink receiving layer 902c is formed using type A on the ink receiving layer 902b. In the recording medium 90 which is manufactured in this manner, the ink is held mainly by the ink receiving layer 902c and further infiltration by the ink is prevented by the ink receiving layer 902b. The recording medium 90 is mainly suitable for printing of characters.

According to the operation of pattern 3, the recording medium 90 is obtained (refer to FIG. 13) in which the third ink receiving layer 902 (hereinafter referred to as “an ink receiving layer 902d”) is further laminated, using type D, onto the recording medium 90 which is obtained by pattern 1. The recording medium 90 has the same function as the recording medium 90 which is obtained by pattern 1 and becomes a colored recording medium 90 in which the color of the pigment is further reflected.

According to the operation of pattern 4, the recording medium 90 is obtained in which the third ink receiving layer 902d is further laminated, using type D, onto the recording medium 90 which is obtained by pattern 2. The recording medium 90 has the same function as the recording medium 90 which is obtained by pattern 2 and becomes a colored recording medium 90 in which the color of the pigment is further reflected.

According to the operation of pattern 5, the ink receiving layer 902b is formed using type C and the ink receiving layer 902c is formed using type E. The recording medium 90 which is manufactured in this manner is mainly suitable for printing of graphic images and the like and becomes a colored recording medium 90 in which infiltration by the ink is prevented by the ink receiving layer 902c.

According to the operation of pattern 6, the ink receiving layer 902b is formed using type C and the ink receiving layer 902c is formed using type F. The recording medium 90 which is manufactured in this manner is mainly suitable for printing of characters and becomes a colored recording medium 90 in which infiltration by the ink is prevented by the ink receiving layer 902c.

According to this configuration, it is possible to form ink receiving layers 902 which have different characteristics (properties) according to the ink receiving layer forming unit 13 which is selected and used during the layer formation. Accordingly, it is possible to obtain various recording media 90 having different characteristics (properties).

In the recording medium manufacturing apparatus 1, although four each of the material supplying section 2 and the second carrying body 131 (the carrying body) are disposed in the present embodiment, the number to be disposed is not particularly limited.

In the recording medium 90 which is configured by a laminate body, for example, an intermediate layer which is configured by a different material from the fiber-containing material may be disposed between the ink receiving layers 902. The function of the intermediate layer is not particularly limited, and for example, a function of increasing the adherence between the ink receiving layers 902 or the like is exemplified.

### Sixth Embodiment

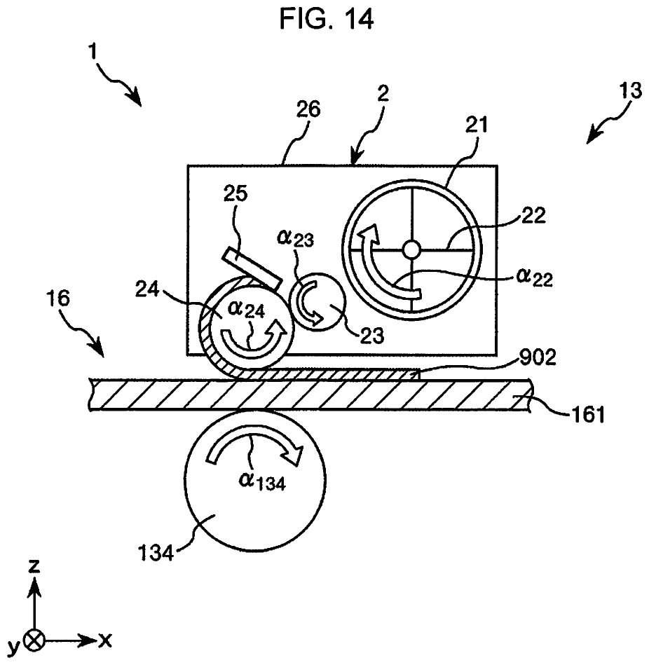

FIG. 14 is a vertical sectional side view illustrating a material supplying section which is included in a recording medium manufacturing apparatus (a sixth embodiment) of the invention.

Hereinafter, a description will be given of the sixth embodiment of the recording medium manufacturing apparatus of the invention with reference to the drawings and the description will be given centered on the points which differ from the previously-described embodiments, omitting the description of items which are the same.

As illustrated in FIG. 14, in the present embodiment, unlike in the embodiments which are described above, the ink receiving layer forming unit 13 is configured to omit the second carrying body 131, the charging unit 132, and the exposing unit 133. Accordingly, it is possible to directly transfer the fiber-containing material from the first carrying body 24 onto the transport belt 161 to form the ink receiving layer 902 having a rectangular (or square) shape in plan view.

As described above, in the present embodiment, it is possible to perform the formation using a simple configuration in which the second carrying body 131, the charging unit 132, and the exposing unit 133 are omitted from the ink receiving layer forming unit 13 when forming the ink receiving layer 902 having a rectangular (or square) shape in plan view.

### Seventh Embodiment

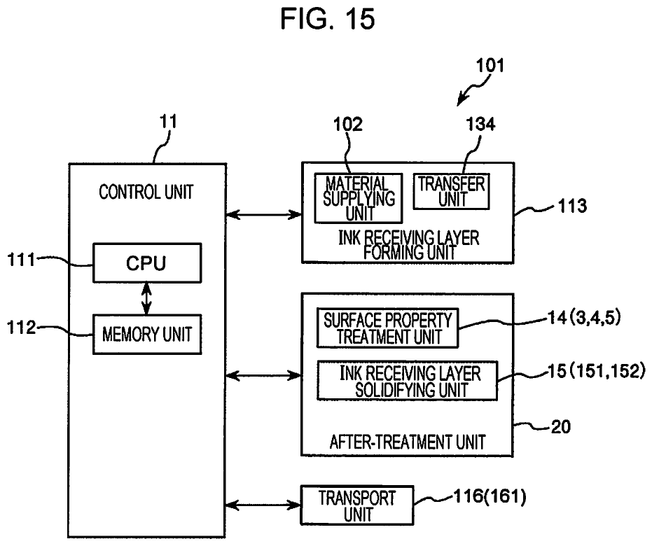

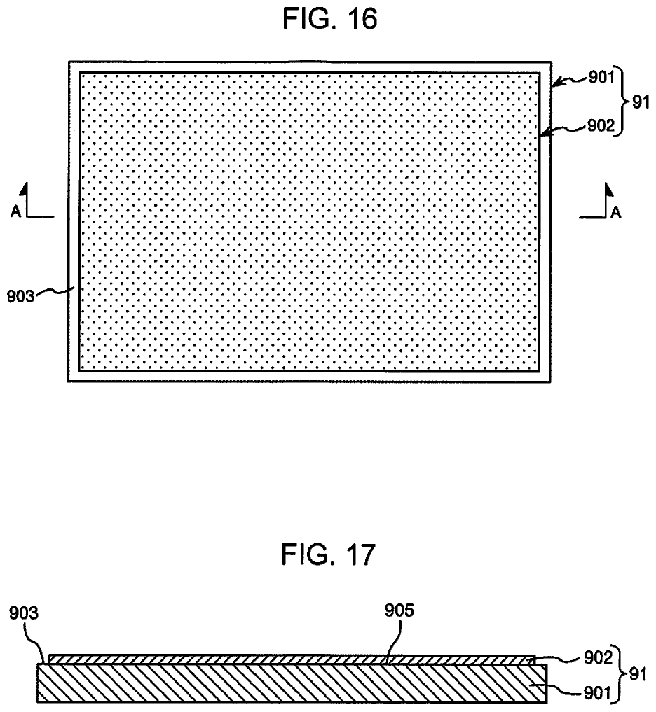

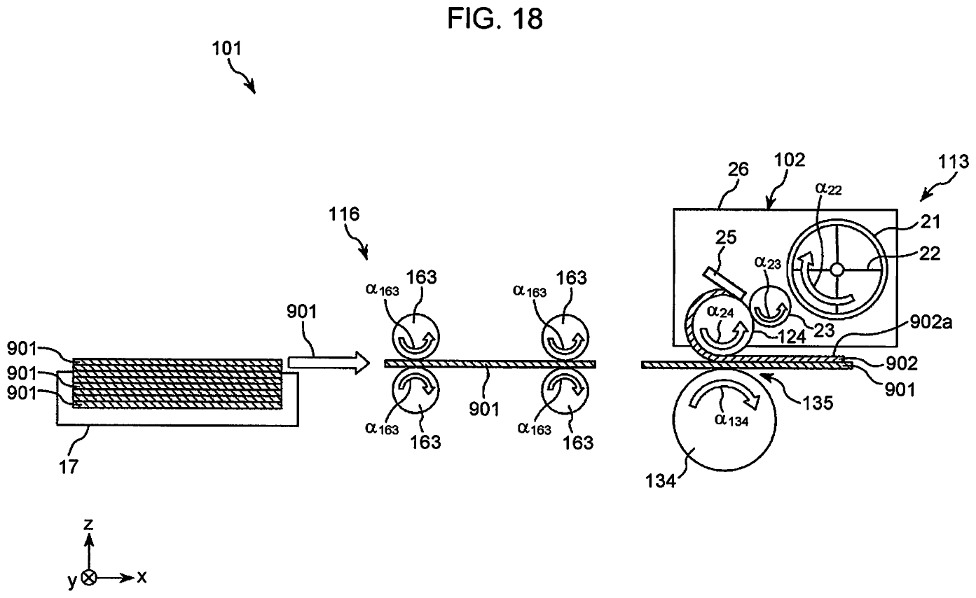

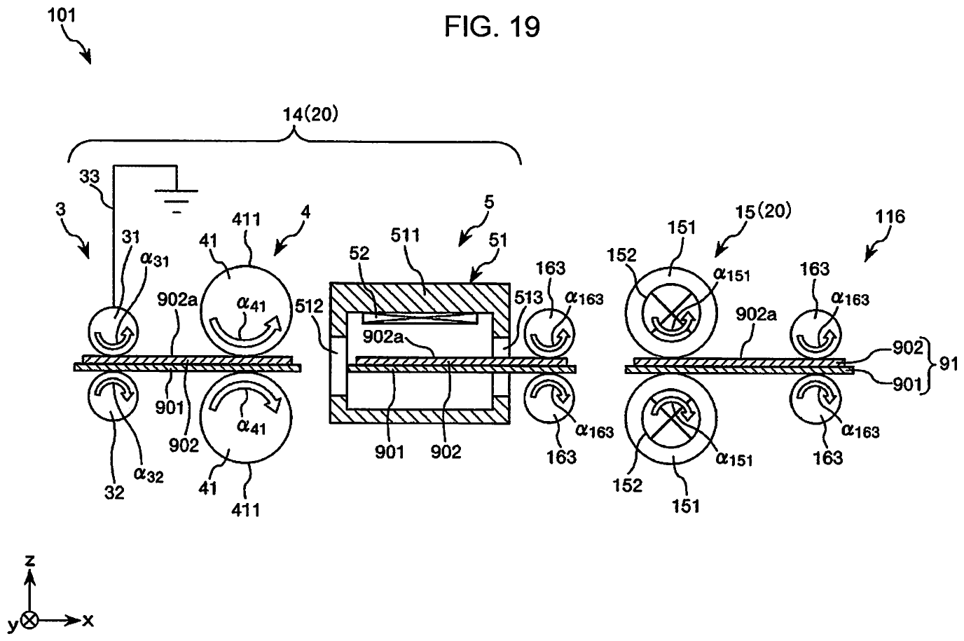

FIG. 15 is a block diagram illustrating main portions of a recording medium manufacturing apparatus (a seventh embodiment) of the invention. FIG. 16 is a plan view illustrating an example of a recording medium which is manufactured by the recording medium manufacturing apparatus illustrated in FIG. 15. FIG. 17 is a sectional diagram taken along a line A-A in FIG. 16. FIGS. 18 and 19 are each a vertical sectional side view illustrating, in order, the process of manufacturing the recording medium using the recording medium manufacturing apparatus illustrated in FIG. 15.

Hereinafter, a description will be given of the seventh embodiment of the recording medium manufacturing apparatus of the invention with reference to the drawings and the description will be given centered on the points which differ from the previously-described embodiments, omitting the description of items which are the same.

A recording medium manufacturing apparatus 101 of the invention is provided with an ink receiving layer forming unit 113, the after-treatment unit 20, a transport unit 116, and the control unit 11 and is an apparatus which forms the ink receiving layer 902 on a substrate 901 to manufacture a recording medium 91. The ink receiving layer forming unit 113 includes at least one material supplying unit 102 and the transfer unit 134 and the after-treatment unit 20 includes the surface property treatment unit 14 and the ink receiving layer solidifying unit 15. Here, the material supplying unit 102 includes the storage unit 21, the stirring device (an agitator) 22, the supply roller 23, a carrying body 124, the blade 25, and the housing 26 (refer to FIG. 17).

The surface property treatment unit 14 includes the leveling process unit 3, the pressure treatment unit 4, and the semi-solidification process unit 5. The ink receiving layer solidifying unit 15 includes the solidifying rollers 151 and the heaters 152. The control unit 11 includes the CPU (central processing unit) 111 and the memory unit 112.

In other words, the recording medium manufacturing apparatus 101 of the invention includes at least one of the material supplying units 102, the transfer unit 134, and the after-treatment unit 20. The material supplying unit 102 includes the storage unit 21 which stores the fiber-containing material containing the cellulose fibers and the resin and the carrying body 124 which carries the fiber-containing material, the transfer unit 134 electrostatically transfers the fiber-containing material which is carried by the carrying body 124 to the transfer-target body (the substrate 901), and the after-treatment unit 20 performs an after-treatment on the fiber-containing material (the ink receiving layer 902) which is electrostatically transferred to the transfer-target body (the substrate 901).

According to the invention, as described later, it is possible to omit the photosensitive body, and thus, it is possible to configure the recording medium manufacturing apparatus 101 in the simplest possible manner. It is possible to electrostatically transfer the fiber-containing material from the carrying body 124 to the transfer-target body (the substrate 901). Accordingly, as described later, it is possible to prevent variation in the adherence amount of the fiber-containing material which adheres to the substrate 901 occurring, that is, it is possible to cause an appropriate amount of the fiber-containing material to adhere to the substrate 901. As a result, it is possible to stably form the ink receiving layer 902 which is configured by the fiber-containing material as a layer having a uniform thickness. It is possible to replace the material supplying unit 102 together with the storage unit 21 and the carrying body 124.

The recording medium 91 illustrated in FIG. 16 is an example of the recording medium 91 which is manufactured by the recording medium manufacturing apparatus 101. As illustrated in FIG. 17, the recording medium 91 includes the sheet-shaped substrate 901 and the ink receiving layer 902 which is formed on the substrate 901. It is possible to use the recording medium 91 of the unused state by carrying out printing on the ink receiving layer 902. Since the various information to be recorded on the ink receiving layer 902 is the same as in the embodiments described above, the description thereof will be omitted.

In a case in which the recording medium 91 on which the printing is carried out is used and is no longer needed, for example, the recording medium 91 is reused as old paper. In this case, the ink receiving layer 902 is removed from the recording medium 91 and the substrate 901 is obtained. By forming the ink receiving layer 902 on the substrate 901 again, the recording medium 91 of the unused state is recycled (manufactured). The substrate 901 is not particularly limited, and for example, may be obtained by removing the ink receiving layer 902 from the recording medium 91 which is used, and may be plain paper copier (PPC) paper which is generally commercially available. It is possible to perform the removal of the ink receiving layer 902 by at least one of cutting, scraping, grinding, and polishing.

First, before describing the configuration of the various components of the recording medium manufacturing apparatus 101, a description will be given of the recording medium 91.

As described earlier, the recording medium 91 includes the substrate 901 and the ink receiving layer 902.

The substrate 901 is the PPC paper, for example. The substrate 901 may be recycled paper which is manufactured by defibrating old paper and may be an OHP sheet (a transparency) which is used in an over head projector (OHP). Although the substrate 901 is flexible, the configuration is not limited thereto and the substrate 901 may be a rigid body. In the configuration illustrated in FIG. 16, although the shape of the substrate 901 in plan view (the shape of the substrate 901 as viewed from the thickness direction) is rectangular, the configuration is not limited thereto. In a case in which the substrate 901 is rectangular in plan view, the size is not particularly limited and, for example, may be A size or B size.

The substrate 901 includes a margin portion 903 in which the ink receiving layer 902 is not provided on at least a portion of the edge portion of the substrate 901 in plan view. In the configuration illustrated in FIG. 16, the margin portion 903 is provided in a belt shape along the entire circumference of the edge portion of the substrate 901. Due to providing the margin portion 903, it is possible to easily remove the ink receiving layer 902 from the margin portion 903 in a case in which the ink receiving layer 902 is removed when reusing the recording medium 91, for example.

It is preferable that the width of the margin portion 903 be, for example, greater than or equal to 1 mm and less than or equal to 10 mm, and it is more preferable that the width be greater than or equal to 3 mm and less than or equal to 7 mm. As long as the width of the margin portion 903 is greater than or equal to the minimum value, it is possible to easily remove the ink receiving layer 902 from the margin portion 903. As long as the width of the margin portion 903 is less than or equal to the maximum value, it is possible to sufficiently secure an area of the ink receiving layer 902 on the substrate 901 of a degree which is printable. Although the margin portion 903 is provided along the entire circumference of the edge portion of the substrate 901, the configuration is not limited thereto and the margin portion 903 may be provided on a portion of the edge portion of the substrate 901.

The ink receiving layer 902 is provided on the substrate 901. In the configuration illustrated in FIG. 17, the ink receiving layer 902 is provided on the surface of one side (a first surface 905 of the top side in the drawing) of the substrate 901. In a case in which the shape of the substrate 901 is rectangular in plan view, it is preferable that the shape of the ink receiving layer 902 in plan view also be rectangular (refer to FIG. 16).

The ink receiving layer 902 is the portion which is printed on using an ink jet system (for example, using an ink jet printer) and is a fiber-containing layer which is configured by a complex (the fiber-containing material) including cellulose fibers and a hydrophobic material which covers at least a portion of the cellulose fibers. It is possible to cause the ink receiving layer 902 to easily receive and allow the infiltration of the ink which is discharged from a print head of an ink jet printer due to the ink receiving layer 902 being the ink receiving layer 902 in which the fiber-containing layer receives the ink. As a result, the printing is carried out on the ink receiving layer 902. As described earlier, various information such as characters, for example, is recorded on the ink receiving layer 902 using printing. Since the complex which is the configuration material of the ink receiving layer 902 being a material which is provided for the recording of information, it is possible to refer to the complex as “an information recording material”.

It is preferable that the thickness of the ink receiving layer 902 be, for example, greater than or equal to 20 μm and less than or equal to 100 μm, and it is more preferable that the thickness be greater than or equal to 30 μm and less than or equal to 70 μm. As long as the thickness of the ink receiving layer 902 is greater than or equal to the minimum value (20 μm), it is possible to suppress the infiltration of the ink which is discharged by the ink jet printer to the substrate 901 on the bottom side of the ink receiving layer 902. As long as the thickness of the ink receiving layer 902 is less than or equal to the maximum value (100 μm), it is possible to suppress the manufacturing cost of the recording medium 91. For example, in a case in which the thickness of the ink receiving layer 902 is thicker than 50 μm, it is possible to obtain the recording medium 91 in which the absorbency and holding properties of the ink in the ink receiving layer 902 are more excellent.

As described later, the ink receiving layer 902 is formed by the complex being caused to adhere to the substrate 901 and being heated under pressure using electrostatic application (application which uses an electrostatic force) by an electrophotographic type of system.

Since the size (length, width), the configuration, the average length, the average aspect ratio, and the like of the cellulose fibers are the same as in the first embodiment, the detailed description thereof will be omitted.

Accordingly, it is possible to improve the uniformity of the charge distribution in a powder formed from the complex which forms the ink receiving layer 902, and as such, it is possible to uniformly electrostatically apply the complex to the substrate 901.

The hydrophobic material is fused with the cellulose fibers through heat treatment to form the complex. Since the hydrophobic material is the same as in the first embodiment, the detailed description thereof will be omitted.

The hydrophobic material has a function of causing the cellulose fibers to bind to each other and has a function of stabilizing the charge characteristics of the complex by covering the cellulose fibers. The hydrophobic material is generally configured by a resin such as those described later. While the resin may be positively charged and may be negatively charged, it is preferable that the resin be negatively charged. In general, the negatively charged resin has particularly excellent charge characteristic stability. In comparison to the positively charged resin, there is a wide selection of types of the negatively charged resin, it is possible to easily perform adjustment of the resin characteristics (for example, the melting point, the glass transition temperature, the bond strength with cellulose fibers, the charge, the degree of hydrophobicity, and the like), and the negatively charged resin is beneficial from the perspective of suppressing the manufacturing cost of the recording medium 91 and the like.

While it is possible to use a thermoplastic resin, a curable resin, or the like for the resin which configures the hydrophobic material, it is preferable to use a thermoplastic resin. In particular, when the hydrophobic material includes the thermoplastic resin, generally, more stable charge characteristics (particularly, the charge characteristics) may be obtained. When the hydrophobic material includes the curable resin, it is possible to render, in particular, the heat resistance, the durability, and the like of the recording medium 91 excellent. Accordingly, in addition to the hydrophobic material including the thermoplastic resin in isolation, the hydrophobic material may include both the thermoplastic resin and the curable resin. Since the thermoplastic resin is the same as in the first embodiment, the detailed description thereof will be omitted.

It is preferable that the glass transition temperature (Tg) of the thermoplastic resin be greater than or equal to 50° C. and less than or equal to 200° C., and it is more preferable that the glass transition temperature is greater than or equal to 55° C. and less than or equal to 160° C. As long as the glass transition temperature of the thermoplastic resin is greater than or equal to the minimum value, it is possible to suppress the ink receiving layer 902 being peeled through the degree of heating generated by friction, and it is possible to suppress a reduction in the strength of the ink receiving layer 902. As long as the glass transition temperature of the thermoplastic resin is less than or equal to the maximum value, for example, it is not necessary to heat the recording medium 91 to a temperature which is higher than the maximum value when heating and pressurizing the complex which serves as the ink receiving layer 902 to fix the complex, and it is possible to suppress the cellulose fibers receiving damage through the heating. Even in a case in which the ink receiving layer 902 is peeled as described earlier, it is possible to soften the ink receiving layer 902 through the heating, and at this time, it is not necessary to heat the recording medium 91 to a higher temperature than the maximum value. Since the curable resin is the same as in the first embodiment, the detailed description thereof will be omitted.

When the resin (the thermoplastic resin) content in the ink receiving layer 902 (the fiber-containing layer) is Wa, it is preferable that Wa be greater than or equal to 10 mass and less than 40 mass %, and it is more preferable that Wa be greater than or equal to 15 mass % and less than or equal to 30 mass %. As long as the content Wa is greater than or equal to the minimum value (10 mass %), it is possible to secure the binding force of the cellulose fibers and it is possible to suppress the cellulose fibers being lost from the ink receiving layer 902. As long as the content Wa is less than the maximum value (40 mass %), it is possible to suppress the hydrophobicity of the ink receiving layer 902 being too high and deflecting the ink and it is possible to improve the print quality. Even if the complex is in a state before the complex adheres onto the substrate 901 and even if the complex is in a state of being adhered onto the substrate 901 to form the ink receiving layer 902, it is preferable that the content Wa be within the numerical value range.

The hydrophobic material may include a charge controlling agent (a charge controller). Accordingly, the complex which serves as the ink receiving layer 902 may have a stable charge and may have a greater charge. It is possible to confirm whether or not the complex includes a charge controlling agent according to, in addition to a change in the charge amount of the complex, a reduction in the repose angle of the complex. The charge controlling agent may have a function as an agglomeration suppressing agent which suppresses the agglomeration of the complex. In the hydrophobic material, the charge controlling agent, ordinarily at least a portion of the charge controlling agent, is exposed to the surface of the resin. Accordingly, the effect of including the charge controlling agent is more effectively exhibited. Since the charge controlling agent is the same as in the first embodiment, the detailed description thereof will be omitted.

The hydrophobic material may include a white pigment. Accordingly, it is possible to favorably adjust the whiteness of the ink receiving layer 902. For example, even in a case in which the cellulose fibers having a low whiteness are used for the substrate 901 having a low whiteness, depending on the white pigment, it is possible to form the ink receiving layer 902 having high whiteness and it is possible to improve the appearance (the quality) of the printing.

Since the white pigment material and the blending quantity are the same as in the first embodiment, the detailed description thereof will be omitted. Accordingly, it is possible to more favorably increase the whiteness of the ink receiving layer 902 while suppressing a rise in the manufacturing cost of the recording medium 91. The white pigment may be positioned on either the surface or the inner portion of the resin.

For example, in a case in which, after mixing 10 parts by mass of calcium carbonate which is the white pigment to 90 parts by mass of polyester inside a hopper, the mixture is placed in a twin-screw kneading extruder and is melted and kneaded to manufacture white resin pellets, the ink receiving layer 902 which is formed from the resin pellets attains a higher whiteness.

The hydrophobic material may include other components. For example, the hydrophobic material may include pigments and dyes other than the white pigment. In this case, it is possible to obtain colored paper easily at low cost using electrostatic application.

It is preferable that the absolute value of the average charge amount of the complex which forms the ink receiving layer 902 be greater than or equal to 3 μC/g. Setting the absolute value of the average charge amount of the complex to a high value ensures that it is possible to easily adhere the complex onto the substrate 901 using electrostatic application to form the ink receiving layer 902. Since the method of obtaining the measurement of the charge amount and the average charge amount of the complex is the same as in the first embodiment, the detailed description thereof will be omitted.

Next, a description will be given of the configuration of the various parts of the recording medium manufacturing apparatus 101. As illustrated in FIG. 15, the recording medium manufacturing apparatus 101 is provided with the control unit 11, the ink receiving layer forming unit 113 which includes the material supplying unit 102 and the transfer unit 134, the after-treatment unit 20 which includes the surface property treatment unit 14 and the ink receiving layer solidifying unit 15 and the transport unit 116.

Since the control unit 11 is the same as in the first embodiment, the detailed description thereof will be omitted.

As illustrated in FIGS. 18 and 19, the transport unit 116 transports the substrate 901 before the ink receiving layer 902 is formed or the substrate 901 on which the ink receiving layer 902 is formed (the recording medium 91) and is provided along each stage of before the manufacturing, during the manufacturing, and after the manufacturing of the recording medium 91.

The transport unit 116 includes a plurality of transport rollers 163. Two of the transport rollers 163 form a group and are configured to transport the substrate 901 while pinching the substrate 901 therebetween. Each group of the transport rollers 163 is disposed leaving an interval along the transport direction of the substrate 901. It is preferable that the interval between the transport rollers 163 of each adjacent group be smaller than the length of the substrate 901 in the x-axis direction (the transport direction).

Each of the transport rollers 163 is capable of transporting the substrate 901 by rotating in an arrow α₁₆₃ direction. In the present embodiment, in the transport unit 116, it is not necessary for all of the transport rollers 163 to be drive rollers which are connected to motors, and as long as the transporting of the substrate 901 is possible, which of the transport rollers 163 are drive rollers is arbitrary. The transport unit 116 is configured to be capable of modifying the transport speed at which to transport the substrate 901. The modification method is not particularly limited, and examples of the modifying method include a method of adjusting the voltage to be applied to the motor which is connected to the transport roller 163.

As illustrated in FIG. 18, the substrate 901 before the ink receiving layer 902 is formed is supplied to the transport unit 116 from a tray 17. The supplying may be performed automatically and may be performed manually. It is preferable that the substrates 901 be supplied one sheet at a time (every sheet) to the transport unit 116. The substrate 901 on which the ink receiving layer 902 is formed is collected separately from the transport unit 116 at the downstream side in the transport direction. The collection may be performed automatically and may be performed manually.

The ink receiving layer forming unit 113 is disposed in the middle of the transport direction of the substrate 901. As illustrated in FIG. 18, the ink receiving layer forming unit 113 is a device which forms the ink receiving layer 902 on the substrate 901 using the fiber-containing material (the complex which serves as the ink receiving layer 902). The ink receiving layer forming unit 113 is provided with the material supplying unit 102 which includes the carrying body 124 and the like and the transfer unit 134 and is a device which forms the ink receiving layer 902 on the substrate 901 using electrostatic application.

The material supplying unit 102 is capable of moving and adhering the fiber-containing material to the substrate 901. The material supplying unit 102 includes the storage unit 21, the stirring device (an agitator) 22, the supply roller 23, the carrying body 124, the blade 25, and the housing 26.

The storage unit 21 stores the powder-form fiber-containing material in the inner portion of the storage unit 21.

The stirring device 22 is capable of rotating in an arrow α₂₂ direction inside the storage unit 21. Accordingly, it is possible to stir and charge the fiber-containing material inside the storage unit 21. The fiber-containing material is supplied to the carrying body 124 via the supply roller 23 which rotates in the arrow α₂₃ direction.

The carrying body 124 is a roller which carries the fiber-containing material which is discharged from the storage unit 21. The carrying body 124 has a potential difference between itself and the fiber-containing material which is supplied via the supply roller 23 and the fiber-containing material electrostatically adheres to the carrying body 124 while the carrying body 124 rotates in the arrow α₂₄ direction. The potential difference between the carrying body 124 and the supply roller 23 is set as appropriate. The setting of the potential difference is controlled by the control unit 11. The carrying body 124 is configured to be capable of modifying the circumferential speed. The modification method is not particularly limited, and for example, the modification method is possible by modifying the voltage which is applied to the motor which is connected to the carrying body 124.

The blade 25 adjusts the thickness (the adherence amount) of the fiber-containing material which adheres onto the carrying body 124 to form a thin film and friction charges the fiber-containing material.

The housing 26 has a box shape, for example, and is a storage portion which stores the storage unit 21 in which the stirring device 22 is embedded, the supply roller 23, the carrying body 124, and the blade 25 together inside the housing 26.

The transfer unit 134 electrostatically transfers the fiber-containing material which is carried by the carrying body 124 to the substrate 901 which is the transfer-target body. The transfer unit 134 is an idle roller which rotates in the arrow α₁₃₄ direction which is opposite to the arrow α₂₄ direction. The transfer unit 134 is disposed on the bottom side of the carrying body 124 and is capable of pinching the substrate 901 between the transfer unit 134 and the carrying body 124. In this state, the carrying body 124 is capable of rotating in the arrow α₂₄ direction and the transfer unit 134 is capable of rotating in the arrow α₁₃₄ direction. The transfer unit 134 forms the transfer nip 135 which is a gap (space) between the transfer unit 134 and the carrying body 124. At the transfer nip 135, a potential difference is generated between the transfer unit 134 and the carrying body 124. Accordingly, the fiber-containing material on the carrying body 124 moves electrostatically to the transfer unit 134 side and is transferred stably to the substrate 901. The transferred fiber-containing material forms a layer shape together with the movement of the substrate 901 to form the ink receiving layer 902. The transfer unit 134 has a function as a transport roller which transports the substrate 901 together with the transport rollers 163 of the transport unit 116.

Meanwhile, in the recording medium manufacturing apparatus 101, the ink receiving layer 902 which is formed on the substrate 901 has a comparatively uncomplicated (simple) rectangular shape in which the shape in plan view is rectangular (or square) (refer to FIG. 16). The ink receiving layer 902 having such a plan-view shape is continuously formed. Therefore, since the necessity to form images of a large variety of shapes is low in the recording medium manufacturing apparatus 101, it is possible to omit the photosensitive body and directly transfer the fiber-containing material from the carrying body 124 to the substrate 901. Accordingly, it is possible to render the recording medium manufacturing apparatus 101 as simple a configuration as possible.

In the recording medium manufacturing apparatus 101, the fiber-containing material is electrostatically transferred from the carrying body 124 to the substrate 901 (the transfer-target body). Since the photosensitive body which has drastic characteristic degradation is not used, it is possible to prevent variation in the adherence amount of the fiber-containing material which adheres to the substrate 901 occurring, that is, it is possible to cause an appropriate amount of the fiber-containing material to adhere to the substrate 901. The carrying body 124 is configured by a metal roller or a roller having a conductive body on the surface layer, has extremely little degradation, and has a long lifespan. As a result, it is possible to stably form the ink receiving layer 902 which is obtained from the fiber-containing material as a layer having a uniform thickness.

The transfer unit 134 is capable of transferring the fiber-containing material to the substrate 901 which is the transfer-target body using the electrostatic force which is generated by the potential difference between the transfer unit 134 and the carrying body 124. In this manner, it is possible to easily and appropriately cause the fiber-containing material to adhere to the substrate 901 using a simple method which uses the electrostatic force (electrostatic transfer). Using the electrostatic transfer contributes to a reduction in the size and a reduction in the noise of the recording medium manufacturing apparatus 101.

As described earlier, in the present embodiment, the transfer-target body onto which the fiber-containing material on the carrying body 124 is transferred is the substrate 901 which configures the recording medium 91 together with the fiber-containing material. Accordingly, it is possible to swiftly manufacture the recording medium 91 which is configured by the substrate 901 and the ink receiving layer 902.

The after-treatment unit 20 is disposed on the downstream side, that is, the x-axis direction positive side of the ink receiving layer forming unit 113. The after-treatment unit 20 performs an after-treatment on the fiber-containing material which is electrostatically transferred to the substrate 901 and includes the surface property treatment unit 14 and the ink receiving layer solidifying unit 15.

The ink receiving layer 902 directly after being formed by the ink receiving layer forming unit 113 assumes a state in which, for example, various irregularities such as line irregularities, undulation, and the like (hereinafter, “line irregularities” are represented) occur. Although depending on the degree of the state, there is a case in which the state impedes, to some extent, the reception of the ink by the ink receiving layer 902, for example. Therefore, it is necessary to perform a treatment which regulates the surface properties of the ink receiving layer 902 in which irregularities occur and the surface property treatment is performed by the surface property treatment unit 14. In the present embodiment, the surface property treatment includes a leveling process which levels and planarizes the surface 902a of the ink receiving layer 902, a pressure treatment which pressurizes the ink receiving layer 902, and a semi-solidification process which semi-solidifies the surface 902a of the ink receiving layer 902. Examples of the origin of the occurrence of the irregularities in the ink receiving layer 902 include those originating in assembly error between the components which configure the ink receiving layer forming unit 113 (a drive gear pitch error during the forming of the layer or during the transferring, for example), those originating in discharging during the transferring, and those originating in the ink receiving layer 902 breaking due to transporting vibrations after the transferring.

As illustrated in FIG. 19, the surface property treatment unit 14 includes the leveling process unit 3, the pressure treatment unit 4, and the semi-solidification process unit 5. The leveling process unit 3, the pressure treatment unit 4, and the semi-solidification process unit 5 are disposed in this order along the transport direction of the substrate 901.

The surface property treatment includes a treatment (a leveling process) which levels and planarizes, that is, smoothens the surface 902a of the ink receiving layer 902 (the fiber-containing material which forms a layer shape) as described earlier. It is possible to render the surface 902a of the ink receiving layer 902 a smooth state using the leveling process.

The leveling process is performed by the leveling process unit 3 in the surface property treatment unit 14. As illustrated in FIG. 19, the leveling process unit 3 includes the leveling roller 31 and the support roller 32.

The leveling roller 31 is capable of rotating in the arrow α₃₁ direction due to a motor (not illustrated) which is the drive source of the leveling roller 31. The leveling roller 31 is capable of contacting the surface 902a of the ink receiving layer 902. The rotation of the leveling roller 31 is adjusted such that the speed in the tangential direction at the point of contact with the surface 902a is less than the transport speed of the substrate 901. Accordingly, minute unevenness and the like which forms the line irregularities is crushed as the surface 902a of the ink receiving layer 902 moves to the x-axis direction positive side and the fiber-containing material is pushed back to the upstream side. Accordingly, the undulation, unevenness, and the like are leveled and reduced and the surface 902a of the ink receiving layer 902 is smoothened (planarized). The material which is pushed back from the ink receiving layer 902 may be separately collected and disposed and may be reused. The rotation of the leveling roller 31 is controlled by the control unit 11.

It is preferable that the outer circumferential surface of the leveling roller 31 be configured by a metal material such as stainless steel, for example. Although not particularly limited, it is preferable that the surface roughness (center line average roughness Ra) of the outer circumferential surface of the leveling roller 31 be greater than or equal to 0.1 μm and less than or equal to 100 μm, for example.

The ink receiving layer 902 is charged by the static electricity which is generated by the friction with the leveling roller 31. Therefore, the leveling roller 31 is grounded via the earth line 33. Accordingly, it is possible to discharge the leveling roller 31, and thus, it is possible to prevent the adherence of the powder of the fiber-containing material which configures the ink receiving layer 902 on the leveling roller 31. In the surface property treatment unit 14, it is possible to perform discharging on the ink receiving layer 902 during the transporting of the ink receiving layer 902 (the fiber-containing material).

The support roller 32 is disposed on the bottom side of the leveling roller 31. The support roller 32 is an idle roller which rotates in the arrow α₃₂ direction. Accordingly, the support roller 32 is capable of supporting the substrate 901 on which the ink receiving layer 902 is formed from beneath, and thus, it is possible to sufficiently perform the leveling process (the planarization process) on the surface 902a of the ink receiving layer 902. The support roller 32 has a function as a transport roller which transports the substrate 901 together with the transport rollers 163 of the transport unit 116.

The surface property treatment includes a treatment (a pressure treatment) which pressurizes the ink receiving layer 902 (the fiber-containing material which forms the layer shape) as described earlier. According to the pressure treatment, the fiber-containing material bonds to itself inside the ink receiving layer 902.

In the surface property treatment unit 14, the pressure treatment is performed by the pressure treatment unit 4. As illustrated in FIG. 19, the pressure treatment unit 4 is a calendering machine which includes two pressurizing rollers 41, outer circumferential portions 411 of which are configured by a metal material such as stainless steel. The two pressurizing rollers 41 are idle rollers which are disposed above and below and rotate in the arrow α₄₁ direction. When the ink receiving layer 902 passes between the two pressurizing rollers 41, it is possible to pressurize the ink receiving layer 902 in a direction in which the layer thickness is reduced. Accordingly, the pressure treatment is carried out, and thus, the fiber-containing material bonds to itself inside the ink receiving layer 902. Inside the ink receiving layer 902 which is pressurized, the density of the fiber-containing material increases and the density is also rendered uniform. It is preferable that the force of the two pressurizing rollers 41 pressurizing the ink receiving layer 902 be strong pressurization greater than or equal to 5 kg and less than or equal to 200 kg, for example, and it is more preferable that the force be strong pressurization greater than or equal to 20 kg and less than or equal to 80 kg. Although the pressurization of the ink receiving layer 902 is performed one time in the present embodiment, the configuration is not limited thereto and the pressurization may be performed stepwise over a plurality of times, for example. The pressurizing roller 41 of the bottom side has a function as a transport roller which transports the substrate 901 together with the transport rollers 163 of the transport unit 116. The two pressurizing rollers 41 may be configured such that the inter-center distance is variable. Accordingly, it is possible to adjust the pressurizing force. The adjustment is also controlled by the control unit 11.

The surface property treatment includes a process (a semi-solidification process) which semi-solidifies the surface 902a of the ink receiving layer 902 (the fiber-containing material which forms the layer shape) as described earlier. According to the semi-solidification process, a thin film is formed on the surface 902a of the ink receiving layer 902 and contributes to the shape maintenance of the ink receiving layer 902 and the like.

In the surface property treatment unit 14, the semi-solidification process is performed by the semi-solidification process unit 5. As illustrated in FIG. 19, the semi-solidification process unit 5 includes the chamber 51 and the heater 52.

The chamber 51 includes the heat-insulating wall 511 which is configured by a heat-insulating material. The chamber 51 includes the entrance 512 and the exit 513. Accordingly, the substrate 901 is capable of passing through the inside of the chamber 51 together with the ink receiving layer 902.

The heater 52 is disposed on the top side inside the chamber 51. It is preferable that the heater 52 be configured by a heat emitting body which emits heat through electrical conduction, and for example, it is possible to use a halogen heater (a halogen lamp). Accordingly, the ink receiving layer 902 is heated without contact from the top side as the ink receiving layer 902 passes through the inside of the chamber 51. According to the heating, the thermoplastic resin is once melted at the surface 902a side of the ink receiving layer 902. When the ink receiving layer 902 leaves the inside of the chamber 51, the melted thermoplastic resin is cooled naturally, for example, is bound, and is cured. Through the curing, a thin film is formed on the surface 902a with respect to the layer thickness of the ink receiving layer 902. According to this layer formation, for example, it is possible to prevent the fiber-containing material from splattering from the ink receiving layer 902 due to the static electricity which is generated by the contact with the ink receiving layer solidifying unit 15 which is disposed next after the surface property treatment unit 14, and to prevent the shape of the ink receiving layer 902 from breaking under the vibrations caused by the transporting.

The heating temperature of the semi-solidification process unit 5 is greater than or equal to the glass transition temperature of the thermoplastic resin, for example, and is greater than or equal to the melting point of preferably the thermoplastic resin. The heating temperature is controlled by the control unit 11. The heating time of the semi-solidification process unit 5 is obtained using the relationship between the distance which the substrate 901 (the ink receiving layer 902) moves inside the chamber 51 and the transport speed of the substrate 901, for example.

As described earlier, the fiber-containing material which is electrostatically transferred onto the substrate 901 (the transfer-target body) forms a layer shape. The surface property treatment unit 14 of the after-treatment unit 20 is capable of performing, as after-treatments, various surface property treatments which regulate the surface properties of the fiber-containing material which forms the layer shape, that is, the ink receiving layer 902. Accordingly, the ink receiving layer 902 is capable of stably receiving the ink.

As illustrated in FIG. 19, the ink receiving layer solidifying unit 15 is disposed on the downstream side, that is, the x-axis direction positive side of the surface property treatment unit 14. The ink receiving layer solidifying unit 15 includes the two solidifying rollers 151. The two solidifying rollers 151 are disposed above and below and rotate in the arrow α₁₅₁ direction. The heater 152 is embedded in each of the solidifying rollers 151. It is preferable that the heater 152 be configured by a heat emitting body which emits heat through electrical conduction, and for example, it is possible to use a halogen heater (a halogen lamp). When the ink receiving layer 902 passes between the two solidifying rollers 151, it is possible to pressurize the ink receiving layer 902 in a direction in which the layer thickness is reduced while heating the ink receiving layer 902. Accordingly, it is possible to sufficiently melt the entirety of the thermoplastic resin inside the ink receiving layer 902. After the ink receiving layer 902 passes between the two solidifying rollers 151, the melted thermoplastic resin is naturally cooled, binds and solidifies, for example. Accordingly, the ink receiving layer 902 which is appropriately solidified is formed. It is preferable that the force of the two solidifying rollers 151 pressurizing the ink receiving layer 902 be greater than or equal to 1 kg and less than or equal to 100 kg, and it is more preferable that the force be greater than or equal to 10 kg and less than or equal to 30 kg, for example. It is preferable that the temperature at which to heat the ink receiving layer 902 be greater than or equal to 100° C. and less than or equal to 200° C., and it is more preferable that the temperature be greater than or equal to 120° C. and less than or equal to 180° C. The temperature at which to heat the ink receiving layer 902 is not limited to this numerical value range, and it is possible to modify according to the type of the thermoplastic resin. In this case, it is preferable that the thermoplastic resin be heated until the thermoplastic resin is softened or melts.

As described earlier, the fiber-containing material which is electrostatically transferred onto the substrate 901 (the transfer-target body) forms a layer shape. The ink receiving layer solidifying unit 15 of the after-treatment unit 20 is capable of performing, as an after-treatment, a solidifying process which solidifies the fiber-containing material which forms the layer shape, that is, the ink receiving layer 902. Accordingly, the ink receiving layer 902 is solidified appropriately, and thus, for example, in a case in which the ink receiving layer 902 is used in an ink jet printer, has a strength of a degree capable of sufficiently withstanding the printing.

In the recording medium 91 which is manufactured by the recording medium manufacturing apparatus 101, the printing is performed favorably using an ink jet system, for example. In the recording medium 91, the printing is also performed favorably using a laser printer or a copier which use toner. The recording medium 91 may also be used favorably for handwriting. In the case of handwriting, for example, it is possible to use an oil-based ink pen, an aqueous ink pen, a pencil, or the like.

It is possible to install the recording medium manufacturing apparatus 101 in all manner of places such as offices, factories, homes, stores such as supermarkets and convenience stores, and public institutions such as schools, hospitals, stations, and public halls.

### Eighth Embodiment

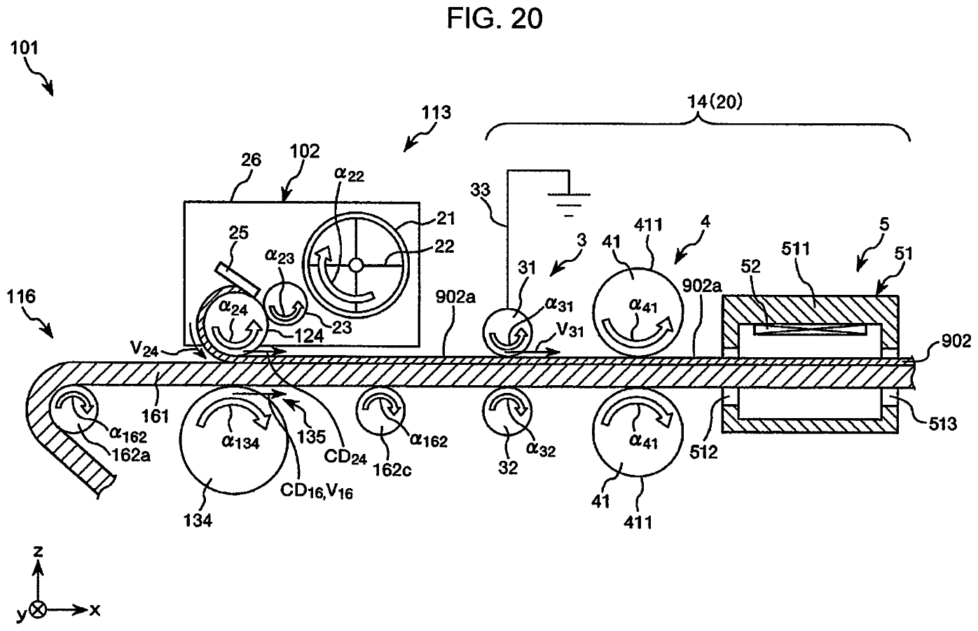

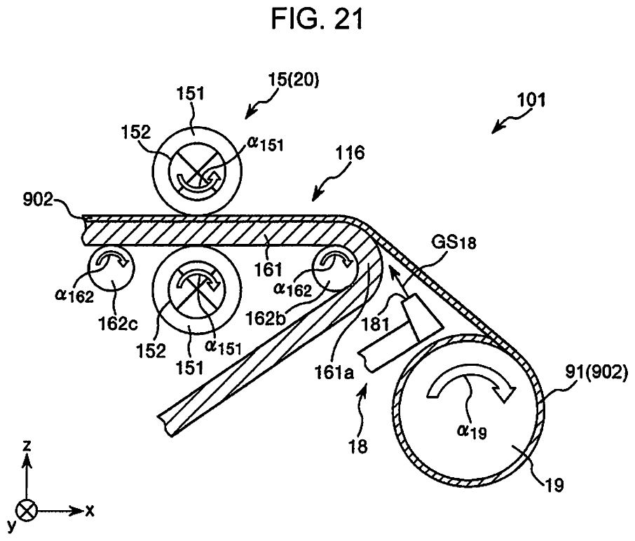

FIGS. 20 and 21 are each a vertical sectional side view illustrating, in order, the process of manufacturing the recording medium using the recording medium manufacturing apparatus (the eighth embodiment) of the invention.

Hereinafter, a description will be given of the eighth embodiment of the recording medium manufacturing apparatus of the invention with reference to the drawings and the description will be given centered on the points which differ from the previously-described embodiments, omitting the description of items which are the same.

As illustrated in FIG. 20, in the present embodiment, the transfer-target body onto which the fiber-containing material on the carrying body 124 is transferred is the transport belt 161 (the belt) transports the fiber-containing material. In the recording medium manufacturing apparatus 101, the transport unit 116 includes the transport belt 161 (the belt). The fiber-containing material which is transferred onto the transport belt 161 moves to the downstream side together with the driving of the transport belt 161 and forms a belt shape. The belt-shaped fiber-containing material forms the ink receiving layer 902. In the recording medium manufacturing apparatus 101 of the present embodiment, the transfer-target body is the transport belt 161. Accordingly, it is possible to obtain the recording medium 91 in which the substrate 901 is omitted and which is configured by the ink receiving layer 902. The transport unit 116 includes the transport roller 162a, the transport roller 162b, and the plurality of transport rollers 162c.

The transport belt 161 is configured by an endless belt in the present embodiment and is capable of transporting the fiber-containing material toward the x-axis direction positive side with the fiber-containing material placed thereon. It is preferable that the transport belt 161 have sufficient strength of a degree at which the transport belt 161 is capable of withstanding the transporting of the fiber-containing material and that the transport belt 161 have sufficient flexibility of a degree at which the transport belt 161 functions as an endless belt. It is preferable that at least the surface of the obverse side of the transport belt 161 be configured by a resin having medium to high resistance (volume resistivity of 10⁷ to 10¹¹ Ω·cm). The configuration material is not particularly limited, and for example, it is possible to use a material in which carbon black is kneaded into a fluorine-based resin. Accordingly, in the ink receiving layer forming unit 113, a powder of the fiber-containing material is transferred to the transport belt 161 using a potential difference and is electrostatically held on the transport belt 161. It is possible to peel the fiber-containing material from the transport belt 161 using a reduction in the electrostatic holding force in the wrap-around portion 161a of the transport belt 161, which is caused by rendering the transport roller 162b low resistance (a volume resistivity of less than or equal to 10⁶ Ω·cm) or conductive and grounding the transport roller 162b, and the curvature of the wrap-around portion 161a. In this manner, it is possible to prevent the powder of the fiber-containing material which configures the ink receiving layer 902 from remaining on the transport belt 161. It is possible to easily peel the ink receiving layer 902 (the recording medium 91) which is configured by the fiber-containing material from the transport belt 161.

The transport belt 161 is stretched around the transport roller 162a and the transport roller 162b. The transport roller 162a is a main drive roller which is connected to a motor via a speed reducer, for example. The transport roller 162b is a follower roller to which the rotational force of the transport roller 162a is transmitted via the transport belt 161 such that the transport roller 162b rotates. In the present embodiment, the transport roller 162a is disposed on the upstream side in the transport direction of the fiber-containing material of the transport belt 161 (the transport unit 116) and the transport roller 162b is disposed on the downstream side. However, the configuration is not limited thereto, and for example, the transport roller 162b may be disposed on the upstream side and the transport roller 162a may be disposed on the downstream side. The plurality of transport rollers 162c are disposed at an interval between the transport roller 162a and the transport roller 162b. The transport rollers 162c are idle rollers. It is possible to transport the fiber-containing material which is placed on the transport belt 161 due to the transport roller 162a, the transport roller 162b, and the transport rollers 162c each rotating in an arrow α₁₆₂ direction.

The transport unit 116 is configured to be capable of modifying the speed (the transport speed) V₁₆ at which the fiber-containing material is transported. The modification method is not particularly limited, and examples of the modifying method include a method of adjusting the applied voltage to the motor which is connected to the transport roller 162a via the speed reducer and a method of modifying the aspect ratio in the speed reducer.

As illustrated in FIG. 20, at the transfer nip 135 (on the transfer unit 134), a transport direction CD₂₄ of the fiber-containing material by the carrying body 124 and the transport direction CD₁₆ of the fiber-containing material by the transport unit 116 are the same directions. At the transfer nip 135, the carrying body 124 transports the fiber-containing material which is carried by the carrying body 124 at a speed (circumferential speed) V₂4 (the first speed V1), and the transport belt 161 transports the fiber-containing material which is transferred onto the transport belt 161 at the speed V₁₆ (the second speed V2). When the fiber-containing material is electrostatically transferred from the carrying body 124 to the transport belt 161, it is preferable that the transport direction CD₂₄ of the fiber-containing material by the carrying body 124 and the transport direction CD₁₆ of the fiber-containing material by the transport belt 161 be the same direction and that the relationship of speed V₂4>speed V₁₆ (that is, first speed V1>second speed V2) be satisfied. According to the magnitude relationship, when the fiber-containing material is transferred from the carrying body 124 to the transport belt 161, the fiber-containing material is gathered toward the x-axis direction negative side once (temporarily) and stops at the transfer nip 135. When the stopping of the fiber-containing material at the transfer nip 135 reaches a threshold, the fiber-containing material is transported to the downstream side and forms a layer shape. This phenomenon may manifest with a simple configuration in which a magnitude difference is established between the speed V₂4 and the speed V₁₆, and it is possible to form the ink receiving layer 902 as thickly as possible using this phenomenon. The thickness of the ink receiving layer 902 which is formed using this phenomenon may be greater than or equal to 10 μm, for example, and it is preferable that the thickness may be greater than or equal to 10 μm and less than or equal to 100 μm. It is possible to satisfy the magnitude relationship between the speed V₂4 and the speed V₁₆ by adjusting the rotation speed (the angular speed) of the carrying body 124 or the transport speed of the transport unit 116 (the angular speed of the transport roller 162a which is the main drive roller). Each speed adjustment is controlled by the control unit 11.

It is preferable that the magnitude relationship between the speed V₂4 and the speed V₁₆ satisfy at least one of the following two conditions (two expressions). The first condition is to satisfy the relationship |speed V₂4|/|speed V₁₆|>1.2 (that is, |first speed V1|/|second speed V2|>1.2). The second condition is to satisfy the relationship |speed V₂4|/|speed V₁₆|<15 (that is, |first speed V1|/|second speed V2|<15). It is possible to stably and swiftly perform the forming of as the ink receiving layer 902 to be as thick as possible by satisfying these conditions.

As illustrated in FIG. 21, the wrap-around portion 161a which wraps around at the transport roller 162b on the downstream side is formed in the transport belt 161. The winding unit 19 is disposed on the bottom right in FIG. 21 with respect to the wrap-around portion 161a. The winding unit 19 winds the recording medium 91 which is manufactured in a belt shape (the ink receiving layer 902 which is formed in a belt shape). The winding unit 19 is a roller which rotates in the arrow α₁₉ direction. It is possible to wind the recording medium 91 into a roll shape through the winding unit 19 rotating in a state in which the end portion of the downstream side of the recording medium 91 is fixed to the winding unit 19. When using the recording medium 91, the rolled state is expanded, the recording medium 91 is cut and used, as appropriate. The winding unit 19 is capable of modifying the winding speed at which the recording medium 91 is wound. The modification method is not particularly limited, and examples of the modifying method include a method of adjusting the applied voltage to the motor which is connected to the winding unit 19.

The recording medium 91 peels away from the transport belt 161 as the recording medium 91 is wound. It is preferable that the diameter of the transport roller 162b be a small diameter in order to increase the curvature of the wrap-around portion 161a of the transport belt 161 to facilitate the peeling of the recording medium 91. For example, it is preferable that the diameter be less than or equal to 20 mm, and it is more preferable that the diameter be greater than or equal to 10 mm and less than or equal to 20 mm. It is preferable to reduce the electrostatic holding force at the wrap-around portion 161a of the transport belt 161 by rendering the transport roller 162b a low resistance (a volume resistivity of less than or equal to 10⁶ Ω·cm) or conductive to ground the transport roller 162b.

Accordingly, the peeling of the recording medium 91 from the transport belt 161 is performed smoothly.

As illustrated in FIG. 21, the recording medium manufacturing apparatus 101 includes the peeling promotion unit 18 which promotes the peeling of the recording medium 91 (the fiber-containing material) from the transport belt 161 (the transfer-target body). The peeling promotion unit 18 is a fan which includes an outlet 181 which blows out air GS₁₈. The outlet 181 is disposed between the transport roller 162b and the winding unit 19 and faces the transport roller 162b side. Accordingly, it is possible to cause the air GS₁₈ to flow in between the transport belt 161 and the recording medium 91 at the wrap-around portion 161a of the transport belt 161, and thus, the peeling between the transport belt 161 and the recording medium 91 becomes easy. The air GS₁₈ which flows in between the transport belt 161 and the recording medium 91 hits the recording medium 91. Accordingly, the recording medium 91 is cooled to further solidify and the peeling from the transport belt 161 is rendered easier, that is, is promoted.

The transport unit 116 is not limited to a configuration including the transport belt 161, and for example, may be configured to include a platen (a stage).

Although the recording medium manufacturing apparatus 101 is configured such that the transport direction CD₂₄ and the transport direction CD₁₆ are the same directions, the configuration is not limited thereto, and a configuration may be adopted in which the transport direction CD₂₄ and the transport direction CD₁₆ are opposite directions.

In the recording medium manufacturing apparatus 101, although the magnitude relationship between the speed V₂4 and the speed V₁₆ is defined and the ink receiving layer 902 is formed, the configuration is not limited thereto. For example, during the formation of the ink receiving layer 902, when the weight per unit area, that is, the linear mass density (unit: g/cm²) of the fiber-containing material which is carried by the carrying body 124 is set to W1 and the weight per unit area, that is, the linear mass density (unit: g/cm²) of the fiber-containing material which is transferred to the transport belt 161 is set to W2, it is preferable that the relationship of weight W2/weight W1>1.0 be satisfied. Accordingly, it is possible to transfer a comparatively large amount of the fiber-containing material from the carrying body 124 to the transport belt 161 using a simple configuration in which a magnitude difference is established between the weight W1 and the weight W2. It is preferable that the relationship of weight W2/weight W1<15 be satisfied. Accordingly, it is possible to stably and swiftly perform the forming of the ink receiving layer 902 to be as thick as possible. It is possible to satisfy the magnitude relationship between the weight W1 and the weight W2 by adjusting the potential of the carrying body 124 and the potential of the transfer unit 134 (or the electromagnetic field strength), for example. The potential adjustment is controlled by the control unit 11.

### Ninth Embodiment

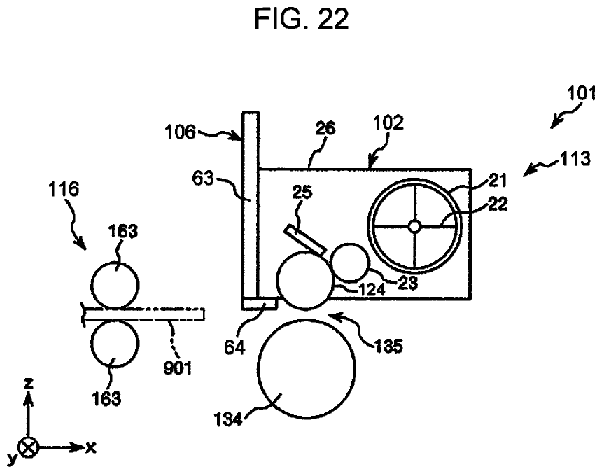

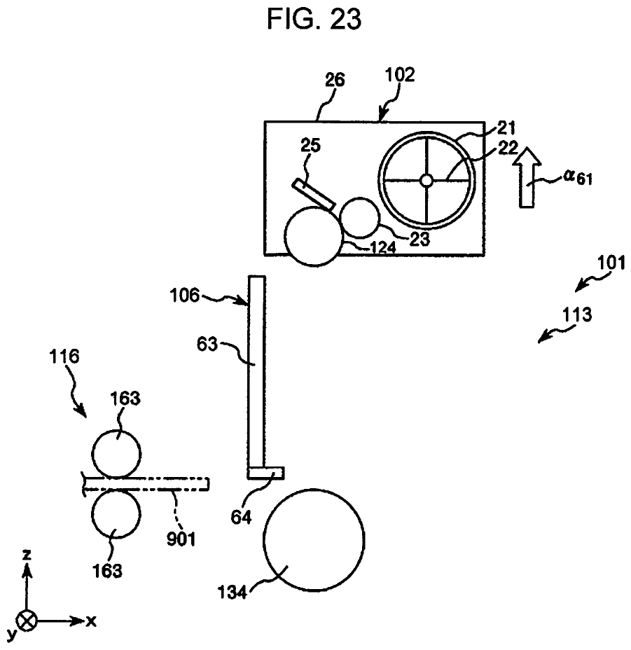

FIGS. 22 and 23 are vertical sectional side views illustrating, in order, the process of displacing the material supplying unit with respect to the recording medium manufacturing apparatus (the ninth embodiment) of the invention.

Hereinafter, a description will be given of the ninth embodiment of the recording medium manufacturing apparatus of the invention with reference to the drawings and the description will be given centered on the points which differ from the previously-described embodiments, omitting the description of items which are the same.

In the present embodiment, the material supplying unit 102 is capable of assuming a first position at which the electrostatic transferring of the fiber-containing material to the transfer-target body (the substrate 901) is possible (the state illustrated in FIG. 22), and a second position which is withdrawn from the first position (the state illustrated in FIG. 23). Accordingly, as described later, various maintenance of the material supplying unit 102 becomes possible.

In the recording medium manufacturing apparatus 101, during continued usage over a long period, it is preferable to perform various maintenance on the material supplying unit 102 such as upkeep, inspection, cleaning, replenishment of material (the fiber-containing material), repair, servicing, and replacement (including replacing a portion of the parts), for example. Therefore, the recording medium manufacturing apparatus 101 of the present embodiment is configured to be capable of performing various maintenance on the material supplying unit 102.

The material supplying unit 102 is a cartridge capable of assuming the state illustrated in FIG. 22 and the state illustrated in FIG. 23 in which the material supplying unit 102 is moved from the state illustrated in FIG. 22. In the state illustrated in FIG. 22, the material supplying unit 102 is positioned at the first position at which the electrostatic transferring of the fiber-containing material to the transfer-target body (the substrate 901) is possible. Meanwhile, in the state illustrated in FIG. 23, the material supplying unit 102 is displaced at the second position which is withdrawn from the first position.

The ink receiving layer forming unit 113 is provided with a support portion 106 which is capable of being displaced between the first position and the second position of the material supplying unit 102. The support portion 106 includes a guide portion 63 which supports the material supplying unit 102 to be movable in the z-axis direction (the vertical direction) and a restricting portion 64 which restricts the movement limit of the material supplying unit 102 to the z-axis direction negative side.

As illustrated in FIG. 22, the material supplying unit 102 assumes a state of being loaded in the recording medium manufacturing apparatus 101 at the first position. In the material supplying unit 102 in the loaded state, the fiber-containing material is moved to the substrate 901 which is transported to the transfer nip 135, the electrostatic transferring is performed, and it is possible to form the ink receiving layer 902. In a case in which the maintenance is performed, the recording medium manufacturing apparatus 101 is set to a state in which the forming of the ink receiving layer 902 is stopped and the material supplying unit 102 is displaced at the second position. For this operation, first, as illustrated in FIG. 23, when the material supplying unit 102 is moved along the guide portion 63 to the z-axis direction positive side, that is, in the arrow α₆₁ direction, it is finally possible to detach the material supplying unit 102 from the recording medium manufacturing apparatus 101. The material supplying unit 102 assumes a detached state in which the material supplying unit 102 may be detached from the recording medium manufacturing apparatus 101 at the second position. It is possible to perform various maintenance as described earlier on the material supplying unit 102 in the detached state. Since the material supplying unit 102 is in the detached state, it is possible to easily perform the maintenance in comparison to a state in which the material supplying unit 102 is supported by the guide portion 63, for example.

As described earlier, examples of the types of the maintenance include upkeep, inspection, cleaning, replenishment of material (the fiber-containing material), repair, servicing, and replacement. In a case in which the material supplying unit 102 breaks down due to degradation over time, for example, the replacement or the repair of the material supplying unit 102 is performed. In a case in which the fiber-containing material which is stored in the storage unit 21 of the material supplying unit 102 is used up, that is, is emptied, the replenishment of the fiber-containing material to the storage unit 21 or the replacement of the material supplying unit 102 is performed. In a case in which problems such as breakdowns are to be preemptively prevented from occurring in the material supplying unit 102, the cleaning, the servicing, and the inspection of the material supplying unit 102 are performed.

It is preferable that the filled amount of the fiber-containing material inside the storage unit 21 be adjusted such that the period until the inside of the storage unit 21 becomes empty is approximately the same as the lifespan of the carrying body 124. Accordingly, during the usage of the recording medium manufacturing apparatus 101, in a case in which at least one state is assumed of a state in which the inside of the storage unit 21 is empty and a state in which the lifespan of the carrying body 124 is ended, it is possible to replace the material supplying unit 102 with a new one while wasting as little as possible of the material supplying unit 102.

The material supplying unit 102 may be replaced with a new material supplying unit 102 in a detached state. Accordingly, it is possible to easily and swiftly perform the replacement of the material supplying unit 102 during breakdowns and the replacement of the material supplying unit 102 when the fiber-containing material is emptied.

The material supplying unit 102 is replaceable in the detached state and is also possible to clean, repair, service, inspect, and to replenish the material in the detached state. Accordingly, it is also possible to easily and swiftly perform the cleaning, the repair, the servicing, the inspection, and the replenishment of the material.

After the maintenance, it is possible to return the material supplying unit 102 to the first position by moving the material supplying unit 102 in the opposite manner to that described above. Accordingly, the material supplying unit 102 returns to the first position, is positioned by the restricting portion 64, and it is possible to continually use the recording medium manufacturing apparatus 101.

It is preferable that the ink receiving layer forming unit 113 be provided with a locking portion (not illustrated) which fixes the material supplying unit 102 which is at the first position. Accordingly, even if vibration caused by the operation of various components is generated in the recording medium manufacturing apparatus 101 during the manufacturing of the recording medium 91, for example, it is possible to prevent positional deviation of the material supplying unit 102, and thus, it is possible to stably perform the forming of the ink receiving layer 902. When moving the material supplying unit 102 to the second position, it is possible to release the fixed state by the locking portion.

As described earlier, the carrying body 124 is configured by a roller. In the present embodiment, a plurality of types of the material supplying unit 102 having different roller widths, that is, different lengths of the carrying body 124 in the y-axis direction is prepared, and it is possible to select from the plurality of types in the detached state to replace the material supplying unit 102. Accordingly, it is possible to form the ink receiving layer 902 having a different width on the substrate 901 according to the material supplying unit 102 which is selected.

As described earlier, the recording medium manufacturing apparatus 101 includes a transport unit which transports the fiber-containing material (the ink receiving layer 902) which is electrostatically transferred onto the substrate 901 (the transfer-target body). As illustrated in FIG. 23, in the present embodiment, the direction in which the material supplying unit 102 is displaced between the first position and the second position, that is, the arrow α₆₁ direction is a direction which intersects the transport direction (the x-axis direction) of the substrate 901 (the fiber-containing material) of the transport unit 116, in particular, is a direction (a z-direction) which orthogonally intersects the transport direction. Although dependent on the structure of the periphery of the material supplying unit 102 in the recording medium manufacturing apparatus 101, since the arrow α₆₁ direction is suitable for the displacement direction of the material supplying unit 102 during the maintenance while preventing interference with the periphery of the material supplying unit 102, the arrow α₆₁ direction is preferable.

### Tenth Embodiment

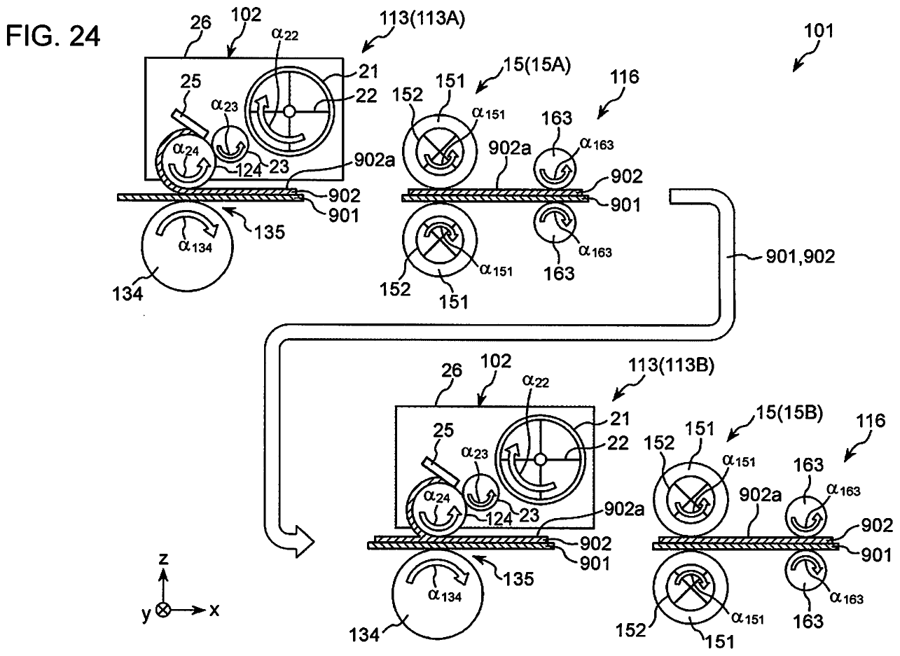

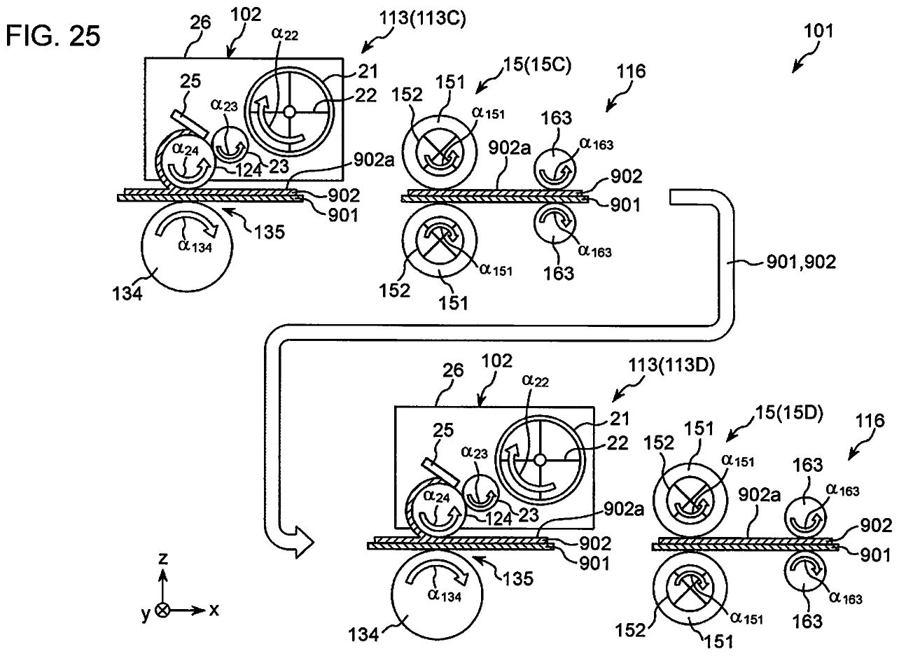

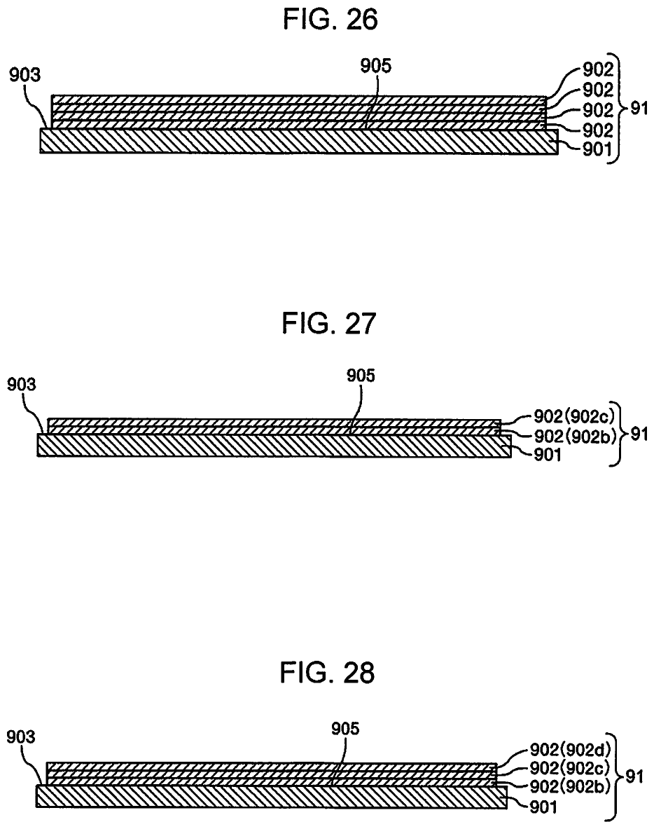

FIGS. 24 and 25 are each a vertical sectional side view illustrating, in order, the process of manufacturing the recording medium using the recording medium manufacturing apparatus (the tenth embodiment) of the invention. FIGS. 26 to 28 are each a vertical sectional view illustrating an example of the recording medium which is manufactured by the recording medium manufacturing apparatus (the tenth embodiment) of the invention. In FIGS. 24 and 25, for the convenience of illustration, the ink receiving layer 902 will be displayed as a single ink receiving layer 902 whether the ink receiving layer 902 is a single layer or a laminated body of a plurality of layers.

Hereinafter, a description will be given of the tenth embodiment of the recording medium manufacturing apparatus of the invention with reference to the drawings and the description will be given centered on the points which differ from the previously-described embodiments, omitting the description of items which are the same.

In the recording medium manufacturing apparatus 101 of the present embodiment, a plurality (in the present embodiment, four) each of the ink receiving layer forming unit 113 and the ink receiving layer solidifying unit 15 are disposed toward the x-axis direction positive side. The four ink receiving layer forming units 113 may be referred to as, in order from the upstream side, “an ink receiving layer forming unit 113A” (refer to FIG. 24), “an ink receiving layer forming unit 113B” (refer to FIG. 24), “an ink receiving layer forming unit 113C” (refer to FIG. 25), and “an ink receiving layer forming unit 113D” (refer to FIG. 25). The four ink receiving layer solidifying units 15 may be referred to as, in order from the upstream side, “the ink receiving layer solidifying unit 15A” (refer to FIG. 24), “the ink receiving layer solidifying unit 15B” (refer to FIG. 24), “the ink receiving layer solidifying unit 15C” (refer to FIG. 25), and “the ink receiving layer solidifying unit 15D” (refer to FIG. 25). The ink receiving layer solidifying unit 15A is disposed between the ink receiving layer forming unit 113A and the ink receiving layer forming unit 113B, the ink receiving layer solidifying unit 15B is disposed between the ink receiving layer forming unit 113B and the ink receiving layer forming unit 113C, the ink receiving layer solidifying unit 15C is disposed between the ink receiving layer forming unit 113C and the ink receiving layer forming unit 113D, and the ink receiving layer solidifying unit 15D is disposed on the downstream side, that is, the x-axis direction positive side of the ink receiving layer forming unit 113D.

The recording medium manufacturing apparatus 101 is configured to include four of the ink receiving layer forming units 113, that is, four (a plurality) of each of the material supplying unit 102 and the transfer unit 134 are disposed and the recording medium manufacturing apparatus 101 includes four of the ink receiving layer solidifying units 15. In the recording medium manufacturing apparatus 101 of this configuration, it is possible to manufacture the recording medium 91 in which a plurality of the ink receiving layers 902 are laminated such as the recording medium 91 illustrated in FIG. 26, for example. In the recording medium 91 illustrated in FIG. 26, four ink receiving layers 902 are laminated. The thickness of each of the ink receiving layers 902 is the same.

The ink receiving layer forming unit 113A forms the first ink receiving layer 902 on the substrate 901. The ink receiving layer solidifying unit 15A solidifies the first ink receiving layer 902.

The ink receiving layer forming unit 113B forms the second ink receiving layer 902 on the solidified first ink receiving layer 902. The ink receiving layer solidifying unit 15B solidifies the second ink receiving layer 902.

The ink receiving layer forming unit 113C forms the third ink receiving layer 902 on the solidified second ink receiving layer 902. The ink receiving layer solidifying unit 15C solidifies the third ink receiving layer 902.

The ink receiving layer forming unit 113D forms the fourth ink receiving layer 902 on the solidified third ink receiving layer 902. The ink receiving layer solidifying unit 15D solidifies the fourth ink receiving layer 902.

According to this configuration, it is possible to stack the plurality of ink receiving layers 902 in order. There is a case in which each of the ink receiving layers 902 assumes a state in which the line irregularities or the like which are described earlier are generated, for example. However, the line irregularities become random as the plurality of ink receiving layers 902 are laminated, and as a result, the fourth ink receiving layer 902 assumes a state in which the line irregularities are solved. Accordingly, the recording medium 91 which is manufactured becomes capable of stably receiving the ink.

Although the recording medium manufacturing apparatus 101 is configured such that the surface property treatment unit 14 is omitted in the depicted configuration, the recording medium manufacturing apparatus 101 may be configured to include the surface property treatment unit 14.

In the recording medium manufacturing apparatus 101, it is possible to adjust the operating conditions of the ink receiving layer forming units 113 and the ink receiving layer solidifying units 15, for example, such that the forming conditions under which the first ink receiving layer 902 is formed, the forming conditions under which the second ink receiving layer 902 is formed, the forming conditions under which the third ink receiving layer 902 is formed, and the forming conditions under which the fourth ink receiving layer 902 is formed are different from each other. Accordingly, it is possible to easily and swiftly manufacture various recording mediums 91 having different characteristics (properties). The adjustment of the operating conditions of the ink receiving layer forming units 113 and the ink receiving layer solidifying units 15 is controlled by the control unit 11.

For example, it is possible to adjust the potential of the transfer unit 134 of each of the ink receiving layer forming units 113 such that the electrostatic force during the formation of the first ink receiving layer 902 in the ink receiving layer forming unit 113A, the electrostatic force during the formation of the second ink receiving layer 902 in the ink receiving layer forming unit 113B, the electrostatic force during the formation of the third ink receiving layer 902 in the ink receiving layer forming unit 113C, and the electrostatic force during the formation of the fourth ink receiving layer 902 in the ink receiving layer forming unit 113D are different from each other. It is preferable that the magnitude relationship between the potentials be “(the potential during the formation of the first ink receiving layer 902)<(the potential during the formation of the second ink receiving layer 902)<(the potential during the formation of the third ink receiving layer 902)<(the potential during the formation of the fourth ink receiving layer 902)”. As the ink receiving layers 902 are laminated, the total thickness of the ink receiving layers 902 on the substrate 901 increases. Therefore, according to the magnitude relationship between the potentials, it is possible to improve the transfer efficiency during the formation of each of the ink receiving layers 902.

In the recording medium manufacturing apparatus 101, the first ink receiving layer 902 is heated by the ink receiving layer solidifying unit 15A, the second ink receiving layer 902 is heated by the ink receiving layer solidifying unit 15B, the third ink receiving layer 902 is heated by the ink receiving layer solidifying unit 15C, and the fourth ink receiving layer 902 is heated by the ink receiving layer solidifying unit 15D.

It is possible to adjust the temperature of the heater 152 of each of the ink receiving layer solidifying units 15 such that the heating temperature at which the first ink receiving layer 902 is heated, the heating temperature at which the second ink receiving layer 902 is heated, the heating temperature at which the third ink receiving layer 902 is heated, and the heating temperature at which the fourth ink receiving layer 902 is heated are different from each other. It is preferable that the magnitude relationship between the heating temperatures be “(the heating temperature during the solidifying of the first ink receiving layer 902)<(the heating temperature during the solidifying of the second ink receiving layer 902)<(the heating temperature during the solidifying of the third ink receiving layer 902)<(the heating temperature during the solidifying of the fourth ink receiving layer 902)”. In the same manner as described above, as the ink receiving layers 902 are laminated, the total thickness of the ink receiving layers 902 on the substrate 901 increases. Therefore, according to the magnitude relationship between the heating temperatures, it is possible to improve the melting of the resin more the closer the ink receiving layer 902 is to the top side to appropriately perform the subsequent solidification.

In the recording medium manufacturing apparatus 101, the first ink receiving layer 902 is pressurized by the ink receiving layer solidifying unit 15A, the second ink receiving layer 902 is pressurized by the ink receiving layer solidifying unit 15B, the third ink receiving layer 902 is pressurized by the ink receiving layer solidifying unit 15C, and the fourth ink receiving layer 902 is pressurized by the ink receiving layer solidifying unit 15D.

In this case, it is possible to adjust the pressurizing force of the ink receiving layer solidifying units 15 such that the pressurization force at which the first ink receiving layer 902 is pressurized, the pressurization force at which the second ink receiving layer 902 is pressurized, the pressurization force at which the third ink receiving layer 902 is pressurized, and the pressurization force at which the fourth ink receiving layer 902 is pressurized are different from each other. It is preferable that the magnitude relationship between the pressurizing forces be “(the pressurizing force during the solidifying of the first ink receiving layer 902)<(the pressurizing force during the solidifying of the second ink receiving layer 902)<(the pressurizing force during the solidifying of the third ink receiving layer 902)<(the pressurizing force during the solidifying of the fourth ink receiving layer 902)”. In the same manner as described above, as the ink receiving layers 902 are laminated, the total thickness of the ink receiving layers 902 on the substrate 901 increases. Therefore, according to the magnitude relationship between the pressurizing forces, it is possible to improve the compression the closer the ink receiving layer 902 is to the top side. Accordingly, the closer the layer is to the top side, the thinner the layer becomes and it is possible to facilitate the transmission of heat from the heater 152, and thus, it is possible to further improve the melting of the resin.

It is possible to manufacture the recording medium 91 in which the thickness of the first ink receiving layer 902, the thickness of the second ink receiving layer 902, the thickness of the third ink receiving layer 902, and the thickness of the fourth ink receiving layer 902 are different from each other. It is preferable that the magnitude relationship between the thicknesses be “(the thickness of the first ink receiving layer 902)>(the thickness of the second ink receiving layer 902)>(the thickness of the third ink receiving layer 902)>(the thickness of the fourth ink receiving layer 902)”. Accordingly, the first ink receiving layer 902 having the greatest thickness is capable of functioning as an ink stop layer which prevents the ink from reaching the substrate 901, for example. Accordingly, in the recording medium 91, it is possible to prevent the bleeding of the ink in the reverse surface.

In this case, it is possible to adjust the operations of each of the ink receiving layer forming units 113 such that the transfer amount of the fiber-containing material during the formation of the first ink receiving layer 902 in the ink receiving layer forming unit 113A, the transfer amount of the fiber-containing material during the formation of the second ink receiving layer 902 in the ink receiving layer forming unit 113B, the transfer amount of the fiber-containing material during the formation of the third ink receiving layer 902 in the ink receiving layer forming unit 113C, and the transfer amount of the fiber-containing material during the formation of the fourth ink receiving layer 902 in the ink receiving layer forming unit 113D are different from each other.

In the recording medium manufacturing apparatus 101, the material supplying unit 102 of each of the ink receiving layer forming units 113 may be a plurality of types (for example, six types) selected from the following, as appropriate, for example.

The first type of material supplying unit 102 (hereinafter the ink receiving layer forming unit 113 including this material supplying unit 102 will be referred to as “type A”) stores a fiber-containing material in which the ratio of the cellulose fibers to the resin in the fiber-containing material is 9:1 by weight ratio. The resin before covering the cellulose fibers is a polyester powder having an average particle diameter of 12 μm.

The second type of material supplying unit 102 (hereinafter the ink receiving layer forming unit 113 including this material supplying unit 102 will be referred to as “type B”) stores a fiber-containing material in which the ratio of the cellulose fibers to the resin in the fiber-containing material is 8:2 by weight ratio. The resin before covering the cellulose fibers is a polyester powder having an average particle diameter of 12 μm.

The third type of material supplying unit 102 (hereinafter the ink receiving layer forming unit 113 including this material supplying unit 102 will be referred to as “type C”) stores a fiber-containing material in which the ratio of the cellulose fibers to the resin in the fiber-containing material is 2:8 by weight ratio.

The fourth type of material supplying unit 102 (hereinafter the ink receiving layer forming unit 113 including this material supplying unit 102 will be referred to as “type D”) stores a material in which a pigment which serves as a colorant is dispersed in a polyester powder having an average particle diameter of 12 μm. Examples of the color of the pigment include yellow (Y), magenta (M), cyan (C), and black (K) and the color is selected from these, as appropriate.

The fifth type of material supplying unit 102 (hereinafter the ink receiving layer forming unit 113 including this material supplying unit 102 will be referred to as “type E”) stores a fiber-containing material in which the ratio of the cellulose fibers to the resin in the fiber-containing material is 9:1 by weight ratio, and further, in which the pigment which serves as the colorant is dispersed. The resin before covering the cellulose fibers is a polyester powder having an average particle diameter of 12 μm.

The sixth type of material supplying unit 102 (hereinafter the ink receiving layer forming unit 113 including this material supplying unit 102 will be referred to as “type F”) stores a fiber-containing material in which the ratio of the cellulose fibers to the resin in the fiber-containing material is 8:2 by weight ratio, and further, in which the pigment which serves as the colorant is dispersed. The resin before covering the cellulose fibers is a polyester powder having an average particle diameter of 12 μm.

For example, it is possible to set the ink receiving layer forming unit 113A to type C, the ink receiving layer forming unit 113B to type B, the ink receiving layer forming unit 113C to type A, and the ink receiving layer forming unit 113D to type D. It is possible to operate the recording medium manufacturing apparatus 101 in this state (hereinafter referred to as “the first state”). The operation patterns in the first state include the following patterns, for example.

Pattern 1: Ink receiving layers 902 are formed using type C and type B and the formation of the ink receiving layers 902 using type A and type D is stopped.

Pattern 2: Ink receiving layers 902 are formed using type C and type A and the formation of the ink receiving layers 902 using type B and type D is stopped.

Pattern 3: Ink receiving layers 902 are formed using type C, type B, and type D and the formation of the ink receiving layer 902 using type A is stopped.

Pattern 4: Ink receiving layers 902 are formed using type C, type A, and type D and the formation of the ink receiving layer 902 using type B is stopped.

It is possible to take the first state, for example, and set the ink receiving layer forming unit 113B to type F instead of type B and to set the ink receiving layer forming unit 113C to type E instead of type A. It is possible to operate the recording medium manufacturing apparatus 101 in this state (hereinafter referred to as “the second state”). The operation patterns in the second state include the following patterns, for example.

Pattern 5: Ink receiving layers 902 are formed using type C and type E and the formation of the ink receiving layers 902 using type A and type D is stopped.

Pattern 6: Ink receiving layers 902 are formed using type C and type F and the formation of the ink receiving layers 902 using type B and type D is stopped.

According to the operation of pattern 1, first, the first ink receiving layer 902 (hereinafter referred to as “the ink receiving layer 902b”) is formed using type C on the substrate 901 (refer to FIG. 27). Next, the second ink receiving layer 902 (hereinafter referred to as “the ink receiving layer 902c”) is formed using type B on the ink receiving layer 902b (refer to FIG. 27). In the recording medium 91 which is manufactured in this manner, the ink is held mainly by the ink receiving layer 902c and further infiltration by the ink is prevented by the ink receiving layer 902b. Accordingly, in the recording medium 91, the ink bleeding in the reverse surface, that is, show-through is prevented. The recording medium 91 is mainly suitable for printing of images in which the ink dot disposition density is comparatively high such as in graphic images and photographic images.

According to the operation of pattern 2, first, the ink receiving layer 902b is formed using type C on the substrate 901 (refer to FIG. 27). Next, the ink receiving layer 902c is formed using type A on the ink receiving layer 902b. In the recording medium 91 which is manufactured in this manner, the ink is held mainly by the ink receiving layer 902c and further infiltration by the ink is prevented by the ink receiving layer 902b. The recording medium 91 is mainly suitable for printing of characters.

According to the operation of pattern 3, the recording medium 91 is obtained (refer to FIG. 28) in which the third ink receiving layer 902 (hereinafter referred to as “the ink receiving layer 902d”) is further laminated, using type D, onto the recording medium 91 which is obtained by pattern 1. The recording medium 91 has the same function as the recording medium 91 which is obtained by pattern 1 and becomes a colored recording medium 91 in which the color of the pigment is further reflected.

According to the operation of pattern 4, the recording medium 91 is obtained in which the third ink receiving layer 902d is further laminated, using type D, onto the recording medium 91 which is obtained by pattern 2. The recording medium 91 has the same function as the recording medium 91 which is obtained by pattern 2 and becomes a colored recording medium 91 in which the color of the pigment is further reflected.

According to the operation of pattern 5, the ink receiving layer 902b is formed using type C and the ink receiving layer 902c is formed using type E. The recording medium 91 which is manufactured in this manner is mainly suitable for printing of graphic images and the like and becomes a colored recording medium 91 in which infiltration by the ink is prevented by the ink receiving layer 902c.

According to the operation of pattern 6, the ink receiving layer 902b is formed using type C and the ink receiving layer 902c is formed using type F. The recording medium 91 which is manufactured in this manner is mainly suitable for printing of characters and becomes a colored recording medium 91 in which infiltration by the ink is prevented by the ink receiving layer 902c.

According to this configuration, it is possible to form ink receiving layers 902 which have different characteristics (properties) according to the ink receiving layer forming unit 113 which is selected and used during the layer formation. Accordingly, it is possible to obtain various recording media 91 having different characteristics (properties).

In the recording medium manufacturing apparatus 101, although four each of the material supplying unit 102 and the transfer unit 134 are disposed in the present embodiment, it goes without saying that the number to be disposed is not particularly limited.

In the recording medium 91 which includes a laminate body of the ink receiving layers 902, for example, an intermediate layer which is configured by a different material from the fiber-containing material may be disposed between the ink receiving layers 902. The function of the intermediate layer is not particularly limited, and for example, a function of increasing the adherence between the ink receiving layers 902 or the like is exemplified.

In a case in which the recording medium 91 including a laminated body of the ink receiving layers 902 is manufactured, although it is possible to use the recording medium manufacturing apparatus 101 of the present embodiment in which a plurality of each of the ink receiving layer forming unit 113 and the ink receiving layer solidifying unit 15 is disposed, it is possible to use the recording medium manufacturing apparatus 101 of the seventh embodiment in which one each of the ink receiving layer forming unit 113 and the ink receiving layer solidifying unit 15 is disposed. In a case in which the recording medium manufacturing apparatus 101 of the seventh embodiment is used, it is possible to manufacture the recording medium 91 which includes a laminated body of the ink receiving layers 902 by causing the substrate 901 to cycle the ink receiving layer forming unit 113 and the ink receiving layer solidifying unit 15 a plurality of times (a number equivalent to the number of times the ink receiving layers 902 are laminated).

Hereinabove, although a description is given of the recording medium manufacturing apparatus of the invention with respect to the depicted embodiments, the invention is not limited thereto, and it is possible to replace the parts which configure the recording medium manufacturing apparatus with parts of a predetermined configuration that may exhibit similar functions. Other predetermined constituent parts may be added.

The recording medium manufacturing apparatus of the invention may be a combination of greater than or equal to two predetermined configurations (characteristics) of the embodiments.

The transport unit which transports the ink receiving layer may be configured to include a platen (a stage), for example.

### REFERENCE SIGNS LIST

1, 101 recording medium manufacturing apparatus

2 material supplying section

21 storage unit

22 stirring device (agitator)

23 supply roller

24 first carrying body

25 blade

26 housing

3 leveling process unit

31 leveling roller

32 support roller

33 earth line

4 pressure treatment unit

41 pressurizing roller

411 outer circumferential portion

5 semi-solidification process unit

51 chamber

511 heat-insulating wall

512 entrance

513 exit

52 heater

6 support portion

61 first guide portion

62 second guide portion

11 control unit

111 CPU (central processing unit)

112 memory unit

13, 113 ink receiving layer forming unit

13A ink receiving layer forming unit

13B ink receiving layer forming unit

13C ink receiving layer forming unit

13D ink receiving layer forming unit

131 second carrying body (photosensitive body)

131a outer circumferential surface

132 charging unit

133 exposing unit

134 transfer unit

134a outer circumferential surface

135 transfer nip

14 surface property treatment unit

15 ink receiving layer solidifying unit

15A ink receiving layer solidifying unit

15B ink receiving layer solidifying unit

15C ink receiving layer solidifying unit

15D ink receiving layer solidifying unit

151 solidifying roller

152 heater

16, 116 transport unit

161 transport belt

161a wrap-around portion

162a transport roller

162b transport roller

162c transport roller

18 peeling promotion unit

181 outlet

19 winding unit

20 after-treatment unit

90, 91 recording medium

902 ink receiving layer

902a surface

902b ink receiving layer

902c ink receiving layer

902d ink receiving layer

CD₁₃₁ transport direction

CD₁₆ transport direction

GS₁₆ air

LB₁₃₃ laser beam

V₁₃₁ speed

V₁₆ speed

V₃₁ speed

W1 weight

W2 weight

α₁₉ arrow

α₂₂ arrow

α₂₃ arrow

α₂₄ arrow

α₃₁ arrow

α₃₂ arrow

α₄₁ arrow

α₆₁ arrow

α₆₂ arrow

α₁₃₁ arrow

α₁₃₂ arrow

α₁₃₄ arrow

α₁₅₁ arrow

α₁₆₂ arrow

β₃₁ arrow

β₃₂ arrow

β₄₁ arrow

β₁₃₄ arrow

β₁₆₂ arrow

1. A recording medium manufacturing apparatus comprising:
a material supplying section which includes a storage unit which stores a fiber-containing material containing cellulose fibers and a resin;
a carrying body which carries the fiber-containing material which is supplied from the material supplying section;
a transfer-target body onto which the fiber-containing material which is carried by the carrying body is electrostatically transferred; and
an after-treatment unit which performs an after-treatment on the fiber-containing material which is electrostatically transferred onto the transfer-target body.

2. The recording medium manufacturing apparatus according to claim 1,
wherein the transfer-target body is a belt which transports the fiber-containing material.

3. The recording medium manufacturing apparatus according to claim 2,
wherein the belt is configured by a resin which has a volume resistivity of 10⁷ to 10¹¹ Ω·cm.

4. The recording medium manufacturing apparatus according to claim 1,
wherein the carrying body and the transfer-target body pressurize the fiber-containing material between the carrying body and the transfer-target body.

5. The recording medium manufacturing apparatus according to claim 1,
wherein the carrying body carries the fiber-containing material which is carried by the carrying body at a first speed V1,
wherein the transfer-target body transports the fiber-containing material which is electrostatically transferred onto the transfer-target body at a second speed V2, and
wherein when the fiber-containing material is electrostatically transferred from the carrying body to the transfer-target body, a transport direction of the fiber-containing material by the carrying body and a transport direction of the fiber-containing material by the transfer-target body are the same direction and a relationship of V1>V2 is satisfied.

6. The recording medium manufacturing apparatus according to claim 1,
wherein the carrying body carries the fiber-containing material which is carried by the carrying body at a first speed V1,
wherein the transfer-target body transports the fiber-containing material which is electrostatically transferred onto the transfer-target body at a second speed V2, and
wherein when the fiber-containing material is electrostatically transferred from the carrying body to the transfer-target body, a transport direction of the fiber-containing material by the carrying body and a transport direction of the fiber-containing material by the transfer-target body are opposite directions from each other.

7. The recording medium manufacturing apparatus according to claim 6,
wherein a relationship |V1|>|V2| is satisfied.

8. The recording medium manufacturing apparatus according to claim 1,
wherein when a weight per unit area of the fiber-containing material which is carried by the carrying body is set to W1 and a weight per unit area of the fiber-containing material which is electrostatically transferred onto the transfer-target body is set to W2, a relationship of W2/W1>1.0 is satisfied.

9. The recording medium manufacturing apparatus according to claim 1,
wherein the material supplying section is capable of assuming a first position at which it is possible to supply the fiber-containing material to the carrying body and a second position at which the material supplying section is withdrawn from the first position.

10. The recording medium manufacturing apparatus according to claim 9,
wherein at the first position, the material supplying section assumes a loaded state of being loaded in the recording medium manufacturing apparatus, and at the second position, the material supplying section assumes a detachable state in which the material supplying section is detachable from the recording medium manufacturing apparatus.

11-18. (canceled)

19. A recording medium manufacturing apparatus comprising:
at least one a material supplying unit which includes a storage unit which stores a fiber-containing material containing cellulose fibers and a resin, and a carrying body which carries the fiber-containing material;
a transfer unit which electrostatically transfers the fiber-containing material which is carried by the carrying body onto a transfer-target body; and
an after-treatment unit which performs an after-treatment on the fiber-containing material which is electrostatically transferred onto the transfer-target body.

20. The recording medium manufacturing apparatus according to claim 19,
wherein the material supplying unit is capable of assuming a first position at which it is possible to electrostatically transfer the fiber-containing material onto the transfer-target body and a second position at which the material supplying unit is withdrawn from the first position.

21. The recording medium manufacturing apparatus according to claim 20,
wherein at the first position, the material supplying unit assumes a loaded state of being loaded in the recording medium manufacturing apparatus, and at the second position, the material supplying unit assumes a detached state in which the material supplying unit is detached from the recording medium manufacturing apparatus.

22-23. (canceled)

24. The recording medium manufacturing apparatus according to claim 20, further comprising:
a transport unit which transports the fiber-containing material which is electrostatically transferred to the transfer-target body,
wherein a direction in which the material supplying unit is displaced between the first position and the second position is a direction which intersects a transport direction of the fiber-containing material by the transport unit.

25-30. (canceled)

31. The recording medium manufacturing apparatus according to claim 19,
wherein the transfer-target body is a substrate which configures a recording medium together with the fiber-containing material.

32. The recording medium manufacturing apparatus according to claim 19,
wherein the transfer-target body is a belt which transports the fiber-containing material, and
wherein the recording medium manufacturing apparatus includes the belt.

33. (canceled)
